(19) United States
(12) Patent Application Publication
(10) Pub. No.: US 2025/0358104 A1
(43) Pub. Date: Nov. 20, 2025

(54) PASSWORD SHARING SYSTEM, METHOD, AND PROGRAM, SERVER DEVICE, AND TERMINAL DEVICE

(71) Applicant: Toru KAMBAYASHI, Chigasaki-shi Kanagawa (JP)

(72) Inventor: Toru KAMBAYASHI, Chigasaki-shi Kanagawa (JP)

(21) Appl. No.: 19/289,428

(22) Filed: Aug. 4, 2025

Related U.S. Application Data
(63) Continuation-in-part of application No. PCT/JP2024/003917, filed on Feb. 6, 2024.

(30) Foreign Application Priority Data
Feb. 7, 2023 (JP) 2023-017076

(51) Int. Cl. H04L 9/08; H04L 9/32

(52) U.S. Cl. CPC H04L 9/0825; H04L 9/0863; H04L 9/3213; H04L 9/3226

(57) ABSTRACT

After a pair of an identification token (131) and password disclosure permission information (134) transmitted from a first client terminal (102) is verified by a verification unit (106), a password registration unit (107) registers a record (122) including password information (133) and the password disclosure permission information (134) to a database 121 of a password sharing server (101) and transmits password identification information (135) for identifying the record to the first client terminal (102). The first client terminal (102) transmits data (139) including encrypted data (138) obtained by encrypting transmission data by using a cipher key (136) for data encryption after first processing output by a cipher key first processing unit (109), a cipher key (137) for data decryption after first processing output by the cipher key first processing unit (109), and the password identification information (135) obtained from the password registration unit (107), to a second client terminal (103). The second client terminal (103) makes an inquiry to a password disclosure unit (110) by using the password identification information (135) acquired from the received data (139) and an identification token (132) of the terminal itself. The password disclosure unit (110) acquires the pair of password information (133) and password disclosure permission information (134) corresponding to the password identification information (135), from the database (121), and notifies, when the identification token (132) is included in a password disclosure permissible range indicated by the password disclosure permission information (134), the second client terminal of the password information (133). The second client terminal (103) uses the notified password information (133) to generate a cipher key (140) for data decryption subjected to second processing from the cipher key (137) for data decryption after first processing acquired from the data (139) and uses the cipher key (140) for data decryption subjected to second processing to execute decryption on the encrypted data (138) in the data (139).

### TECHNICAL FIELD

The present invention relates to a password sharing technique and specifically relates to a password sharing system, method, and program, a server device, and a terminal device.

The technique disclosed herein relates, for example, to a mechanism for password sharing in which a transmitter and a receiver of an e-mail share encrypted data of an attached file and a mechanism for password sharing for sharing encrypted data on the basis of a relationship with another user.

### BACKGROUND ART

Pretty Good Privacy (PGP) is one of mechanisms for transmitting/receiving encrypted contents. In PGP cryptography, a receiver generates its own key pair (pair of a private key and a public key) and deposits the public key to a server on the Internet to make the public key pubic. A transmitter establishes a connection to the server of the receiver and searches for the public key of the receiver to obtain the public key.

The transmitter generates a symmetric key (also referred to as a common key or a private key) and encrypts a transmission text with the symmetric key. The transmitter then uses the public key of the receiver obtained previously, to encrypt the symmetric key. The transmitter transmits the encrypted transmission text and the symmetric key encrypted with the public key to the receiver.

The receiver uses the private key of the key pair to decrypt the symmetric key encrypted with the public key. From the nature of the key pair, only the receiver having the private key can execute the decryption successfully. The receiver uses the symmetric key acquired through the decryption to decrypt the transmission text received from the transmitter.

As described above, in PGP cryptography, a server on the Internet distributes a public key. The server receives an e-mail address of a receiver and the public key from the receiver and make the e-mail address of the receiver and the public key public on the Internet. The server then provides, in response to a request from a transmitter, the e-mail address of the receiver and the public key to the transmitter.

An example of related techniques is Facebook (registered trademark). This is one of typical social networking services (SNSs) and provides a mechanism for sharing information (including data) on the basis of a relationship between users. Examples of the relationship between users include “family”, “good friend”, “friend”, and “others”.

Besides the above, other examples of the related techniques related to the mechanism for sharing information (including data) are Patent Literatures 1, 2, and 3.

### CITATION LIST

### Patent Literature

Patent Literature 1: JP 2021-524216 T
Patent Literature 2: JP 2018-534818 T
Patent Literature 3: JP 2011-097453 A
Patent Literature 4: JP 2020-198616 A

### SUMMARY OF INVENTION

### Technical Problem

While encryption using a public key encryption (asymmetric key encryption) technique such as PGP is highly secure, this requires significant time and effort of a transmitter/receiver. To avoid such time and effort, a password encrypted zip file is used as a method for simple file encryption. However, this method is likely to cause a problem in security. This is because people concerned are to share the same password. In addition, this password is likely not to be changed for a long time. This is because it is difficult to inform all the people concerned of the change. To avoid such a situation, a password is generated randomly for each file to transmit the password to a transmission destination, but apparently, this method also has a problem in security. Specifically, the password needs to be transmitted in a separate e-mail, and if an attacker acquires a log in a transmission path of the e-mail, the attacker can easily read the password surreptitiously.

Patent Literature 1 discloses a technique that enables entity verification and asset authentication at transmission/reception of digital data (for example, refer to paragraph). Patent Literature 1 also discloses an e-mail address and a proof (for example, refer to paragraphs [0051], [0170], [0044], and [0054]).

Patent Literature 2 discloses a system for security-protected content sharing. Patent Literature 2 also discloses an e-mail address and a data token (for example, refer to paragraphs [0001], [0012], and [0025]).

Patent Literature 3 discloses a technique for transmitting and receiving a message (e-mail) for completely preventing exposure of a private key from information held by a server and also discloses PGP (for example, refer to Abstract and paragraphs to [0001] to [0003] and [0006]).

Patent Literature 4 discloses an e-mail server that sets a password of an encrypted attachment file to be public/non-public in response to a request from a corresponding transmission source.

However, the techniques disclosed in Patent Literatures 1, 2, 3, and 4 described above are not sufficient yet in an aspect of password sharing processing for sharing encrypted data more securely.

An object of the present invention is to, by using an identification token, password disclosure permission information, password identification information, password information, and a plurality of kinds of keys in combination, provide a password sharing processing technique for more securely sharing encrypted data obtained by encrypting encryption target data.

### Solution to Problem

A password sharing system of the preset application including one or more password sharing servers, one or more first client terminals having functions of password registration and data output, and one or more second client terminals having a function of reading data output by the first client terminal, includes:
an identification token issue unit configured to issue an identification token indicating “authenticated” to the first client terminal and the second client terminal;
a password provision unit configured to provide password information, which is a password or a password key generated based on the password;
a verification unit configured to verify an identification token transmitted from the first client terminal;
a password registration unit configured to, only when the verification unit confirms that the identification token is correct, store the password information provided by the password provision unit and password disclosure permission information designating a disclosure permissible range of the password transmitted from the first client terminal in a record in a database included in one of the password sharing servers and also transmit password identification information for identifying the record to the first client terminal;
a cipher key generation unit configured to generate a pair of a cipher key for data encryption and a cipher key for data decryption;
a cipher key first processing unit configured to perform first processing on at least one of the cipher key for data decryption and the cipher key for data encryption generated by the cipher key generation unit, based on the password information provided by the password provision unit, to thereby generate a cipher key for data decryption and a cipher key for data encryption subjected to or not subjected to the first processing, respectively as a cipher key for data decryption after first processing and a cipher key for data encryption after first processing, and input the cipher key for data decryption after first processing and the cipher key for data encryption after first processing to the first client terminal; and
a password disclosure unit configured to acquire the password identification information and the identification token included in a password inquiry information from the second client terminal, acquire the password information and the password disclosure permissible information from a record in the database included in the password sharing server, the record corresponding to the password identification information acquired, acquire information of a user corresponding to the identification token acquired, and transmit the password information acquired to the second client terminal only when it is confirmed that the user is included in the disclosure permissible range indicated by the password disclosure permission information acquired.

A password sharing method of the present application applied to a password sharing system including one or more password sharing servers, one or more first client terminals having functions of password registration and data output, and one or more second client terminals having a function of reading data output by the first client terminal, executes:
identification token issue processing for issuing an identification token indicating “authenticated” to the first client terminal and the second client terminal;
password generation processing for generating password information, which is a password or a password key generated based on the password;
verification processing for verifying an identification token transmitted from the first client terminal;
password registration processing for, only when the verification processing confirms that the identification token is correct, storing the password information generated by the password generation processing and password disclosure permission information designating a disclosure permissible range of the password transmitted from the first client terminal in a record in a database included in one of the password sharing servers and also transmitting password identification information for identifying the record to the first client terminal;
cipher key generation processing for generating a pair of a cipher key for data encryption and a cipher key for data decryption;
cipher key first processing for performing first processing on at least one of the cipher key for data decryption and the cipher key for data encryption generated by the cipher key generation processing, based on the password information generated by the password generation processing, to thereby generate a cipher key for data decryption and a cipher key for data encryption subjected to or not subjected to the first processing, respectively as a cipher key for data decryption after first processing and a cipher key for data encryption after first processing, and input the cipher key for data decryption after first processing and the cipher key for data encryption after first processing to the first client terminal; and
password response processing for acquiring the password identification information and the identification token included in a password inquiry information from the second client terminal, acquiring the password information and the password disclosure permissible information from a record in the database included in the password sharing server, the record corresponding to the password identification information acquired, acquiring information of a user corresponding to the identification token acquired, and transmitting the password information acquired to the second client terminal only when it is confirmed that the user is included in the disclosure permissible range indicated by the password disclosure permission information acquired.

A program of the present application causes one or more computers in a password sharing system including one or more password sharing servers, one or more first client terminals having functions of password registration and data output, and one or more second client terminals having a function of reading data output by the first client terminal, to execute all of or in a divided manner:
identification token issue processing for issuing an identification token indicating “authenticated” to the first client terminal and the second client terminal;
password generation processing for generating password information, which is a password or a password key generated based on the password;
verification processing for verifying an identification token transmitted from the first client terminal;
password registration processing for, only when the verification processing confirms that the identification token is correct, storing the password information generated by the password generation processing and password disclosure permission information designating a disclosure permissible range of the password transmitted from the first client terminal in a record in a database included in one of the password sharing servers and also transmitting password identification information for identifying the record to the first client terminal;
cipher key generation processing for generating a pair of a cipher key for data encryption and a cipher key for data decryption;
cipher key first processing for performing first processing on at least one of the cipher key for data decryption and the cipher key for data encryption generated by the cipher key generation processing, based on the password information generated by the password generation processing, to thereby generate a cipher key for data decryption and a cipher key for data encryption subjected to or not subjected to the first processing, respectively as a cipher key for data decryption after first processing and a cipher key for data encryption after first processing, and input the cipher key for data decryption after first processing and the cipher key for data encryption after first processing to the first client terminal; and
password response processing for acquiring the password identification information and the identification token included in a password inquiry information from the second client terminal, acquiring the password information and the password disclosure permissible information from a record in the database included in the password sharing server, the record corresponding to the password identification information acquired, acquiring information of a user corresponding to the identification token acquired, and transmitting the password information acquired to the second client terminal only when it is confirmed that the user is included in the disclosure permissible range indicated by the password disclosure permission information acquired.

### BRIEF DESCRIPTION OF DRAWINGS

FIG. 1A is a block diagram illustrating a functional configuration of a password sharing system according to a first aspect.

FIG. 1B is a sequence diagram illustrating an operation sequence of the functional configuration of the password sharing system according to the first aspect.

FIG. 1C is an explanatory diagram of processing (wrapping or transformation).

FIG. 1D is a block diagram illustrating a network configuration of a password sharing system according to one embodiment.

FIG. 2 is a block diagram illustrating a configuration of a password sharing server according to one embodiment.

FIG. 3 is a block diagram illustrating a configuration of a client terminal according to one embodiment.

FIG. 4 is a block diagram illustrating a configuration of a first password sharing server according to one embodiment.

FIG. 5 is a block diagram illustrating a detailed configuration of the first password sharing server according to one embodiment.

FIG. 6 is a block diagram illustrating a detailed configuration of the first password sharing server according to one embodiment.

FIG. 7 is a block diagram illustrating a detailed configuration of the first password sharing server according to one embodiment.

FIG. 8 is a diagram for describing the first password sharing server according to one embodiment.

FIG. 9 is a diagram for describing the first password sharing server according to one embodiment.

FIG. 10 is a diagram for describing the first password sharing server according to one embodiment.

FIG. 11A is a block diagram illustrating a detailed configuration of the first password sharing server according to one embodiment.

FIG. 11B is a diagram for describing processing of the first password sharing server according to one embodiment.

FIG. 12A is a block diagram illustrating a detailed configuration of the first password sharing server according to one embodiment.

FIG. 12B is a diagram for describing processing of the first password sharing server according to one embodiment.

FIG. 12C is a diagram for describing processing of the first password sharing server according to one embodiment.

FIG. 13A is a block diagram illustrating a password deletion processing unit, which is a detailed configuration of the first password sharing server according to one embodiment.

FIG. 13B is a diagram for describing processing of the password deletion processing unit according to one embodiment.

FIG. 14A is a block diagram illustrating a password disclosure period change processing unit in the detailed configuration of the first password sharing server according to one embodiment.

FIG. 14B is a diagram for describing processing of the password disclosure period change processing unit according to one embodiment.

FIG. 14C is a block diagram illustrating a password disclosure permissible range change processing unit, which is a detailed configuration of the first password sharing server according to one embodiment.

FIG. 14D is a diagram for describing processing of the password disclosure permissible range change processing unit according to one embodiment.

FIG. 15 is a block diagram illustrating a configuration of a second password sharing server according to one embodiment.

FIG. 16A is a block diagram illustrating a detailed configuration of the second password sharing server according to one embodiment.

FIG. 16B is a diagram for describing processing of the second password sharing server according to one embodiment.

FIG. 17A is a diagram for describing a processing example of a password registration processing unit in a case of key wrapping in assignment of roles in combination 3.

FIG. 17B is a block diagram of a password registration client terminal in the case of the key wrapping in the assignment of roles in combination 3.

FIG. 17C is a diagram for describing operations of the password registration client terminal in the case of the key wrapping in the assignment of roles in combination 3.

FIG. 17D is a diagram for describing a processing example of the password registration processing unit in a case of key transformation in the assignment of roles in combination 3.

FIG. 17E is a diagram for describing operations of the password registration client terminal in the case of the key transformation in the assignment of roles in combination 3.

FIG. 17F is a diagram for describing a processing example of the password registration processing unit in a case of key wrapping in assignment of roles in combination 4.

FIG. 17G is a block diagram of the password registration client terminal in the case of the key wrapping in the assignment of roles in combination 4.

FIG. 17H is a diagram for describing operations of the password registration client terminal in the case of the key wrapping in the assignment of roles in combination 4.

FIG. 17I is a diagram for describing a processing example of the password registration processing unit in a case of key transformation in the assignment of roles in combination 4.

FIG. 17J is a diagram for describing operations of the password registration client terminal in the case of the key transformation in the assignment of roles in combination 4.

FIG. 17K is a diagram for describing a processing example of a password registration processing unit in a case of key wrapping in assignment of roles in combination 5.

FIG. 17L is a block diagram of the password registration client terminal in the case of the key wrapping in the assignment of roles in combination 5.

FIG. 17M is a diagram for describing operations of the password registration client terminal in the case of the key wrapping in the assignment of roles in combination 5.

FIG. 17N is a diagram for describing a processing example of the password registration processing unit in a case of key transformation in the assignment of roles in combination 5.

FIG. 17O is a diagram for describing operations of the password registration client terminal in the case of the key transformation in the assignment of roles in combination 5.

FIG. 17P is a diagram for describing a processing example of the password registration processing unit in a case of key wrapping in assignment of roles in combination 6.

FIG. 17Q is a block diagram of the password registration client terminal in the case of the key wrapping in the assignment of roles in combination 6.

FIG. 17R is a diagram for describing operations of the password registration client terminal in the case of the key wrapping in the assignment of roles in combination 6.

FIG. 17S is a block diagram of the password registration client terminal in a case of key transformation in the assignment of roles in combination 6.

FIG. 17T is a diagram for describing operations of the password registration client terminal in the case of the key transformation in the assignment of roles in combination 6.

FIG. 17U is a diagram for describing a processing example of the password registration processing unit in a case of key wrapping in assignment of roles in combination 7.

FIG. 17V is a block diagram of the password registration client terminal in the case of the key wrapping in the assignment of roles in combination 7.

FIG. 17W is a diagram for describing operations of the password registration client terminal in the case of the key wrapping in the assignment of roles in combination 7.

FIG. 17X is a block diagram of the password registration client terminal in a case of key transformation in the assignment of roles in combination 7.

FIG. 17Y is a diagram for describing operations of the password registration client terminal in the case of the key transformation in the assignment of roles in combination 7.

FIG. 17Z is a diagram for describing a processing example of the password registration processing unit in a case of key wrapping in assignment of roles in combination 8.

FIG. 18A is a block diagram of the password registration client terminal in the case of the key wrapping in the assignment of roles in combination 8.

FIG. 18B is a diagram for describing operations of the password registration client terminal in the case of the key wrapping in the assignment of roles in combination 8.

FIG. 18C is a diagram for describing a processing example of the password registration processing unit in a case of key transformation in the assignment of roles in combination 8.

FIG. 18D is a diagram for describing operations of the password registration client terminal in the case of the key transformation in the assignment of roles in combination 8.

FIG. 19 is a block diagram illustrating a configuration of the password registration client terminal according to one embodiment.

FIG. 20 is a block diagram illustrating a detailed configuration of a first password registration client terminal according to one embodiment.

FIG. 21 is a block diagram illustrating a detailed configuration of a first password registration client terminal according to one embodiment.

FIG. 22A is a block diagram illustrating a detailed configuration of the first password registration client terminal according to one embodiment.

FIG. 22B is a diagram for describing processing of the first password registration client terminal according to one embodiment.

FIG. 23 is a diagram for describing processing of the first password registration client terminal according to one embodiment.

FIG. 24A is a block diagram illustrating a detailed configuration of a second password registration client terminal according to one embodiment.

FIG. 24B is a diagram for describing processing of the second password registration client terminal according to one embodiment.

FIG. 25A is a block diagram illustrating a detailed configuration of a third password registration client terminal according to one embodiment.

FIG. 25B is a diagram for describing processing of the third password registration client terminal according to one embodiment.

FIG. 25C is a diagram for describing processing of the third password registration client terminal according to one embodiment.

FIG. 26A is a block diagram illustrating a detailed configuration of a fourth password registration client terminal according to one embodiment.

FIG. 26B is a diagram for describing processing of the fourth password registration client terminal according to one embodiment.

FIG. 27 is a block diagram illustrating a configuration of a password acquisition client terminal according to one embodiment.

FIG. 28A is a block diagram illustrating a detailed configuration of a first password acquisition client terminal according to one embodiment.

FIG. 28B is a diagram for describing processing of the first password acquisition client terminal according to one embodiment.

FIG. 29A is a block diagram illustrating a detailed configuration of the first password acquisition client terminal according to one embodiment.

FIG. 29B is a diagram for describing processing of the first password acquisition client terminal according to one embodiment.

FIG. 30A is a block diagram illustrating a detailed configuration of a second password acquisition client terminal according to one embodiment.

FIG. 30B is a diagram for describing processing of the second password acquisition client terminal according to one embodiment.

FIG. 31 is a diagram describing combinations of execution locations of respective functional units of a password sharing system.

FIG. 32 is a diagram for describing processing of a user registration processing unit 21.

FIG. 33 is a diagram for describing processing of a user registration processing unit 31.

FIG. 34 is a diagram for describing processing of a login processing unit 22.

FIG. 35 is a diagram for describing processing of a login processing unit 32.

### DESCRIPTION OF EMBODIMENTS

A description will be given in further detail below with reference to the accompanying drawings. Preferable embodiments are illustrated in the drawings. However, many different embodiments are possible, and the embodiments described in this Description are not restrictive.

### {Password Sharing System}

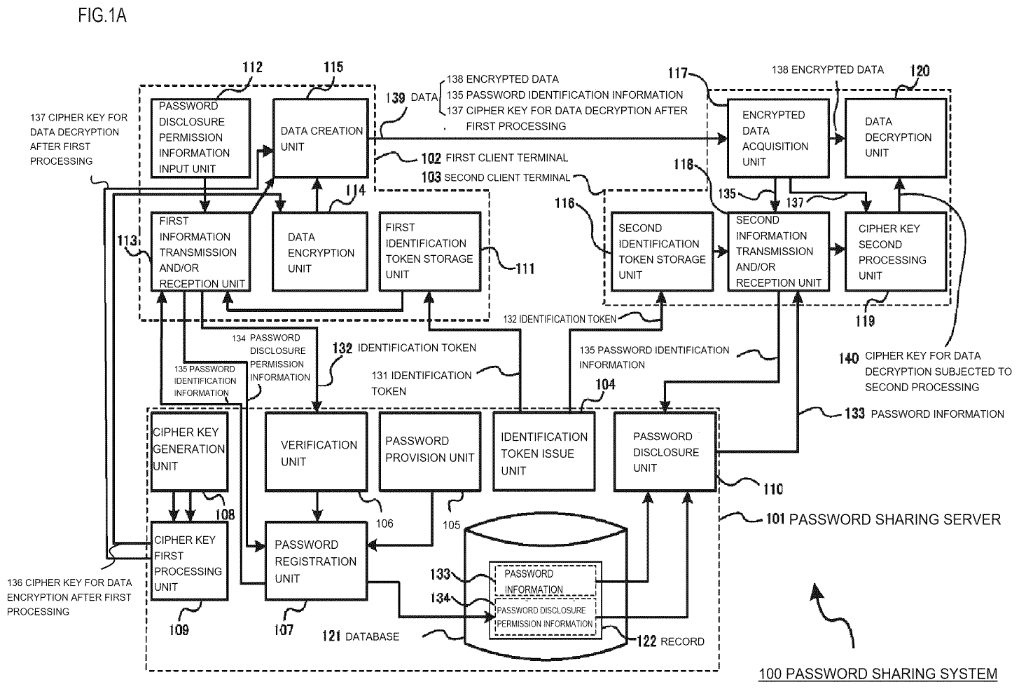

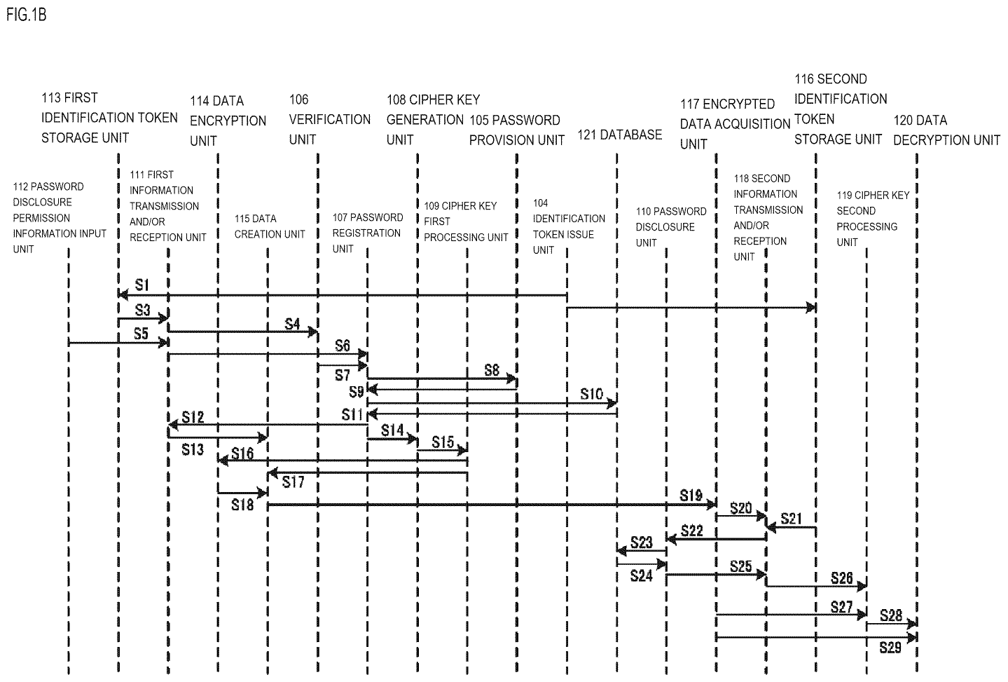

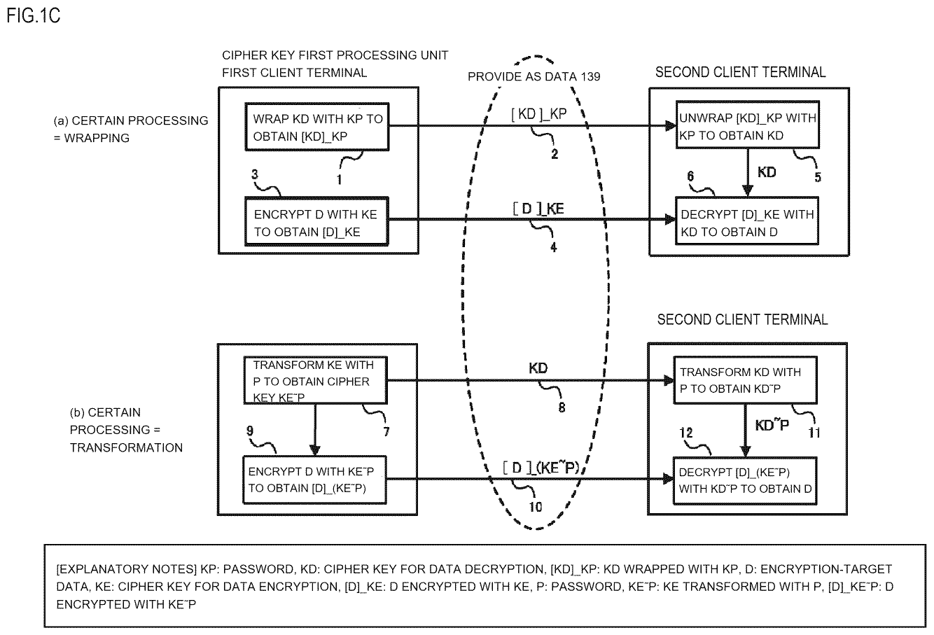

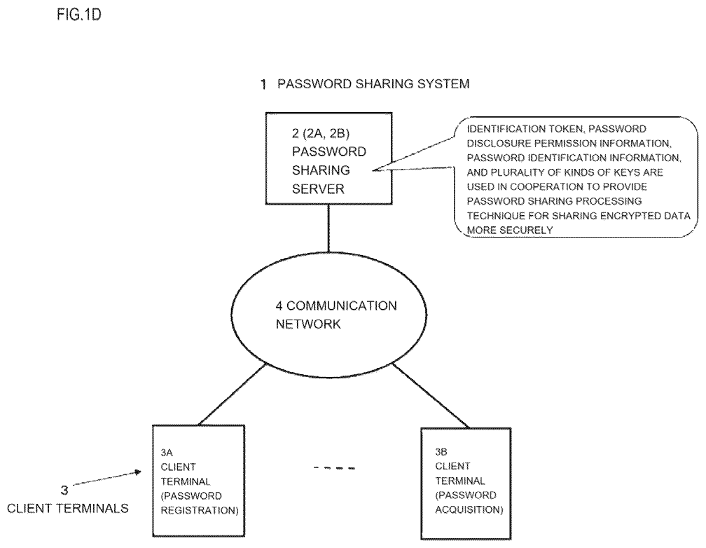

With reference to FIG. 1D illustrating a system configuration in one embodiment, a password sharing system 1 includes a password sharing server 2, a plurality of client terminals (also referred to as user terminals) 3, and a communication network 4. According to this password sharing system 1, by using an identification token, password disclosure permission information, password identification information, a password, and a plurality of kinds of keys in combination, a password sharing processing technique for more securely sharing encrypted data obtained by encrypting encryption target data is provided. The password sharing system 1 corresponds to a password sharing system 100 in FIG. 1A. The password sharing server 2 corresponds to a password sharing server 101 in FIG. 1A. Each client terminal 3 corresponds to a first client terminal 102 or a second client terminal 103 in FIG. 1A.

The communication network 4 enables wireless or wired data communication and is configured by an Internet protocol (IP) network such as the Internet, a local area network, or a virtual private network (VPN), to include the password sharing server 2 and the plurality of client terminals 3 (3A and 3B). Note that, in the following description, intervention of the communication network 4 is omitted unless otherwise causing ambiguity.

In this password sharing system 1, the password sharing server 2 is a server on the Internet, the server being operated and managed by a password sharing service provider and is operated by using facilities of a virtual server provider or a cloud operator. With this configuration, password sharing processing to be described below in detail is executed. The password sharing server 2 is implemented as a first password sharing server 2A, a second password sharing server 2B, or a third password sharing server 2C (not illustrated).

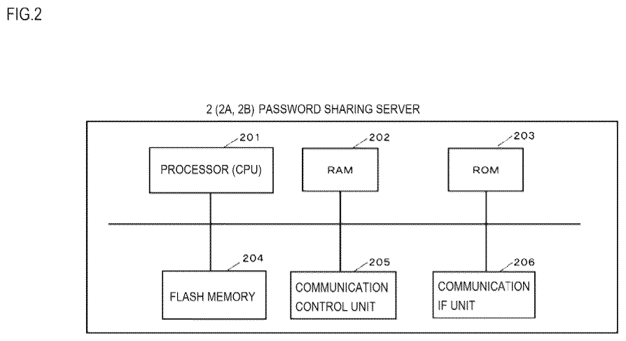

To be more specific, this password sharing server 2 has the function of data communication with the plurality of client terminals 3 and includes hardware components as illustrated in FIG. 2. Specifically, the password sharing server 2 includes a central processing unit (CPU) 201 as a processor, a random access memory (RAM) 202 as a memory for operation, and a read only memory (ROM) 203 storing therein a boot program for boot-up.

The password sharing server 2 further includes a nonvolatile flash memory 204 storing therein an operating system (OS), an application program, and various kinds of information (including data) in a rewritable manner, a communication control unit 205, a communication interface (IF) unit 206 such as a network interface card (NIC), and the like.

The password sharing server 2 includes a user registration processing unit (first processing unit) 21, a login processing unit 22, a user relationship holding processing unit 23, a password registration processing unit (second processing unit) 24, a password disclosure processing unit (third processing unit) 25, a password deletion processing unit 26, a password disclosure period change processing unit 27, and the like as functional components to be described below in detail.

As an example, to logically implement these functional components in the password sharing server 2, a password sharing processing program is installed in advance in the flash memory 204 as an application program. Then, in the password sharing server 2, upon indication or power-on by an operator (manager), the processor (CPU) 201 continuously develops this processing program in the RAM 202 for execution. The password sharing processing program executes the password sharing processing in cooperation with the above-described hardware components.

In this password sharing system 1, each client terminal 3 is a single unit or a combined unit of user terminals having a wireless or wired data communication function such as a mobile phone terminal including a smartphone and a computer terminal including a personal computer and a tablet terminal, and is assigned with a telephone number, an e-mail address, and/or an IP address.

Each client terminal 3 is implemented as the client terminal 3A having a password registration function (corresponding to the first client terminal 102 in FIG. 1A) or the client terminal 3B having a password acquisition function (corresponding to the second client terminal 103 in FIG. 1A). One client terminal 3 may be configured to have the password registration function and the password acquisition function.

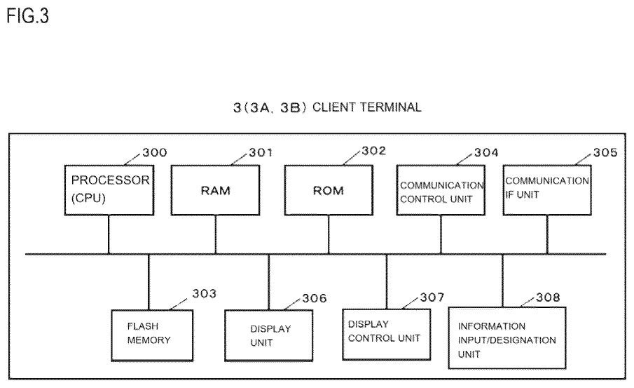

To be more specific, each of the plurality of client terminals 3 (3A and 3B) in the password sharing system 1 includes hardware components as illustrated in FIG. 3. Specifically, the client terminal 3 includes a CPU 300 as a processor, a RAM 301 as a memory for operation, and a ROM 302 storing therein a boot program for boot-up.

The client terminal 3 further includes a nonvolatile flash memory 303 storing therein an OS, an application program, and various kinds of information (including data) in a rewritable manner, a communication control unit 304 having a wireless and wired data communication function, and a communication interface (IF) unit 305 such as an NIC.

The client terminal 3 further includes a display unit 306 including a display (liquid crystal display (LCD)), a display control unit 307, and an information input/designation unit 308 including ten keys, various kinds of function buttons (keys), a pointing unit, a cursor moving unit, and the like.

Each client terminal 3 selectively includes a user registration processing unit 31, a login processing unit 32, a password registration processing unit 33, a data creation processing unit 34, a password acquisition processing unit 35, a data decryption processing unit 36, and the like, as functional components to be described below in detail, according to each embodiment (example).

As an example, to logically implement these functional components in each client terminal 3, a terminal control program for password sharing processing is installed in the flash memory 303 as an application program. Then, in the client terminal 3, upon indication or power-on by a user, the processor (CPU) 300 develops this terminal control program in the RAM 301 for execution. The terminal control program executes the password sharing processing in cooperation with the above-described hardware components.

### {Details of First Password Sharing Server}

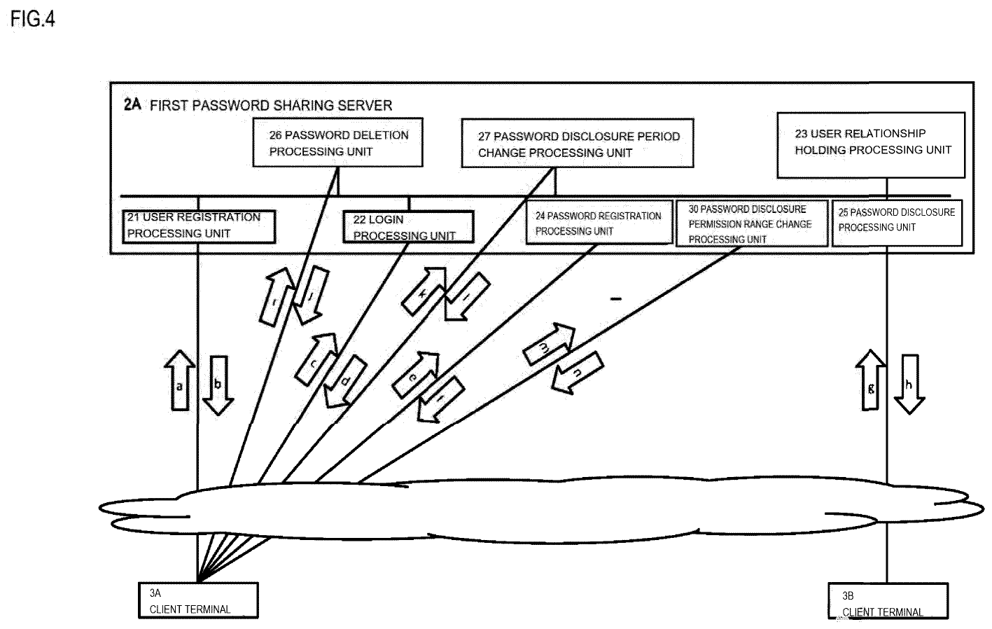

Details of the first password sharing server 2A in the password sharing system 1 will be described with reference to FIG. 1D, FIG. 4, and related drawings together.

With reference to FIG. 4, the first password sharing server 2A includes the user registration processing unit 21, the login processing unit 22, the user relationship holding processing unit 23, the password registration processing unit 24, the password disclosure processing unit 25, the password deletion processing unit 26, and the password disclosure period change processing unit 27 as functional components.

Here, the basic feature elements of the first password sharing server 2A are the user registration processing unit (corresponding to the identification token issue unit 104 in FIG. 1A) 21, the password registration processing unit (corresponding to the password registration unit 107 in FIG. 1A) 24, and the password disclosure processing unit (corresponding to the password disclosure unit 110 in FIG. 1A) 25.

In other words, the first password sharing server 2A is a password sharing server (corresponding to the password sharing server 101 in FIG. 1A) applicable to the password sharing system 1 including the password registration client terminal 3A (corresponding to the first client terminal 102 in FIG. 1A) used by a first user and the password acquisition client terminal 3B (corresponding to the second client terminal 103 in FIG. 1A) used by a second user and includes the user registration processing unit 21 configured to issue an identification token (proof) indicating that a corresponding user is an authenticated user. The identification token will be described later.

The first password sharing server 2A includes the password registration processing unit 24 configured to receive an identification token issued by the user registration processing unit 21 and corresponding to the first user (corresponding to the identification token 131 in FIG. 1A), a password (corresponding to a password information 133 in FIG. 1A), and password disclosure permission information (corresponding to a password disclosure permission information 134 in FIG. 1A) designating the disclosure permissible range for the password, from the first client terminal 3A, store the password and the password disclosure permission information in a database, and transmit, only when the identification token is confirmed to be a correct identification token (identification token corresponding to the first user) through verification, password identification information (password ID) (corresponding to password identification information 135 in FIG. 1A) for identifying the stored password and password disclosure permission information in the database (corresponding to a database 121 in FIG. 1A), to the first client terminal 3A.

Note that the password may be created by the first user or may be automatically generated by a program, and a method of generating the password is not limited to these. In this embodiment, a function corresponding to the password provision unit 105 in FIG. 1A is included in the first client terminal 3A (corresponding to the first client terminal 102 in FIG. 1A).

A cookie may be used for transmission of an identification token from a client to a server. In this case, it is assumed that the server has transmitted the identification token as a cookie to the client terminal in advance.

Further, the first password sharing server 2A includes the password disclosure processing unit (third processing unit) 25 configured to receive an identification token issued by the user registration processing unit 21 and corresponding to a second user (corresponding to an identification token 132 in FIG. 1A) and the password ID acquired by reading the data output by the first client terminal 3A (corresponding to the data 139 in FIG. 1A) and transmitted from the password registration processing unit 24, from the second client terminal 3B, acquire information of the second user identified by the identification token corresponding to the second user, acquire the password (corresponding to the password information 133 stored in a record 122 in the database 121 in FIG. 1A) identified by the password ID received from the second client terminal 3B and the password disclosure permission information (corresponding to the password disclosure permission information 134 similarly stored in the record 122 in FIG. 1A), from the database (corresponding to the database 121 in FIG. 1A), and transmit, only when it is confirmed that the second user is included in the password disclosure permissible range designated by the password disclosure permission information acquired from the database, the password identified by the password ID to the second client terminal 3B.

The first password sharing server 2A can adopt any of the following aspects. Note that [Aspect 1] to [Aspect 4] are also applicable to the second password sharing server 2B and the third password sharing server 2C to be described later.

[Aspect 1] In the first password sharing server 2A, the password disclosure permission information includes at least one of a relationship between users registered to the first password sharing server 2A in advance, designation of a user group registered to the first password sharing server 2A in advance, and a list of e-mail addresses. Regarding the list of e-mail addresses, the client terminal 3A may transmit the list of e-mail addresses as the password disclosure permission information.

[Aspect 2] In the first password sharing server 2A, the password registration processing unit 24 receives a password disclosure period together with the identification token from the first client terminal 3A and stores the password disclosure period in a database, and the password disclosure processing unit 25 acquires the password disclosure period together with the password identified by the received password ID, from the database, and transmits, when a current time is within the password disclosure period, the password identified by the password ID, to the second client terminal 3B.

[Aspect 3] In the first password sharing server 2A, the password registration processing unit 24 transmits a password owner ID (password owner identification information) or a URL for password acquisition to the first client terminal 3A.

[Aspect 4] In the first password sharing server 2A, the password disclosure processing unit 25 receives a first password owner ID together with the identification token and the password ID from the second client terminal 3B, acquires a second password owner ID together with the password identified by the password ID, from the database, and transmits, when the first password owner ID and the second password owner ID match, the password identified by the password ID, to the second client terminal 3B.

Next, further details of the first password sharing server 2A in the password sharing system 1 will be described with reference to FIGS. 1A to 1D, FIG. 4, and related drawings together.

With reference to FIG. 4, the user registration processing unit 21, the login processing unit 22, the user relationship holding processing unit 23, the password registration processing unit 24, the password disclosure processing unit 25, the password deletion processing unit 26, and the password disclosure period change processing unit 27 configuring the first password sharing server 2A share part of detailed components as will be described later in detail.

As illustrated in FIG. 4, the first password sharing server 2A transmits/receives the following various data a to n to/from the password registration client terminal 3A and the password acquisition client terminal 3B. Note that data with a “*” mark described below is optional data and is not used in some examples.

[Data a] at temporary registration: e-mail address, password; at formal registration: token for registration, e-mail address, password
[Data b] at temporary registration: token for registration, URL for registration; at formal registration: identification token
[Data c] e-mail address, password
[Data d] identification token
[Data e] identification token, password, password disclosure permission information, *password disclosure period
[Data f] password ID, *password owner ID, *URL for password acquisition
[Data g] identification token, password ID, *password owner ID
[Data h] password
[Data i] identification token, password ID
[Data j] *result: success or failure
[Data k] identification token, password ID, password disclosure period
[Data l] *result: success or failure
[Data m] identification token, password ID, password disclosure permission information
[Data n] *result: success or failure

Here, a user to encrypt data (encryption target data) and register a password uses the password registration processing unit 24, and a user to request disclosure of the password to decrypt the data (encrypted data) uses the password disclosure processing unit 25. These users may be the same user but are separate in general, and hence the password registration client terminal 3A and the password acquisition client terminal 3B are illustrated.

An “e-mail address” in this Description indicates an ID (identification information) for identifying a reception user in communication in general. For example, a phone number may be used instead of an e-mail address. Any ID usable as an ID for identifying a reception user in communication, such as an ID of an SNS (for example, a LINE ID, “LINE” is a registered trademark of LINE Corporation) and a handle name may be used.

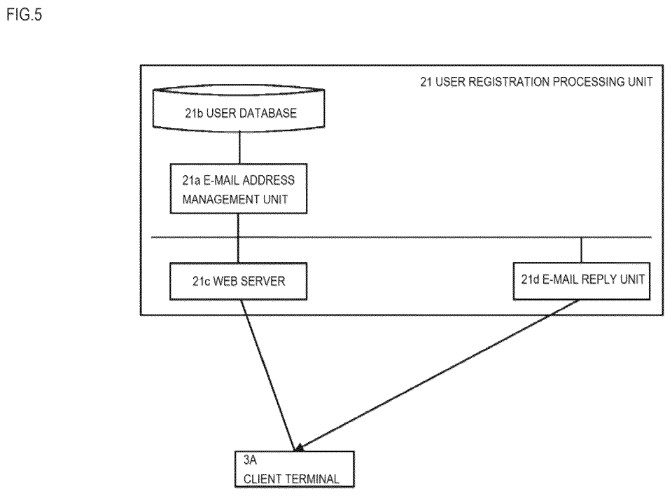

With reference to FIG. 5, the user registration processing unit 21 in the first password sharing server 2A is configurable to include an e-mail address management unit 21a, a user database 21b, a web server (here, a web server function unit) 21c, and an e-mail reply unit 21d, as detailed components.

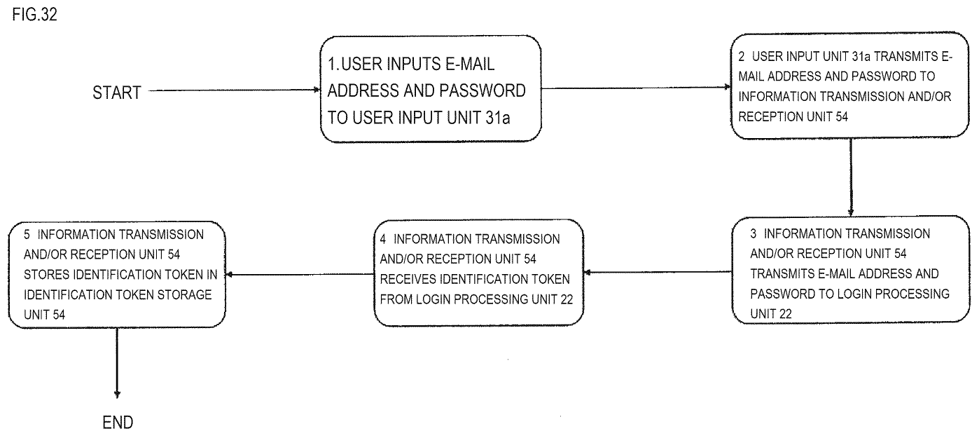

In the processing in this user registration processing unit 21, several methods are carried out in various Internet services. Here, one example of the methods will be described. FIG. 5 illustrates a configuration of the user registration processing unit 21. FIG. 32 illustrates operations of the user registration processing unit 21.

In the user registration processing unit 21, the e-mail address management unit 21a, the user database 21b, the web server 21c, and the e-mail reply unit 21d cooperate to temporarily register an e-mail address used by a user and a password and confirm that the user is the owner of the e-mail address for formal registration. The user cannot use the service of the first password sharing server 2A until the formal registration is completed. As will be described below, to use the various services of this server, an identification token generated by the user registration processing unit 21 is needed.

In the user registration processing unit 21, to confirm that the e-mail address temporarily registered by the user is the e-mail address of the user, the e-mail reply unit 21d transmits a token for registration in an e-mail to a registered e-mail address. The token for registration is transmitted as a readable character string. The token for registration is given as a query parameter of a uniform resource locator (URL) for registration. When the user who has received the e-mail clicks the URL for registration, the web server 21c can acquire the token for registration as the query parameter. The URL for registration is a URL for the user to access the web server 21c from the password registration client terminal 3A.

The token for registration includes information specific to the temporarily registered user generated by the e-mail address management unit 21a. The information is the ID or the like of the user temporarily registered to the user database 21b. The e-mail address management unit 21a searches the user database 21b by using the token for registration to thereby be able to acquire the e-mail address and the password of the temporarily registered user.

The web server 21c asks the temporarily registered user who has received the e-mail and accessed the first password sharing server 2A, to input the e-mail address and the password. Consequently, the e-mail address management unit 21a confirms that the e-mail receiver is the user who has made temporary registration. Upon confirmation that the e-mail address and the password input by the user match the e-mail address and the password of the temporarily registered user, the e-mail address management unit 21a formally registers the user to the user database 21b.

After the formal registration, the e-mail address management unit 21a generates an identification token for the registered user, and the web server 21c transmits the identification token to the password registration client terminal 3A. The identification token is different from the token for user registration. The identification token includes information specific to the user, for example, the ID of the user in the user database 21b, and the user can be identified by the identification token.

Note that the web server 21c may transmit the identification token as a cookie to the client terminal 3A.

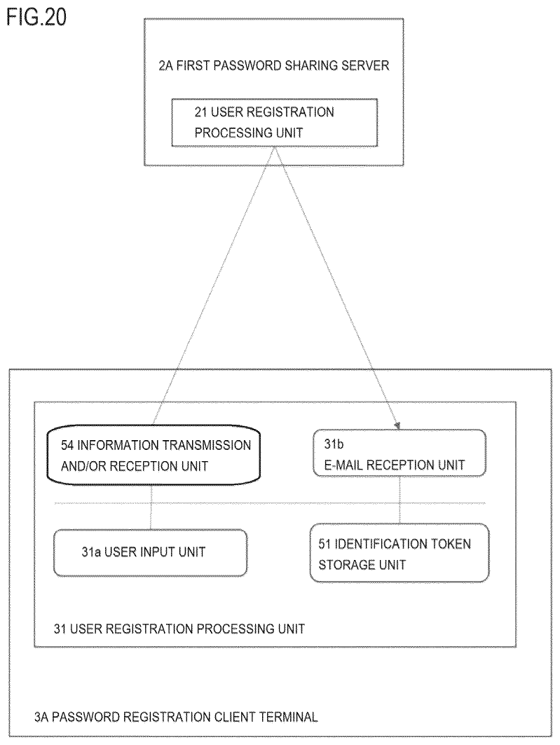

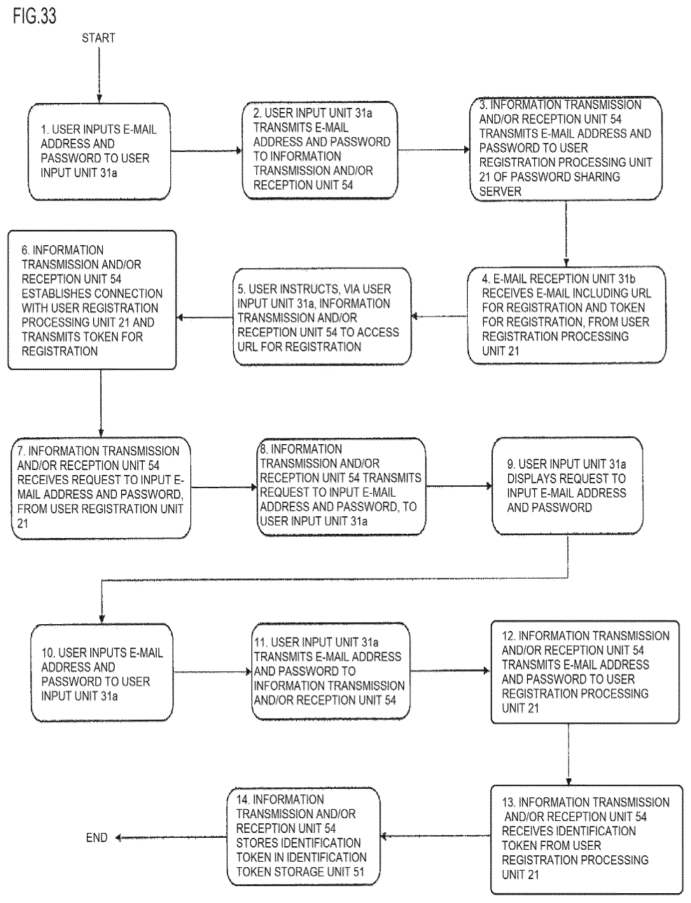

The corresponding client terminal 3A includes the user registration processing unit 31. FIG. 20 illustrates a configuration of the user registration processing unit 31. The user registration processing unit 31 includes another processing unit, an information transmission and/or reception unit 54, and an identification token storage unit 51. FIG. 33 illustrates operations of the user registration processing unit 31. The e-mail address of the user registration processing unit 21 of the password sharing server 2A is described in a URL for registration.

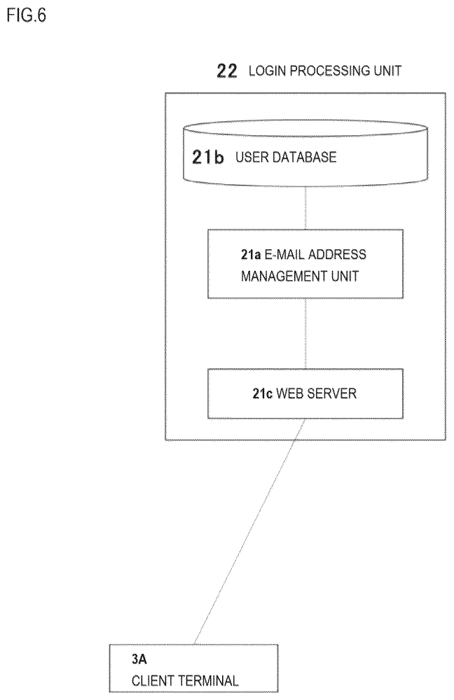

With reference to FIG. 6, the login processing unit 22 in the first password sharing server 2A is configurable to include the e-mail address management unit 21a, the user database 21b, and the web server 21c, as detailed components. These components are shared with the user registration processing unit 21.

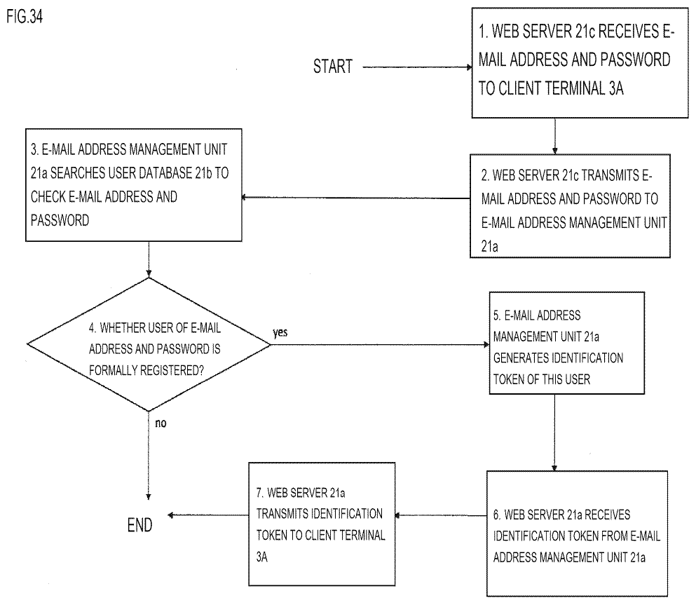

In the processing in this login processing unit 22, several methods are carried out in various Internet services. Here, one example of the methods will be described. FIG. 6 illustrates a configuration of the login processing unit 22. FIG. 34 illustrates operations of the user registration processing unit 21.

In the login processing unit 22, the e-mail address management unit 21a, the user database 21b, and the web server 21c cooperate to reissue an identification token to the formally registered user. This is a necessary procedure for such an identification token set with a term of validity. In other words, the login processing unit 22 has a function of issuing an identification token to the formally registered user and issuing, when the identification token expires, a new identification token to the user. When the user uses the first password sharing server 2A from a plurality of password registration client terminals 3A, the user storing an identification token in each password registration client terminal 3A to use can increase convenience.

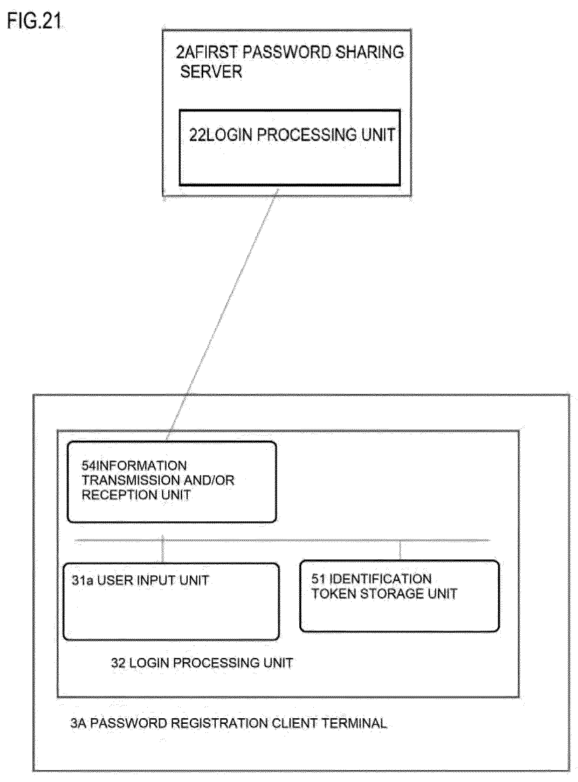

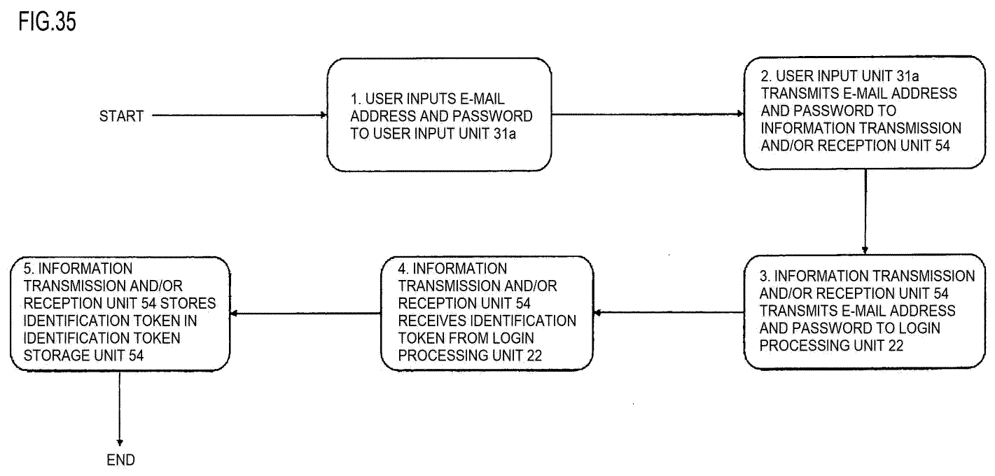

The corresponding client terminal 3A includes the login processing unit 32. FIG. 21 illustrates a configuration of the user registration processing unit 31. The login processing unit 32 includes another processing unit, the information transmission and/or reception unit 54, and the identification token storage unit 51. FIG. 35 illustrates operations of the login processing unit 32.

The identification token is evidence (proof) that the e-mail address is authenticated. The authentication of the e-mail address indicates that a system (server) successfully confirms that the user who has temporarily registered the e-mail address has received an e-mail destined to the e-mail address. In general, a function of providing authentication of an e-mail address to another system is present. For example, a mechanism called OAuth provides the function. The first password sharing server 2A may use this OAuth mechanism to thereby issue an identification token based on the authentication of the e-mail address.

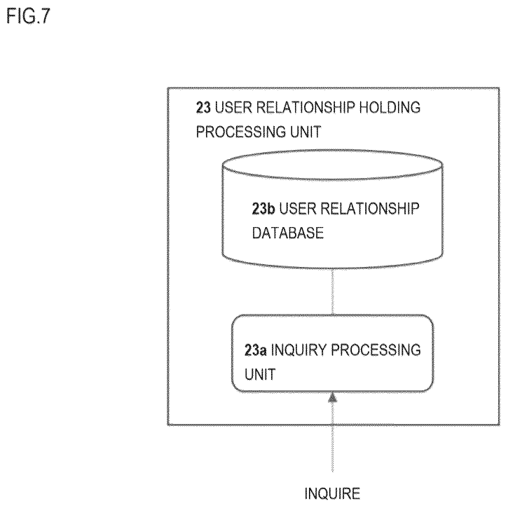

With reference to FIG. 7, the user relationship holding processing unit 23 in the first password sharing server 2A is configurable to include an inquiry processing unit 23a and a user relationship database 23b, as detailed components.

In the processing in this user relationship holding processing unit 23, the user registering a password to the first password sharing server 2A registers a relationship between the user and another user to the user relationship database 23b from the password registration client terminal 3A in advance. In response to an inquiry/question [U, R, u] about a user U, a user u, and a relationship R between users from the password disclosure processing unit 25, the inquiry processing unit 23a returns an answer [yes (positive judgment)] or [no (negative judgment)].

The user subjected to the processing in the user relationship holding processing unit 23 is expressed by the e-mail address used by the user as an example. An example of the relationship R between users is any of “family”, “good friend”, “friend”, “friend of friend”, and “others”.

This relationship R between users may be designation of the group to which the user U and the user u belong. In this case, the user relationship holding processing unit 23 answers [yes] when the user U and the user u belong to a group of the relationship R between users, and answers [no] otherwise. As the relationship R between users, a plurality of groups may be designated. In this case, the user relationship holding processing unit 23 answers [yes] when the user U and the user u both belong to any of the groups included in the relationship R between users, and answers [no] otherwise. Further, as designation of a relationship between users, “following/followed” used by Twitter (registered trademark of US “Twitter, Inc.”) and the like can be used.

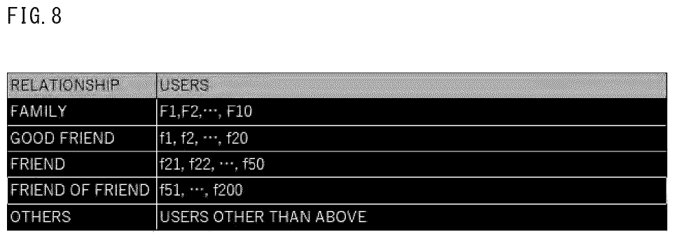

The user relationship database 23b in the user relationship holding processing unit 23 stores therein a list illustrated in FIG. 8 for the user U. This list is a user relationship table for the user U. The user relationship table for the user U is registered in advance to the user relationship database 23b in the user relationship holding processing unit 23 by the user U. Note that the relationship R between users is assumed to have an order relation of “family”>“good friend”>“friend”>“friend of friend”>“others”.

Upon receipt of an inquiry [U, friend, f20], the inquiry processing unit 23a interprets this inquiry as “whether U and f20 are friends?” According to the user relationship table, U and f20 are of good friend, and good friend has an order relation higher than that of friend. Hence, the answer from the inquiry processing unit 23a to this inquiring is [yes].

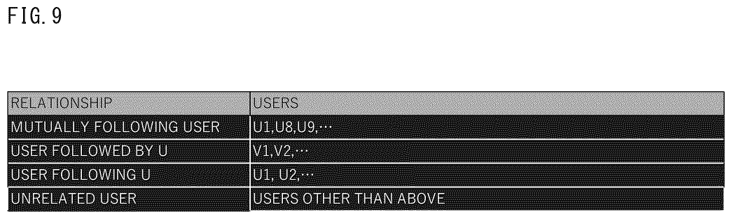

As the relationship R between users, when “following/followed” described above is used, the user relationship holding processing unit 23 stores the user relationship table illustrated in FIG. 9 for each user U. In this user relationship table, “mutually following user” is a product set of a set of “users followed by U” and a set of “users following U”. It is assumed that the product set (set of mutually following users) is excluded from both the set of “users followed by U” and the set of “users following U”. It is assumed that the relationship R between users has an order relation of “mutually following user”>“user followed by U”>“users following U”>“unrelated user”.

In the case of this example, in the user relationship holding processing unit 23, the inquiry processing unit 23a receives an inquiry [U, mutual follow, U2]. The inquiry processing unit 23a interprets this inquiry as “whether U2 is a user having a relationship of mutual follow with U?” According to the user relationship table illustrated in FIG. 9, U2 follows U but is not followed by U. Mutual follow has an order relation higher than that of a case of being simply followed. In other words, a user simply following U does not have a relationship of mutual follow. Hence, the answer from the inquiry processing unit 23a to this inquiry is [no].

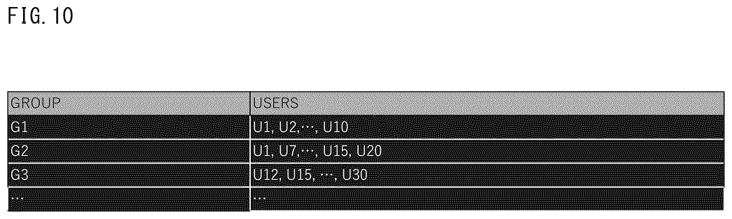

The user relationship database 23b in the user relationship holding processing unit 23 may store therein a list of groups illustrated in FIG. 10 for the user U. The user registers this list to the user relationship database 23b from the password registration client terminal 3A in advance, for example.

In the case of this example, in the user relationship holding processing unit 23, the inquiry processing unit 23a receives an inquiry [u, {G1, G2, . . . , GN}, f]. The inquiry processing unit 23a interprets this inquiry as “whether a group including f is included in groups G1 to GN for u?” The inquiry processing unit 23a checks whether the members of the groups G1 to GN for the user u include a user f, on the basis of the list of groups illustrated in FIG. 10 in the user relationship database 23b. Then, the inquiry processing unit 23a answers [yes] when the user f is included and answers [no] otherwise.

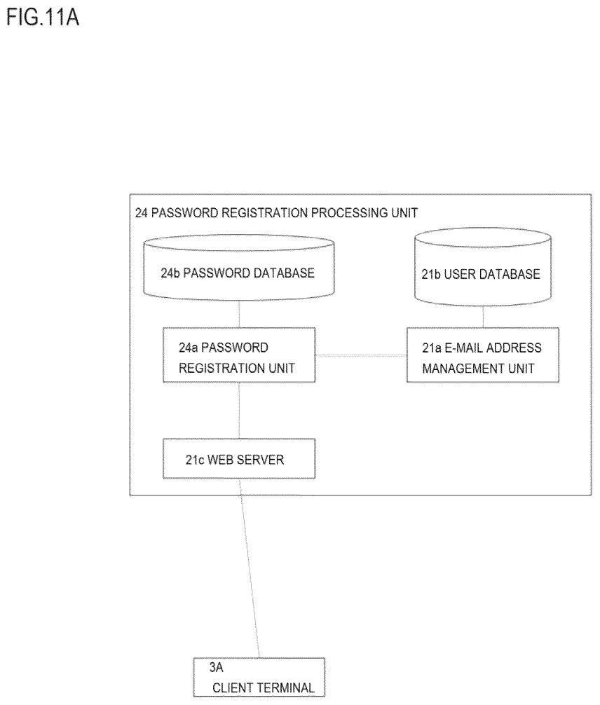

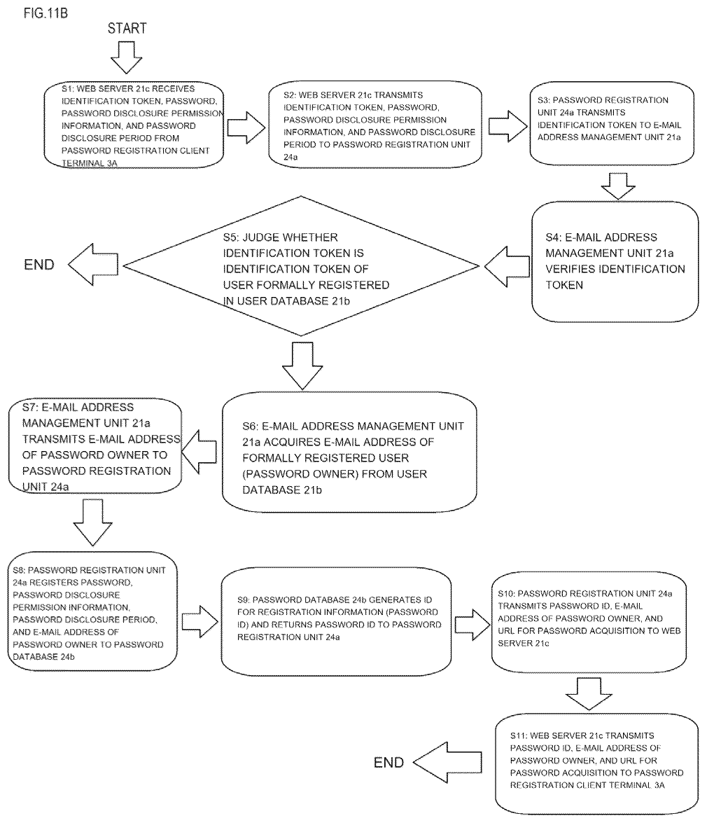

With reference to FIG. 11A, the password registration processing unit 24 in the first password sharing server 2A is configurable to include the e-mail address management unit 21a, the user database 21b, the web server 21c, a password registration unit 24a, and a password database 24b, as detailed components. The e-mail address management unit 21a, the user database 21b, and the web server 21c of the components are shared with other processing units.

In the processing in this password registration processing unit 24, the password registration unit 24a receives an identification token, a password, and password disclosure permission information from the password registration client terminal 3A via the web server 21c. The password registration unit 24a cooperates with the e-mail address management unit 21a and the user database 21b to verify the identification token and confirms that this is the user formally registered to the user registration processing unit 21.

The password registration unit 24a cooperates with the e-mail address management unit 21a and the user database 21b to acquire the e-mail address of the user and register the e-mail address to the password database 24b together with the password and the password disclosure permission information. The password database 24b generates password identification information (password ID) for identifying the information registered and returns the password ID to the password registration unit 24a. The user who has registered a password is referred to as the password owner of the password.

The identification token transmitted from the password registration client terminal 3A to the password registration processing unit 24 is one generated by the user registration processing unit 21 or the login processing unit 22 here. The password registration client terminal 3A transmits the identification token to indicate that this is the user formally registered to the first password sharing server 2A.

The password registration processing unit 24 may receive a password disclosure period from the password registration client terminal 3A in addition to the identification token, the password, and the password disclosure permission information. Concrete examples of the password disclosure period are a password disclosure start time corresponding to the time at which disclosure of the password starts and a password disclosure end time corresponding to the time at which the disclosure of the password ends. When the password disclosure start time is valid, the password disclosure processing unit 25 to be described below does not transmit the password to the password acquisition client terminal 3B before the password disclosure start time. When the password disclosure end time is valid, the password disclosure processing unit 25 does not transmit the password to the password acquisition client terminal 3B after the password disclosure end time.

The password registration unit 24a stores the password owner ID in the password database 24b in addition to the password, the password disclosure permission information, and the e-mail address. The password owner ID is stored to verify the password owner at password disclosure. The password owner ID is information for identifying the password owner in the user database 21b. For example, the user ID of the password owner in the user database 21b can be used as the password owner ID. Alternatively, the e-mail address of the password owner can be used as the password owner ID. This is because, by searching the user database 21b by using the e-mail address of the password owner, the password owner can be identified.

Next, a cipher key will be described. In a case of symmetric key encryption (common key encryption) such as the Advanced Encryption Standard (AES), a key for data encryption and a key for data decryption are identical.

In contrast, in a case of public key encryption such as elliptic curve cryptography, a key for data encryption and a key for data decryption are different from each other. In public key encryption, a private key may be used for data encryption while a public key may be used for data decryption. However, the keys may be used inversely. Specifically, a public key may be used for data encryption while a private key may be used for data decryption.

To encrypt a huge volume of data by public key encryption, symmetric key encryption is interposed in general. For example, a symmetric key k is used to encrypt data (encryption target data) D to obtain encrypted data k[D]. The symmetric key k is further encrypted with a public key Kp to create Kp[k]. At this event, a private key Ks can be regarded as a cipher key for data decryption. Here, Ks is a private key paired with the public key Kp. This is because, when the encrypted data k[D] and the symmetric key Kp[k] are obtained, Kp[k] is decrypted with Ks to obtain k, and k[D] is decrypted with k to obtain D. In general, when n (n is a positive integer) cipher keys {ke1, ke2, . . . , ken} are used for data encryption to create encrypted data and the encrypted data is decrypted with N (N is a positive integer) cipher keys {kd1, kd2, . . . , kdN} to return to the original data, {ke1, ke2, . . . , ken} are referred to as cipher keys for data encryption while {kd1, kd2, . . . , kdN} are referred to as cipher keys for data decryption.

A generation source of a key will be described. A symmetric-key cipher key is generated by using a random number in general. For example, a 32-byte (=256-bit) random number can be used directly as an AES key. Alternatively, by generating a sufficiently large (for example, 1 kilobyte) random number and applying a one-way function such as Secure Hash Algorithm 256 (SHA-256) to this random number to obtain a 32-byte bit string, the bit string may be used as an AES key. This similarly applies to a case of an asymmetric-key encryption (public key encryption) key. For example, in elliptic curve cryptography, a large random number is generated and used as a private key. Then, a public key corresponding to this private key is computed in a predetermined method. Data being a source for generation of a cipher key is referred to as a generation source of the cipher key.

In the password sharing system 1, a cipher key for data encryption and the generation source of the cipher key for data encryption are considered the same. Similarly, a cipher key for data decryption and the generation source of the cipher key for data decryption are considered the same. A cipher key transmitted/received between the password sharing server 2 and a client terminal 3 may be the cipher key itself or may be the generation source of the cipher key (cipher key generation source information). When the password sharing server 2 receives the generation source of the cipher key instead of the cipher key for data decryption from the client terminal 3, what is stored as the cipher key for data decryption by the password sharing server 2 in the database may be the generation source or may be the cipher key generated from the generation source. The client terminal 3 generates the cipher key from the generation source and uses the cipher key for encryption/decryption of data. Note that, in some embodiments, the processing of deriving a cipher key for data decryption based on the password information received at the second client terminal may be referred to as “second processing.” A functional unit that performs this second processing may be called a “cipher key second processing unit.” These correspond to the cipher key second processing unit and the second processing described in the claims.

The password disclosure permission information transmitted from the password registration client terminal 3A to the password registration processing unit 24 is information defining a disclosure target (password disclosure permissible range) of the password transmitted together with the password disclosure permission information. The password disclosure permission information is “friend”, for example. This is information designating the relationship R between users in the user relationship holding processing unit 23. Alternatively, this may be designation of a group when a list of user groups as that illustrated in FIG. 10 is stored in the user relationship holding processing unit 23.

The password disclosure permission information may be an e-mail address of a corresponding user. A plurality of e-mail addresses can be designated. In this case, the password disclosure permission information is a list of the e-mail addresses. As the password disclosure permission information, both the relationship R between users in the user relationship holding processing unit 23 and the list of e-mail addresses can be designated. An example is also conceivable where the password registration processing unit 24 receives only the list of e-mail addresses as the password disclosure permission information. In this case, the first password sharing server 2A does not include the user relationship holding processing unit 23.

Note that the e-mail address included in the password disclosure permission information does not need to be an e-mail address of a user formally registered in the user registration processing unit 21. At the time of password registration, a password owner can designate an e-mail address of a user not formally registered yet, as a disclosure destination. The first password sharing server 2A discloses the password after the user is formally registered.

The password registration processing unit 24 transmits a password ID to the password registration client terminal 3A. The password ID is an ID for uniquely identifying the password, the password disclosure permission information, the e-mail address of the password owner, or the password owner ID in the password database 24b. The password registration processing unit 24 may transmit the password owner ID in addition to the password ID to the password registration client terminal 3A. The password registration processing unit 24 may transmit the URL for password acquisition in addition to the password ID to the password registration client terminal 3A. The URL for key acquisition is the URL of the password acquisition destination. As will be described below, for password disclosure, the password acquisition client terminal 3B accesses the URL for password acquisition to acquire the password and transmits the password ID.

In the processing in the password registration processing unit 24, the password owner ID is an e-mail address. The URL for password acquisition is assumed to be held by the password registration unit 24a. The password owner is a user who transmits an identification token to the password registration processing unit 24. The formally registered user identified by the identification token in the user database 21b is the password owner. In the example, the e-mail address of the password owner is also used as a password owner ID.

In the processing in the password registration processing unit 24, the web server 21c receives the password disclosure period, and the password disclosure period may be either a password disclosure start time or a key start end time. When the password disclosure start time is not designated, the password registration processing unit 24 assumes that the current time is the password disclosure start time. When the password disclosure end time is not designated, the password registration processing unit 24 assumes that the password disclosure end time is one week after the password disclosure start time, for example. When the password registration processing unit 24 defines the password disclosure start time or the password disclosure end time, it is assumed that appropriate setting is made so that a relationship password disclosure start time ≥password disclosure end time is established. Moreover, also when the password disclosure period is not received, the first password sharing server 2A may uniquely set the password disclosure period in some cases. For example, it is conceivable that one week after reception of a request for password registration is set as a tacit password disclosure end time.

With reference to FIG. 11A and FIG. 11B together, in the password registration processing unit 24, the following detailed processing steps are executed as an example.

[S1 (refer to FIG. 11B)] The web server 21c receives an identification token, a password, password disclosure permission information, and a password disclosure period from the password registration client terminal 3A.
[S2] The web server 21c transmits the identification token, the password, the password disclosure permission information, and the password disclosure period to the password registration unit 24a.
[S3] The password registration unit 24a transmits the identification token to the e-mail address management unit 21a.
[S4] The e-mail address management unit 21a verifies the identification token.
[S5] Whether the identification token is the identification token of a user formally registered to the user database 21b is judged. When it is [no] (negative judgment), the procedure is terminated. When it is [yes] (positive judgment), the processing advances to processing step S6.
[S6] The e-mail address management unit 21a acquires the e-mail address of the formally registered user (password owner) from the user database 21b.
[S7] The e-mail address management unit 21a transmits the e-mail address of the password owner to the password registration unit 24a.
[S8] The password registration unit 24a registers the password, the password disclosure permission information, the password disclosure period, and the e-mail address of the password owner to the password database 24b.
[S9] The password database 24b generates an ID (password ID) for the registration information and returns the password ID to the password registration unit 24a.
[S10] The password registration unit 24a transmits the password ID, the e-mail address of the password owner, and the URL for password acquisition to the web server 21c.
[S11] The web server 21c transmits the password ID, the e-mail address of the password owner, and the URL for password acquisition to the password registration client terminal 3A.

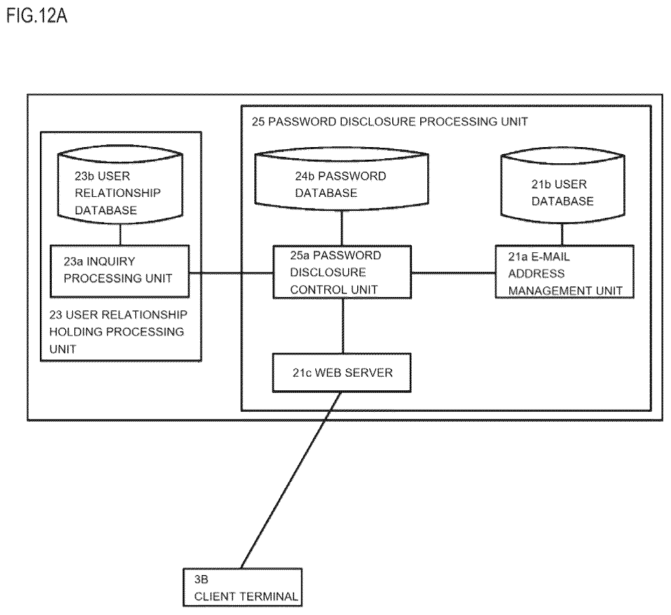

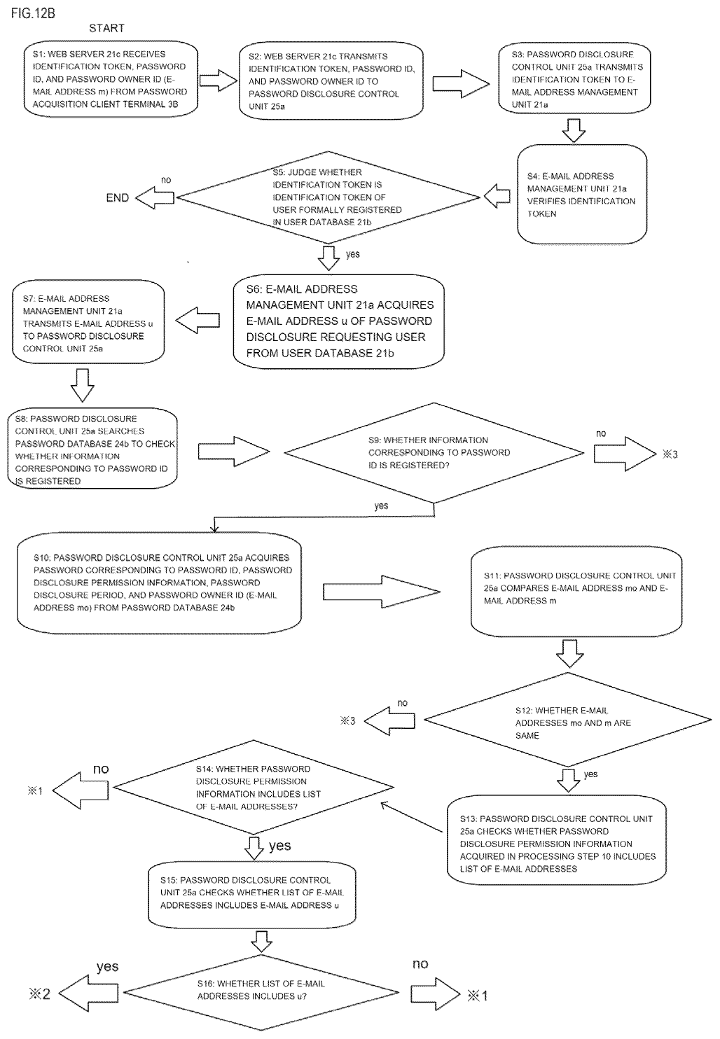

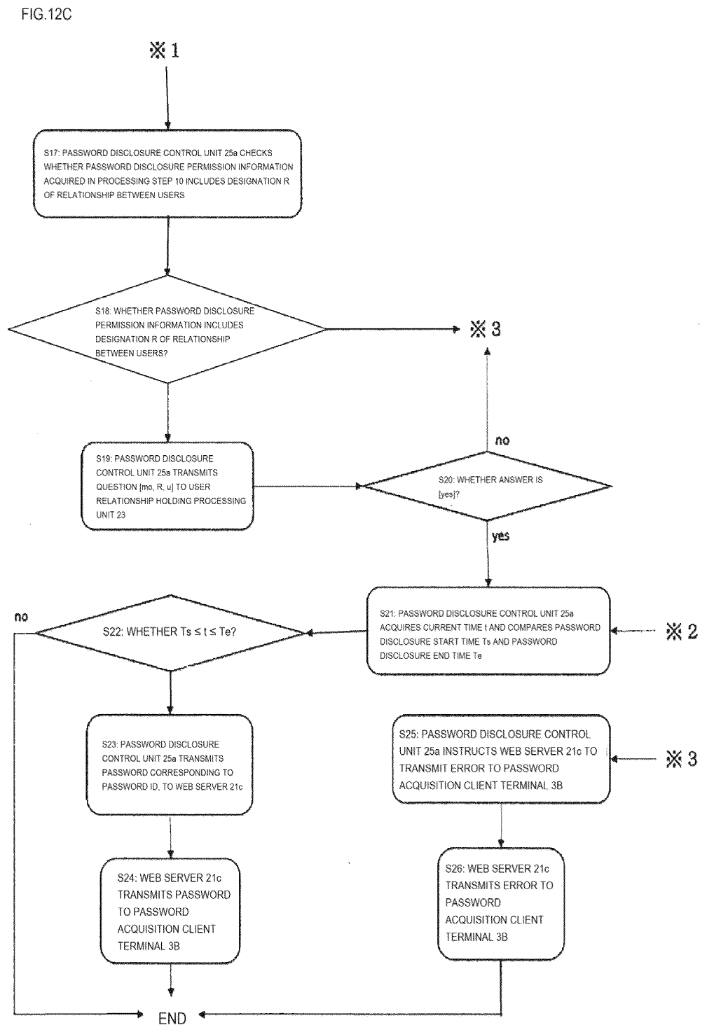

With reference to FIG. 12A, the password disclosure processing unit 25 in the first password sharing server 2A is configurable to include the e-mail address management unit 21a, the user database 21b, the web server 21c, a password disclosure control unit 25a, and the password database 24b, as detailed components. The e-mail address management unit 21a, the user database 21b, the web server 21c, and the password database 24b of the components are shared with other processing units.

In the processing in this password disclosure processing unit 25, the password disclosure control unit 25a receives an identification token, a password ID, and a password owner ID (e-mail address) from the password acquisition client terminal 3B via the web server 21c. A user requesting password disclosure (also referred to as a password disclosure requesting user) transmits the identification token, the password ID, and the password owner ID from the password acquisition client terminal 3B to the password disclosure processing unit 25. The password disclosure control unit 25a confirms that the password disclosure requesting user is a user formally registered in the user registration processing unit 21, by the identification token. The password disclosure control unit 25a then acquires the e-mail address of the password disclosure requesting user.

The password disclosure control unit 25a uses the password ID to identify the password, the password disclosure permission information, the password disclosure period, and the password owner ID in the password database 24b. When information corresponding to the password ID is not registered in the password database 24b, the password disclosure control unit 25a terminates the processing and does not return the password to the password acquisition client terminal 3B. For example, a case where the password owner deletes the password corresponds to this.

The password disclosure control unit 25a compares the identified password owner ID and the password owner ID received from the password acquisition client terminal 3B. When these password owner IDs are different from each other, the password disclosure processing unit 25 does not transmit the password to the password acquisition client terminal 3B. In this way, it is possible to confirm that the user described in the encrypted data as the data creator (password owner) is certainly the creator of the encrypted data (password owner). If the password owner ID of the encrypted data is forgery, the password disclosure processing unit 25 does not return the password for data decryption to the password acquisition client terminal 3B, and hence encrypted data cannot be decrypted. An example of not performing this confirmation is also conceivable. In this case, the password acquisition client terminal 3B does not transmit the password owner ID to the password disclosure processing unit 25, and the password disclosure processing unit 25 skips the confirmation of the password owner ID.

The password disclosure control unit 25a checks the password disclosure permission information stored in the password database 24b and identified by the password ID. When the password disclosure permission information includes a list of e-mail addresses, the password disclosure control unit 25a checks whether the e-mail address of the password disclosure requesting user is included in the list of e-mail addresses. If the result of the confirmation indicates no, the password disclosure control unit 25a checks whether or not the password disclosure permission information includes designation of a relationship between users. If the result of this confirmation indicates no, the password disclosure control unit 25a checks whether the password disclosure permission information includes designation of a group. If the result of this confirmation is also no, the password disclosure control unit 25a does not transmit the password identified by the password ID, to the user requesting the password disclosure.

When the password disclosure permission information identified by the password ID in the password database 24b includes designation of a relationship between users, the password disclosure control unit 25a inquires the user relationship holding processing unit 23 of the relationship between users. Assume that the designation of the relationship between users is R. In the user relationship holding processing unit 23 in this example, the password owner is expressed by an e-mail address. Assume that the e-mail address of the password owner is mo. Also assume that the e-mail address of the password disclosure requesting user is u. The password disclosure processing unit 25 transmits a question [mo, R, u] to the user relationship holding processing unit 23. This corresponds to a question “whether u has a relationship of R with mo?” The user relationship holding processing unit 23 finds an answer to the question in the above-described manner and returns the answer to the password disclosure processing unit 25. When the answer obtained from the user relationship holding processing unit 23 is [no], the password disclosure processing unit 25 does not transmit the password identified by the password ID to the user requesting the password disclosure. This process of verifying whether the user is authorized and then deriving a decryption key using the password information may be understood as a “second processing” step. The component executing this derivation-typically located within the second client erminal-functions as a “cipher key second processing unit,” in the terminology of the claims.

When the relationship R between users is designation of a user group, the password disclosure processing unit 25 inquires of the user relationship holding processing unit 23 whether or not the password disclosure requesting user belongs to the group to which the disclosure is permitted (allowed). Here, assume that the designation of a user group is R={G1, . . . , GN}. Note that G1 to GN denote group names. Assume that the e-mail address of the password owner is mo. Also assume that the e-mail address of the password disclosure requesting user is u. The password disclosure processing unit 25 transmits a question [mo, R, u] to the user relationship holding processing unit 23. This corresponds to a question “whether u and mo belong to the same one of groups of R?” The user relationship holding processing unit 23 finds an answer to the question in the above-described manner and returns the answer to the password disclosure processing unit 25. When the answer obtained from the user relationship holding processing unit 23 is [no], the password disclosure processing unit 25 does not transmit the password identified by the password ID to the user requesting the password disclosure.

A further description will be given. The e-mail address m that the web server 21c in the password disclosure processing unit 25 receives from the password acquisition client terminal 3B is the password owner ID. The password acquisition client terminal 3B reads the password owner ID accompanying the encrypted data, for example, and transmits the password owner ID to the password disclosure processing unit 25.

The password disclosure control unit 25a checks whether or not the password owner ID (e-mail address m) transmitted from the password acquisition client terminal 3B matches the ID (e-mail address mo) of the owner of the password. When the password owner ID does not match the ID of the owner of the password, the password disclosure control unit 25a transmits error information without transmitting the password to the password acquisition client terminal 3B via the web server 21c.

The password disclosure control unit 25a compares a password disclosure start time Ts and a password disclosure end time Te set for the password, with a current time t, to judge whether or not the password disclosure is possible. As the current time, a system time of the first password sharing server 2A is acquired and used.

With reference to FIG. 12A, FIG. 12B, and FIG. 12C together, in the password disclosure processing unit 25, the following detailed processing steps are executed as an example.

[S1 (refer to FIG. 12B)] The web server 21c receives an identification token, a password ID, and a password owner ID (e-mail address m) from the password acquisition client terminal 3B.
[S2] The web server 21c transmits the identification token, the password ID, and the password owner ID to the password disclosure control unit 25a.
[S3] The password disclosure control unit 25a transmits the identification token to the e-mail address management unit 21a.
[S4] The e-mail address management unit 21a verifies the identification token.
[S5] Whether the identification token is the identification token of a user formally registered to the user database 21b is judged. When it is [no], the procedure is terminated. When it is [yes] (positive judgment), the processing advances to processing step S6.
[S6] The e-mail address management unit 21a acquires the e-mail address u of a password disclosure requesting user from the user database 21b.
[S7] The e-mail address management unit 21a transmits the e-mail address u to the password disclosure control unit 25a.
[S8] The password disclosure control unit 25a searches the password database 24b to check whether information corresponding to the password ID is registered to the password database 24b.
[S9] When information corresponding to the password ID is not registered ([no]), the processing advances to the processing step S25. When information corresponding to the password ID is registered ([yes]), the processing advances to processing step S10.
[S10] The password disclosure control unit 25a acquires a password, password disclosure permission information, a password disclosure period, and a password owner ID (e-mail address mo) corresponding to the password ID, from the password database 24b.
[S11] The password disclosure control unit 25a compares the e-mail address mo and the e-mail address m.
[S12] When the result of the judgment is [no], the processing advances to processing step S25. When the result of the judgment is [yes], the processing advances to processing step S13.
[S13] The password disclosure control unit 25a checks whether the password disclosure permission information acquired in processing step S10 includes a list of e-mail addresses.
[S14] When the result of the judgment is [no], the processing advances to processing step S17. When the result of the judgment is [yes], the processing advances to processing step S15.
[S15] The password disclosure control unit 25a checks whether the list of e-mail addresses includes the e-mail address u.
[S16] When the result of the judgment is [no], the processing advances to processing step S17. When the result of the judgment is [yes], the processing advances to processing step S21.
[S17 (refer to FIG. 12C)] The password disclosure control unit 25a checks whether the password disclosure permission information acquired in processing step S10 includes designation R of a relationship between users.
[S18] When the result of the judgment is [no], the processing advances to processing step S25. When the result of the judgment is [yes], the processing advances to processing step S19.
[S19] The password disclosure control unit 25a transmits a question [mo, R, u] to the user relationship holding processing unit 23.
[S20] When an answer is [no], the processing advances to processing step S25. When the answer is [yes], the processing advances to processing step S21.
[S21] The password disclosure control unit 25a acquires the current time t and compares the current time t with the password disclosure start time Ts and the password disclosure end time Te.
[S22] When the result of the judgment is [no], the processing is terminated. When the result of the judgment is [yes] (t is equal to or later than Ts and equal to or earlier than Te), the processing advances to processing step S23.
[S23] The password disclosure control unit 25a transmits a password corresponding to the password ID to the web server 21c.
[S24] The web server 21c transmits the password to the password acquisition client terminal 3B.
[S25] The password disclosure control unit 25a indicates, to the web server 21c, that the web server 21c transmits an error to the password acquisition client terminal 3B.
[S26] The web server 21c transmits an error to the password acquisition client terminal 3B.

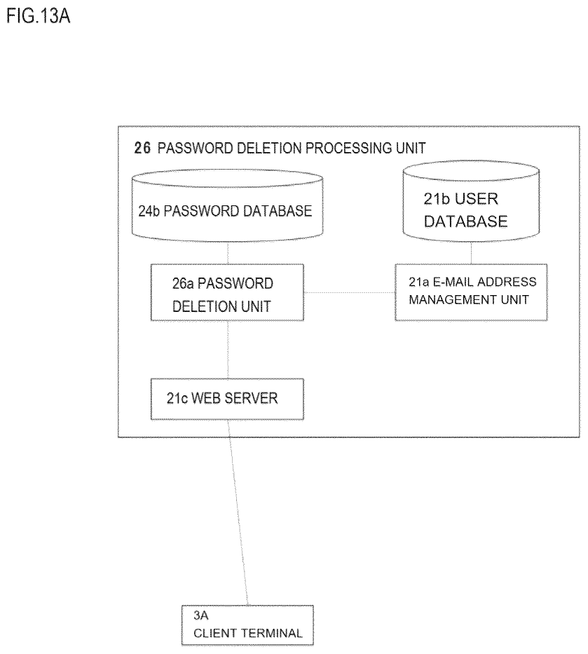

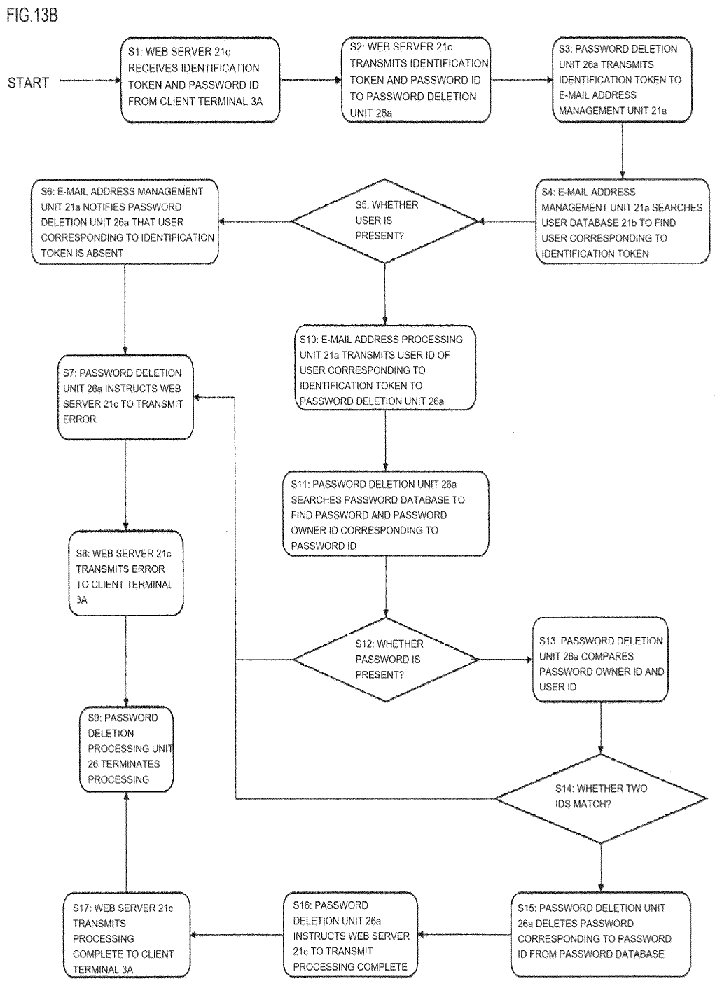

With reference to FIG. 13A, the password deletion processing unit 26 in the first password sharing server 2A is configurable to include the e-mail address management unit 21a, the user database 21b, the web server 21c, a password deletion unit 26a, and the password database 24b, as detailed components. The e-mail address management unit 21a, the user database 21b, the web server 21c, and the password database 24b of the components are shared with other processing units.

Main points of processing in this password deletion processing unit 26 are as follows. (Refer to FIG. 13B.)

[S1] The web server 21c receives an identification token and a password ID (password identification information) from the client terminal 3A.
[S2] The web server 21c transmits the identification token and the password ID to the password deletion unit 26a.
[S3] The password deletion unit 26a transmits the identification token to the e-mail address management unit 21a.
[S4] The e-mail address management unit 21a searches the user database 21b and finds the user corresponding to the identification token.
[S5] Whether the user is present? If yes, the processing advances to [S10]. If no, the processing returns to [S6].
[S6] The e-mail address management unit 21a notifies the password deletion unit 26a that the user corresponding to the identification token is absent.
[S7] The password deletion unit 26a indicates transmission of an error to the web server 21c.
[S8] The web server 21c transmits an error to the client terminal 3A.
[S9] The password deletion processing unit 26 terminates the processing.
[S10] The e-mail address management unit 21a transmits the user ID of the user corresponding to the identification token, to the password deletion unit 26a.
[S11] The password deletion unit 26a searches the password database 24b and finds the password and the password owner ID corresponding to the password ID.
[S12] Whether the password is present? If yes, the processing advances to [S13]. If no, the processing returns to [S7].
[S13] The password deletion unit 26a compares the password owner ID acquired in [S11] and the user ID acquired in [S10].
[S14] Whether the password owner ID and the user ID match? If yes, the processing advances to [S15]. If no, the processing returns to [S7].
[S15] The password deletion unit 26a deletes the password corresponding to the password ID from the password database 24b.
[S16] The password deletion unit 26a indicates transmission of processing complete to the web server 21c.
[S17] The web server 21c transmits processing complete to the client terminal 3A, and the processing returns to [S9]. In the above steps, only when the ID of the user making deletion indication and the password owner ID match, the password is deleted. Hence, a user who is not the owner of the password cannot delete the password. Note that information that the password deletion unit 26a deletes from the password database 24b is the entire information corresponding to the password ID. Specifically, the password deletion unit 26a deletes everything including the password, the password disclosure permission information, the password disclosure period, the password owner ID, and the like. As a result of the deletion, the password and the like corresponding to the password ID are no longer present in the password database 24b.

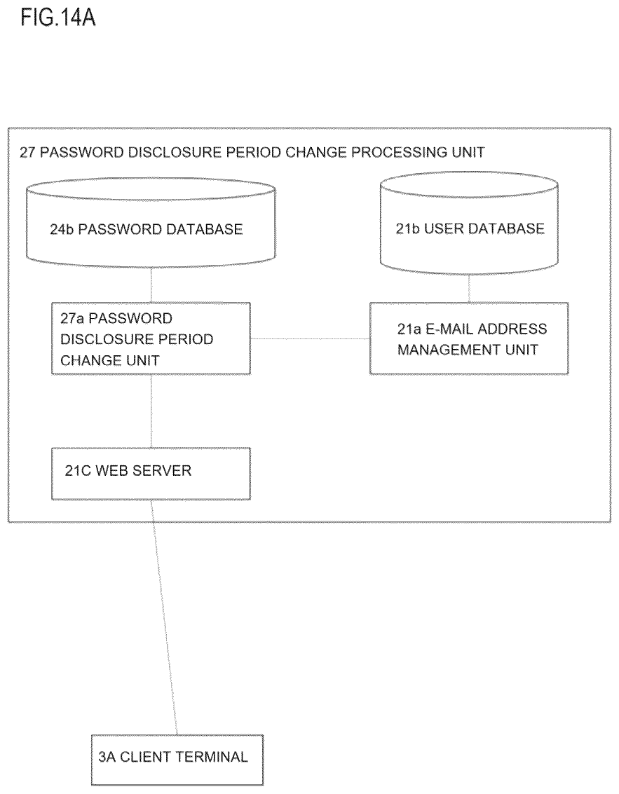

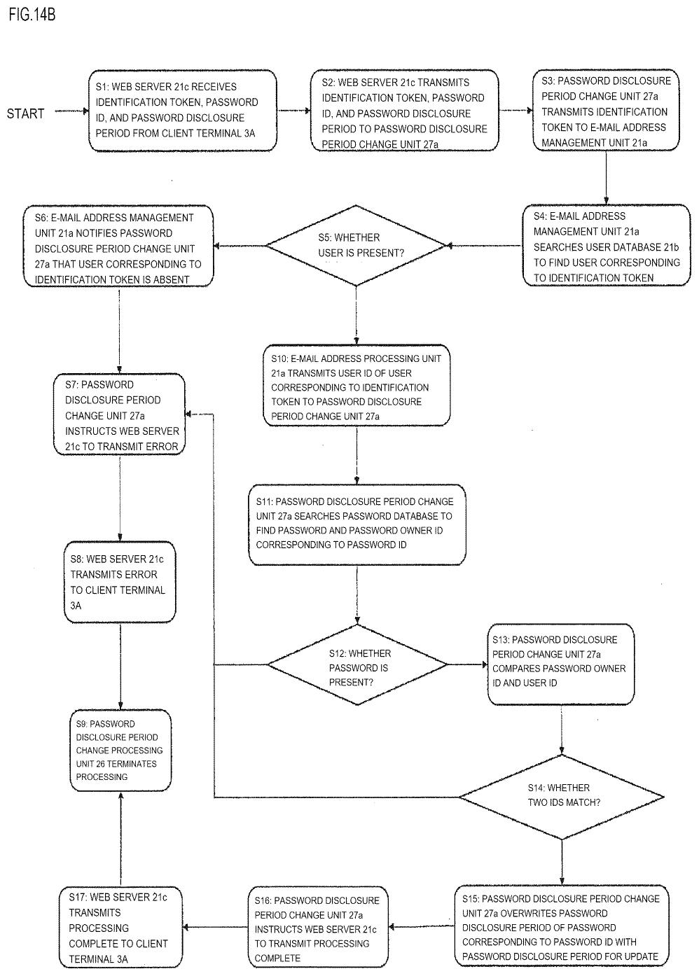

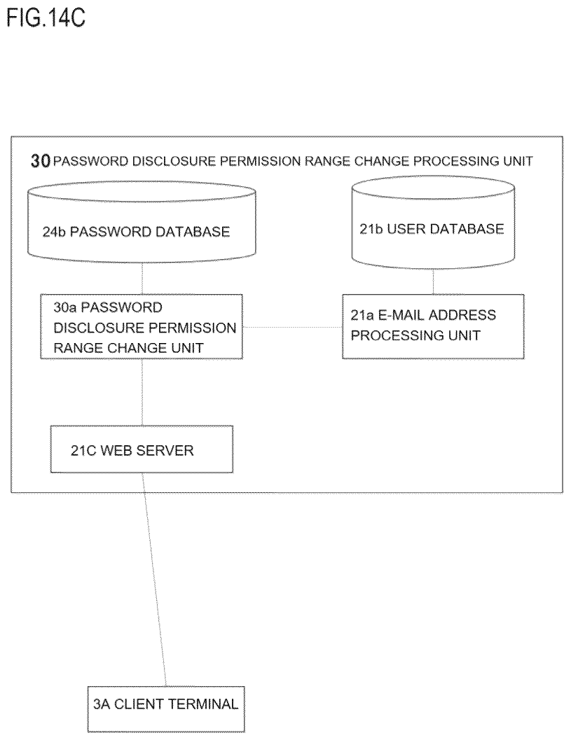

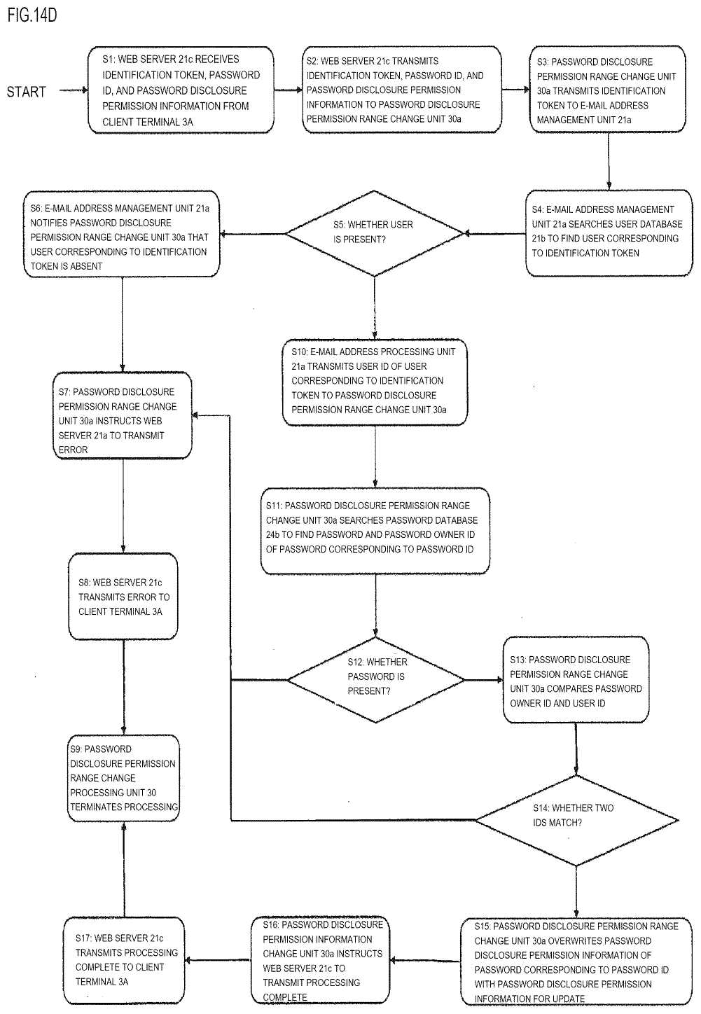

With reference to FIG. 14A, the password disclosure period change processing unit 27 in the first password sharing server 2A is configurable to include the e-mail address management unit 21a, the user database 21b, the web server 21c, a password disclosure period change unit 27a, and the password database 24b, as detailed components. The e-mail address management unit 21a, the user database 21b, the web server 21c, and the password database 24b of the components are shared with other processing units.

Main points of processing in this password disclosure period change processing unit 27 are as follows. (Refer to FIG. 14B.)

[S1] The web server 21c receives an identification token, a password ID (password identification information), and a password disclosure period from the client terminal 3A. This password disclosure period is for update.
[S2] The web server 21c transmits the identification token, the password ID, and the password disclosure period to the password disclosure period change unit 27a.
[S3] The password disclosure period change unit 27a transmits the identification token to the e-mail address management unit 21a.
[S4] The e-mail address management unit 21a searches the user database 21b and finds the user corresponding to the identification token.
[S5] Whether the user is present? If yes, the processing advances to [S10]. If no, the processing returns to [S6].
[S6] The e-mail address management unit 21a notifies the password disclosure period change unit 27a that the user corresponding to the identification token is absent.
[S7] The password disclosure period change unit 27a indicates transmission of an error to the web server 21c.
[S8] The web server 21c transmits an error to the client terminal 3A.
[S9] The password disclosure period change processing unit 27 terminates the processing.
[S10] The e-mail address management unit 21a transmits the user ID of the user corresponding to the identification token, to the password disclosure period change unit 27a.
[S11] The password disclosure period change unit 27a searches the password database 24b and finds the password and the password owner ID corresponding to the password ID.
[S12] Whether the password is present? If yes, the processing advances to [S13]. If no, the processing returns to [S7].
[S13] The password disclosure period change unit 27a compares the password owner ID acquired in [S11] and the user ID acquired in [S10].
[S14] Whether the password owner ID and the user ID match? If yes, the processing advances to [S15]. If no, the processing returns to [S7].
[S15] The password disclosure period change unit 27a updates the password disclosure period of the password corresponding to the password ID with the password disclosure period for update in the password database 24b.
[S16] The password disclosure period change unit 27a indicates transmission of processing complete to the web server 21c.
[S17] The web server 21c transmits processing complete to the client terminal 3A, and the processing returns to [9].

In the above steps, only when the ID of the user making indication of update of the password disclosure period and the password owner ID match, the disclosure period of the password is updated. Hence, a user who is not the owner of the password cannot change the disclosure period of the password.

### (Change of Password Disclosure Permissible Range)

With reference to FIG. 14C, the password disclosure permissible range change processing unit 30 in the first password sharing server 2A is configurable to include the e-mail address management unit 21a, the user database 21b, the web server 21c, a password disclosure permissible range change unit 30a, and the password database 24b, as detailed components. The e-mail address management unit 21a, the user database 21b, the web server 21c, and the password database 24b of the components are shared with other processing units.

Main points of processing in this password disclosure permissible range change processing unit 30 are as follows.

### (Refer to FIG. 14D.)

[S1] The web server 21c receives an identification token, a password ID (password identification information), and a password disclosure permission information from the client terminal 3A. This password disclosure permission information is for update. Specifically, the password disclosure permission information is a list of e-mail addresses. Alternatively, the password disclosure permission information is designation of the relationship between users, such as “family”. This password disclosure permission information for update may be a list of groups of users held by the user relationship holding processing unit 23.
[S2] The web server 21c transmits the identification token, the password ID, and the password disclosure permission information to the password disclosure permissible range change unit 30a.
[S3] The password disclosure permissible range change unit 30a transmits the identification token to the e-mail address management unit 21a.
[S4] The e-mail address management unit 21a searches the user database 21b and finds the user corresponding to the identification token.
[S5] Whether the user is present? If yes, the processing advances to [S10]. If no, the processing returns to [S6].
[S6] The e-mail address management unit 21a notifies the password disclosure permissible range change unit 30a that the user corresponding to the identification token is absent.
[S7] The password disclosure permissible range change unit 30a indicates transmission of an error to the web server 21c.
[S8] The web server 21c transmits an error to the client terminal 3A.
[S9] The password disclosure permissible range change processing unit 30 terminates the processing.
[S10] The e-mail address management unit 21a transmits the user ID of the user corresponding to the identification token, to the password disclosure permissible range change unit 30a.
[S11] The password disclosure permissible range change unit 30a searches the password database 24b and finds the password corresponding to the password ID and the password owner ID of the password.
[S12] Whether the password is present? If yes, the processing advances to [S13]. If no, the processing returns to [S7].
[S13] The password disclosure permissible range change unit 30a compares the password owner ID acquired in [S11] and the user ID acquired in [S10].
[S14] Whether the password owner ID and the user ID match? If yes, the processing advances to [S15]. If no, the processing returns to [S7].
[S15] The password disclosure permissible range change unit 30a updates the password disclosure permission information of the password corresponding to the password ID with the password disclosure permission information for update in the password database 24b.
[S16] The password disclosure permissible range change unit 30a indicates transmission of processing complete to the web server 21c.
[S17] The web server 21c transmits processing complete to the client terminal 3A, and the processing returns to [S9].

In the above steps, only when the user ID of the user making indication of change of the password disclosure permissible range and the password owner ID match, the password disclosure permission information of the password is updated. Hence, a user who is not the owner of the password cannot change the disclosure permissible range of the password.

### {Details of Second Password Sharing Server}

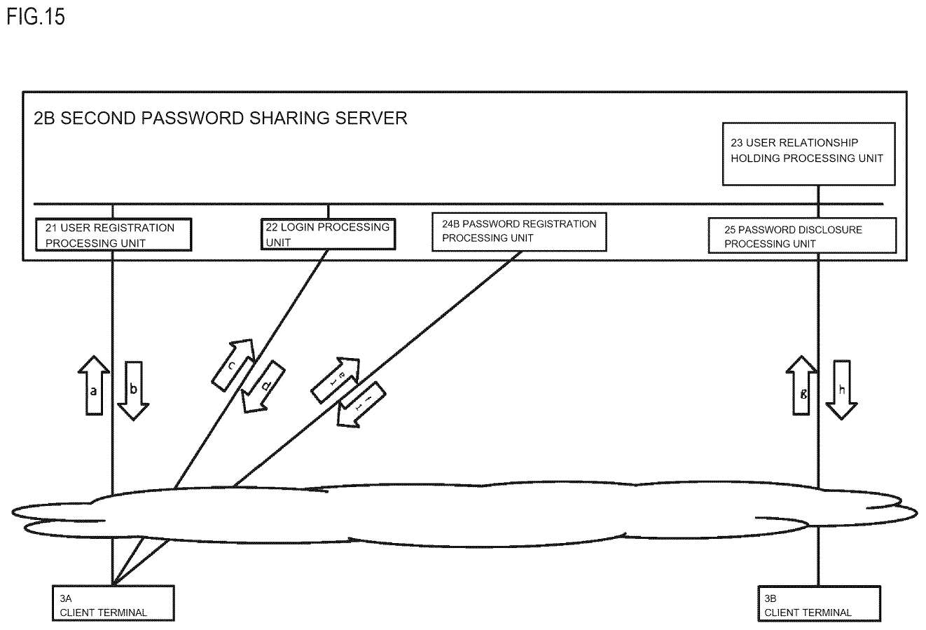

Details of the second password sharing server 2B in the password sharing system 1 will be described with reference to FIGS. 1A to 1D, FIG. 15, and related drawings together.

With reference to FIG. 15, the second password sharing server 2B includes the user registration processing unit 21, the login processing unit 22, the user relationship holding processing unit 23, a password registration processing unit 24B, and the password disclosure processing unit 25 as functional components. The user registration processing unit 21, the login processing unit 22, the user relationship holding processing unit 23, and the password disclosure processing unit 25 have similar functions to those of the first password sharing server 2A.

Here, the basic feature elements of the second password sharing server 2B are the user registration processing unit (corresponding to the identification token issue unit 104 in FIG. 1A) 21, the password registration processing unit (corresponding to the password registration unit 107 in FIG. 1A) 24B, and the password disclosure processing unit (corresponding to the password disclosure unit 110 in FIG. 1A) 25.

In other words, the second password sharing server 2B is a password sharing server applicable to the password sharing system 1 including the password registration client terminal (first client terminal) 3A used by a first user and the password acquisition client terminal (second client terminal) 3B used by a second user and includes the user registration processing unit 21 configured to issue an identification token (proof) indicating that a corresponding user is an authenticated user.

The second password sharing server 2B includes the password registration processing unit 24B configured to receive an identification token issued by the user registration processing unit 21 and corresponding to the first user and password disclosure permission information designating the password disclosure permissible range, from the first client terminal 3A, generate a password, store the password generated and the password disclosure permission information in a database, and transmit, only when the identification token is confirmed to be a correct identification token (identification token corresponding to the first user) through verification, password identification information (password ID) for identifying the stored password and password disclosure permission information in a database and the password, to the first client terminal 3A.

Further, the second password sharing server 2B includes the password disclosure processing unit 25 configured to receive, from the second client terminal 3B, an identification token issued by the user registration processing unit 21 and corresponding to the second user and the password ID acquired by reading the data output by the first client terminal 3A and transmitted from the password registration processing unit 24B, acquire information of the second user identified by the identification token corresponding to the second user, acquire, from the database, the password and the password disclosure permission information identified by the password ID received from the second client terminal 3B, and transmit, only when it is confirmed that the second user is included in the password disclosure permissible range designated by the password disclosure permission information acquired from the database, the password identified by the password ID to the second client terminal 3B.

Next, further details of the second password sharing server 2B in the password sharing system 1 will be described with reference to FIGS. 1A to 1D, FIG. 15, and related drawings together.

With reference to FIG. 15, the user registration processing unit 21, the login processing unit 22, a user relationship holding processing unit 23, the password registration processing unit 24B, and the password disclosure processing unit 25 configuring the second password sharing server 2B share part of detailed components as described above.

As illustrated in FIG. 15, the second password sharing server 2B transmits/receives the following various data a to d, e1, f1, g, and h to/from the password registration client terminal 3A and the password acquisition client terminal 3B. A “*” mark described below is optional data and is not used in some examples.

[Data a] at temporary registration: e-mail address, password; at formal registration: token for registration, e-mail address, password
[Data b] at temporary registration: token for registration, URL for registration; at formal registration: identification token [Data c] e-mail address, password
[Data d] identification token
[Data e1] identification token, password disclosure permission information, *password disclosure period
[Data f1] password ID, password, *password owner ID, *URL for password acquisition
[Data g] identification token, password ID, *password owner ID
[Data h] password

Here, a user to encrypt data (encryption target data) (corresponding to the data 139 in FIG. 1A) and register a password uses the password registration processing unit 24B, and a user to request disclosure of the password to decrypt the data (encrypted data) uses the password disclosure processing unit 25. These users may be the same user but are separate in general, and hence the password registration client terminal 3A and the password acquisition client terminal 3B are illustrated.

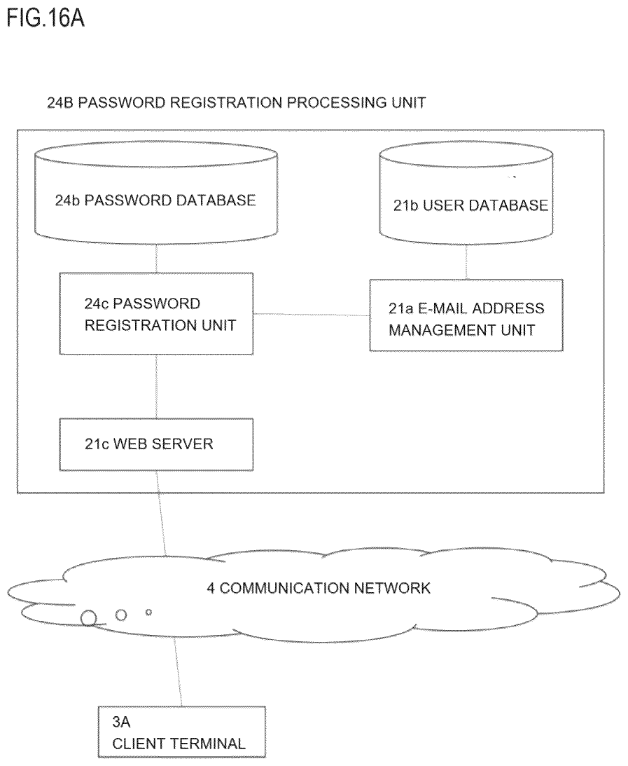

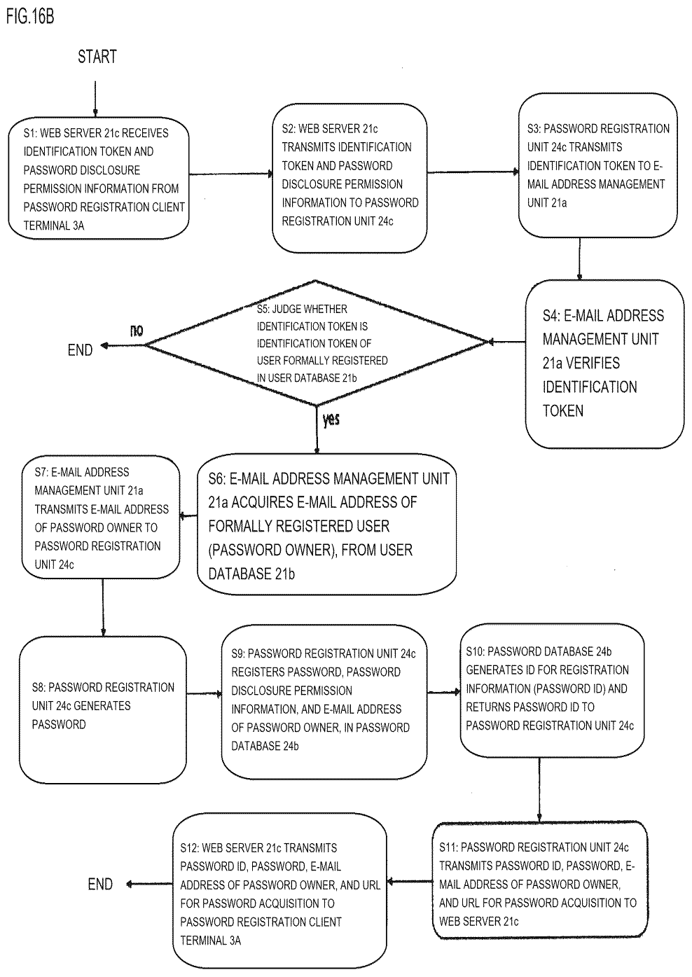

With reference to FIG. 16A, the password registration processing unit 24B in the second password sharing server 2B is configurable to include the e-mail address management unit 21a, the user database 21b, the web server 21c, the password registration unit 24c, and the password database 24b, as detailed components. The e-mail address management unit 21a, the user database 21b, and the web server 21c of the components are shared with other processing units.

As described above, the password registration processing unit 24 in the first password sharing server 2A registers a password transmitted from the password registration client terminal 3A used by a user, to the password database 24b (corresponding to the database 121 in FIG. 1A) and returns a password ID. However, the password registration processing unit 24B in the second password sharing server 2B itself generates a password, registers the password to the password database 24b, and returns the password and the password ID of the password in the password database 24b.

The password registration processing unit 24B generates a password on the basis of a pseudo-random number generated by a program, for example, but a password generation method is not limited to this.

The password registration unit 24c acquires an e-mail address of a user identified by an identification token. Since the user is a password registrant, the e-mail address is, in other words, the e-mail address of the password owner. In this example, the e-mail address is also used as a password owner ID. In this example, a URL for password acquisition is held by the password registration unit 24c in advance.

An example that the URL for password acquisition is not returned to the password registration client terminal 3A is also conceivable.

With reference to FIG. 16A and FIG. 16B together, in the password registration processing unit 24B, the following detailed processing steps are executed as an example.

[S1 (refer to FIG. 16B)] The web server 21c receives an identification token and password disclosure permission information from the password registration client terminal 3A.
[S2] The web server 21c transmits the identification token and the password disclosure permission information to the password registration unit 24c.
[S3] The password registration unit 24c transmits the identification token to the e-mail address management unit 21a.
[S4] The e-mail address management unit 21a verifies the identification token.
[S5] Whether the identification token is the identification token of a user formally registered to the user database 21b is judged. When it is [no], the procedure is terminated. When it is [yes], the processing advances to processing step S6.
[S6] The e-mail address management unit 21a acquires the e-mail address of the formally registered user (password owner) from the user database 21b.
[S7] The e-mail address management unit 21a transmits the e-mail address of the password owner to the password registration unit 24c.
[S8] The password registration unit 24c generates a password.
[S9] The password registration unit 24c registers the password, the password disclosure permission information, and the e-mail address of the password owner to the password database 24b.
[S10] The password database 24b generates an ID (password ID) for the registration information and returns the password ID to the password registration unit 24c.
[S11] The password registration unit 24c transmits the password ID, the password, the e-mail address of the password owner, and the URL for password acquisition to the web server 21c.
[S12] The web server 21c transmits the password ID, the password, the e-mail address of the password owner, and the URL for password acquisition to the password registration client terminal 3A.

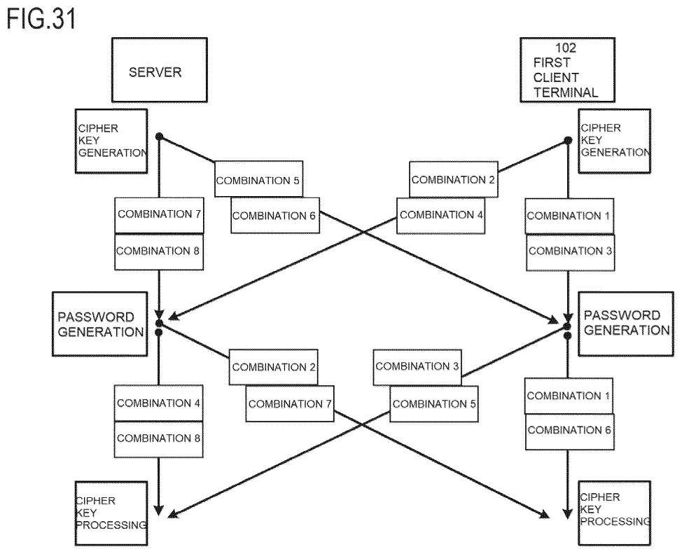

For the password sharing system 100 in the first aspect of the present invention, description will be given that several combinations are present, by using FIG. 31, regarding in which one of the first client terminal 102, the password sharing server 101, and a server other than the password sharing server 101 the password provision unit 105, the cipher key generation unit 108, and the cipher key first processing unit 109 are implemented, in the configuration of the password sharing system 100 in FIG. 1A.

Similar combinations are also present in the embodiment described above. These combinations will be described below.

In the assignment of roles in combination 2 in FIG. 31, in the first aspect of the present invention described above,
the cipher key generation unit 108 and the cipher key first processing unit 109 are included in the first client terminal 102,
the password provision unit 105 is included in a server (for example, the password sharing server 101 or another server), and
the server including the password provision unit 105 is configured to transmit the password information 133 provided by the password provision unit 105 to a server including the password registration unit 107 (for example, the password sharing server 101) and a server including the cipher key first processing unit 109, and transmit a cipher key for data decryption and a cipher key for data encryption generated by the cipher key generation unit 108, to the cipher key first processing unit 109.

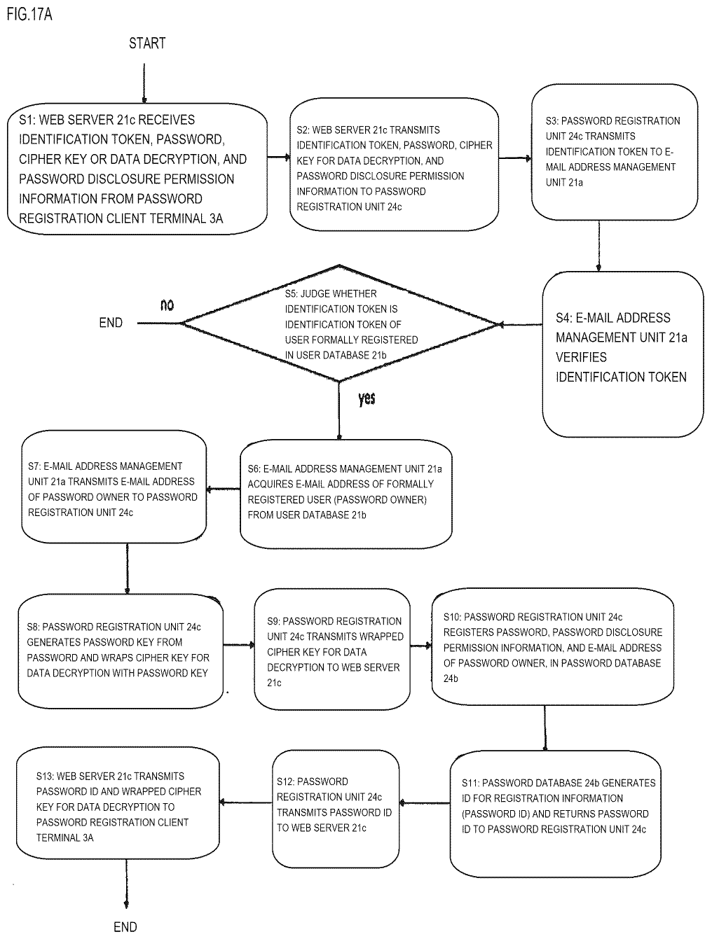

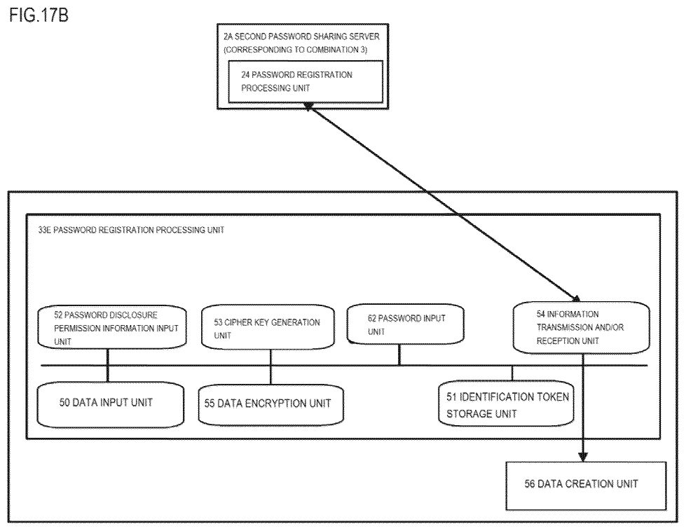

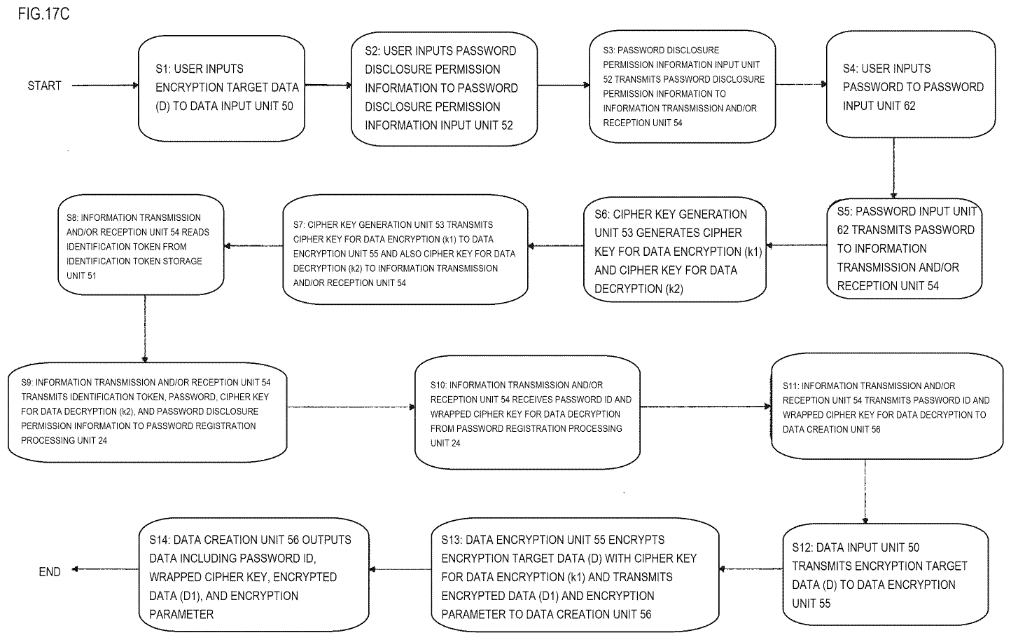

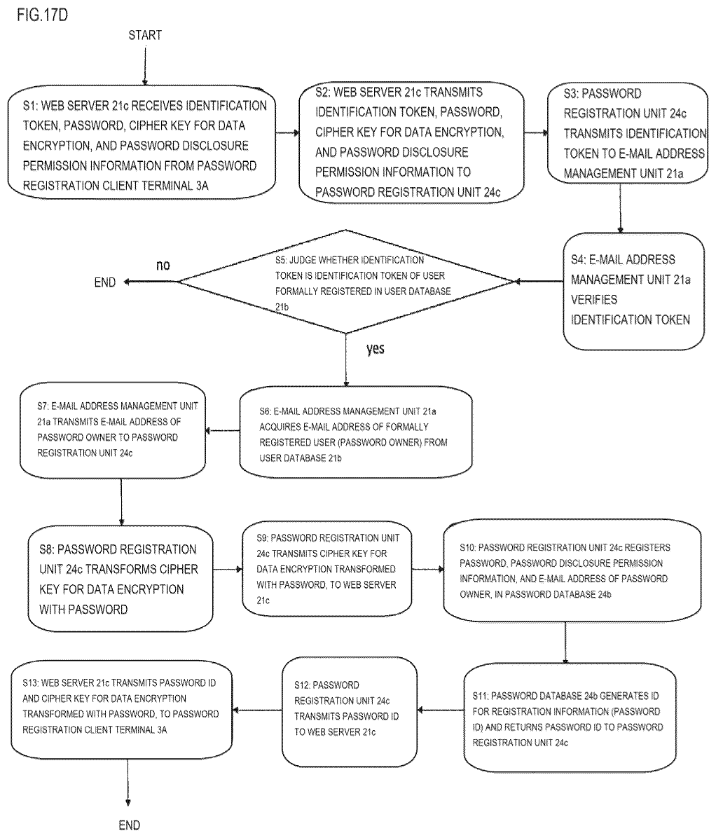

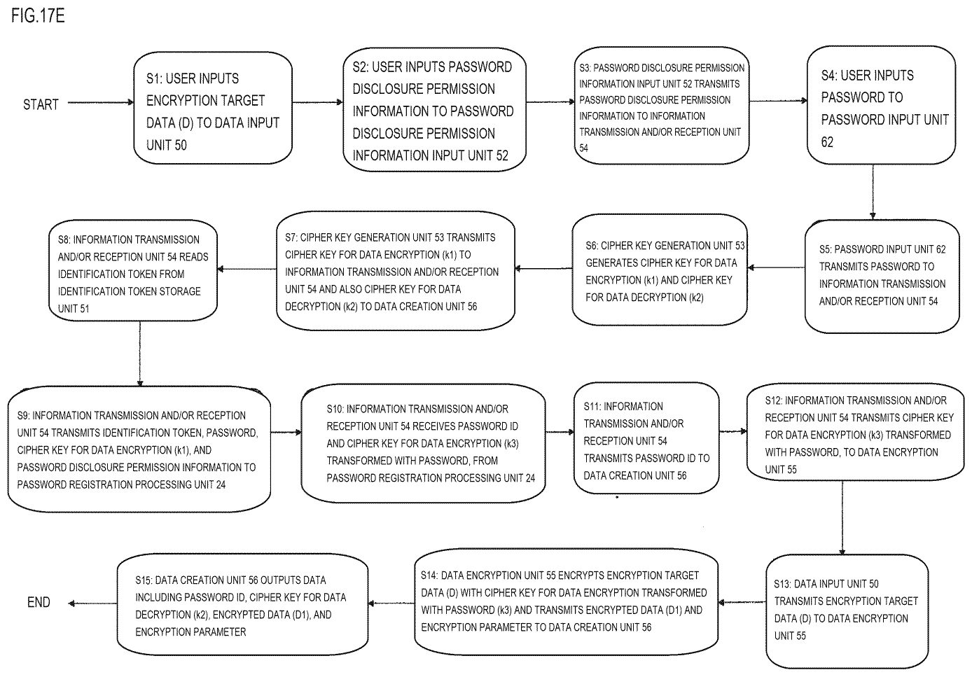

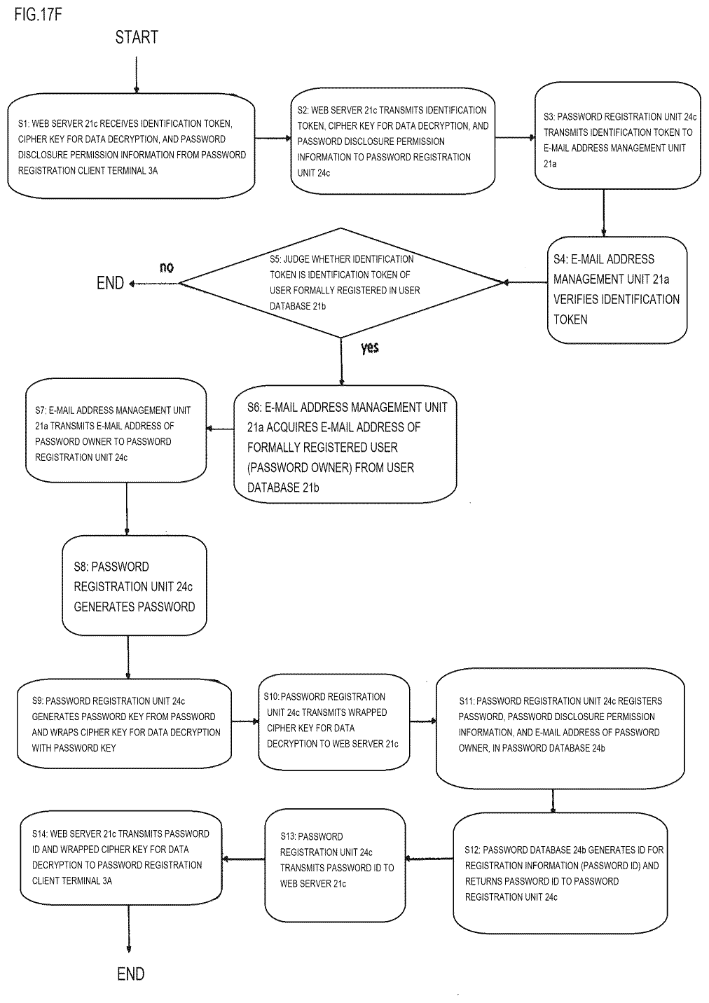

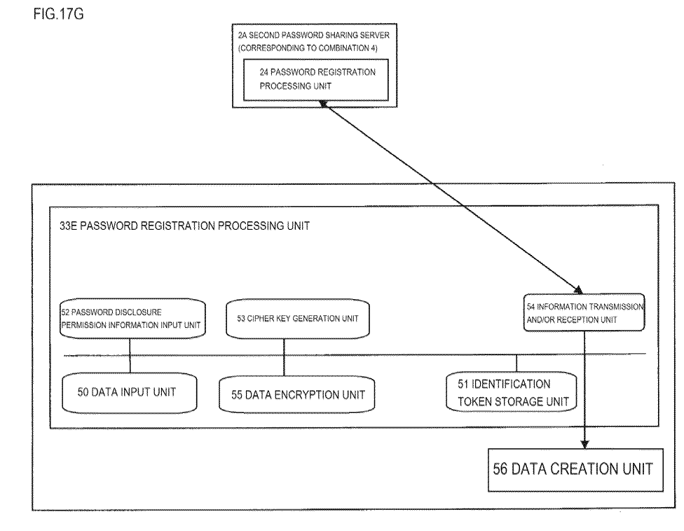

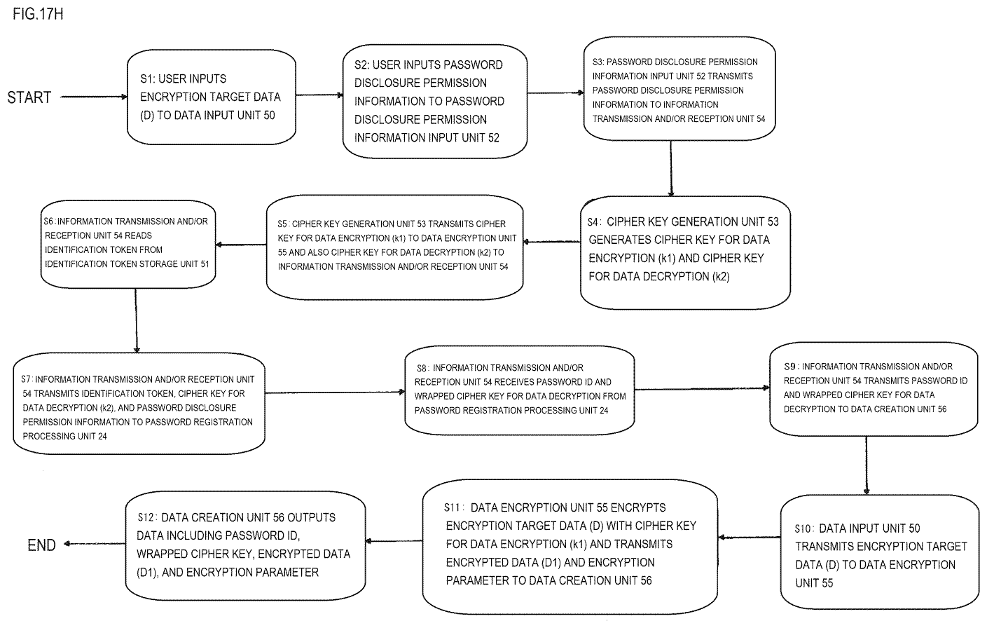

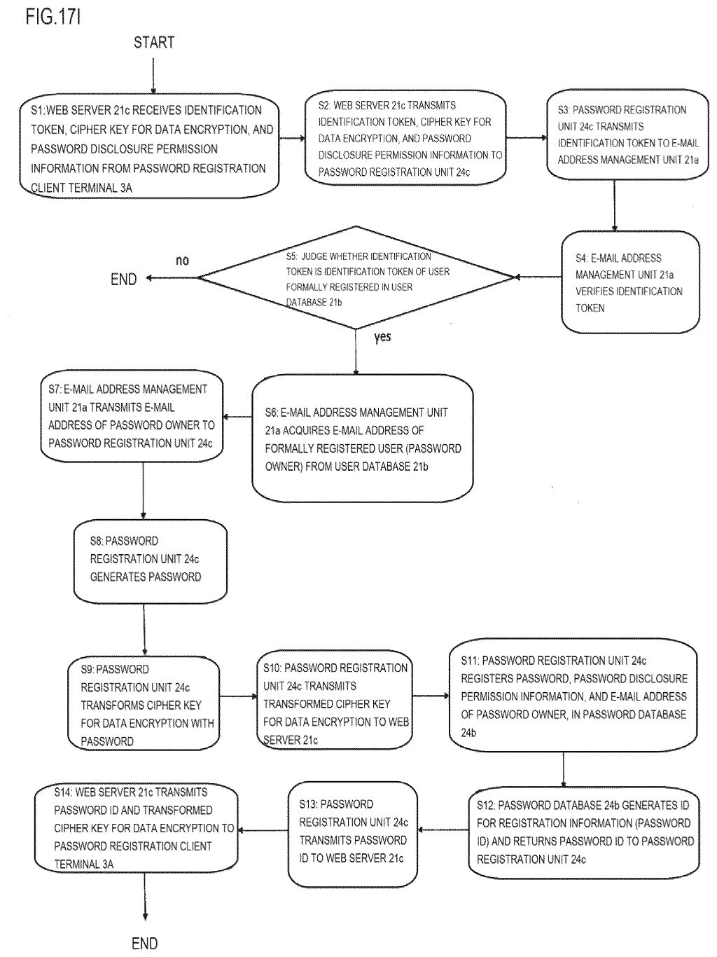

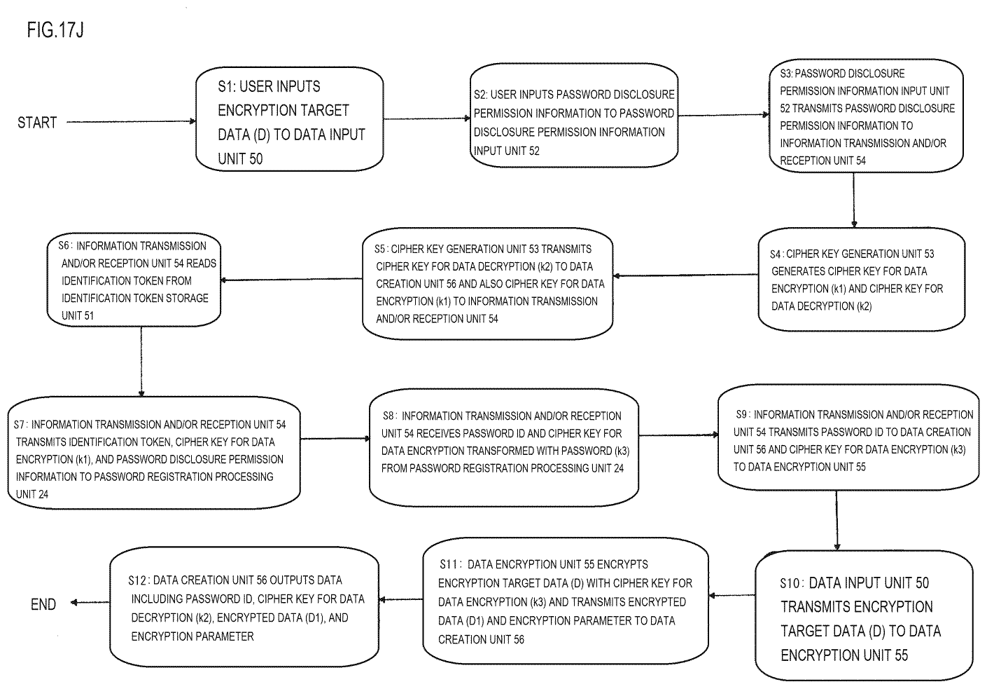

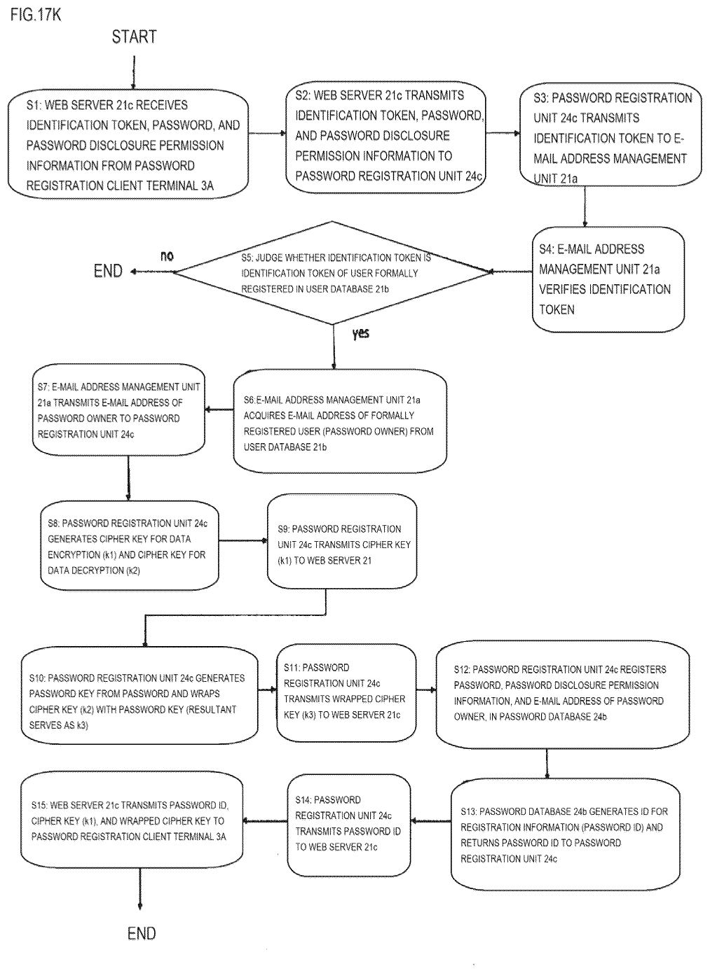

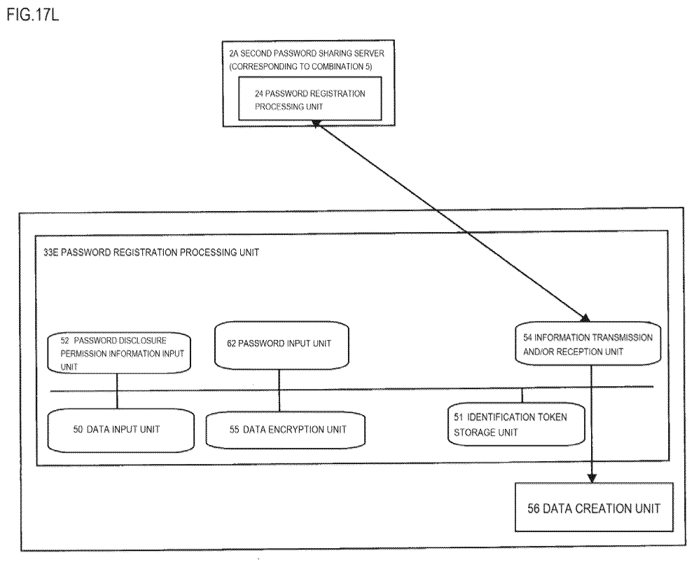

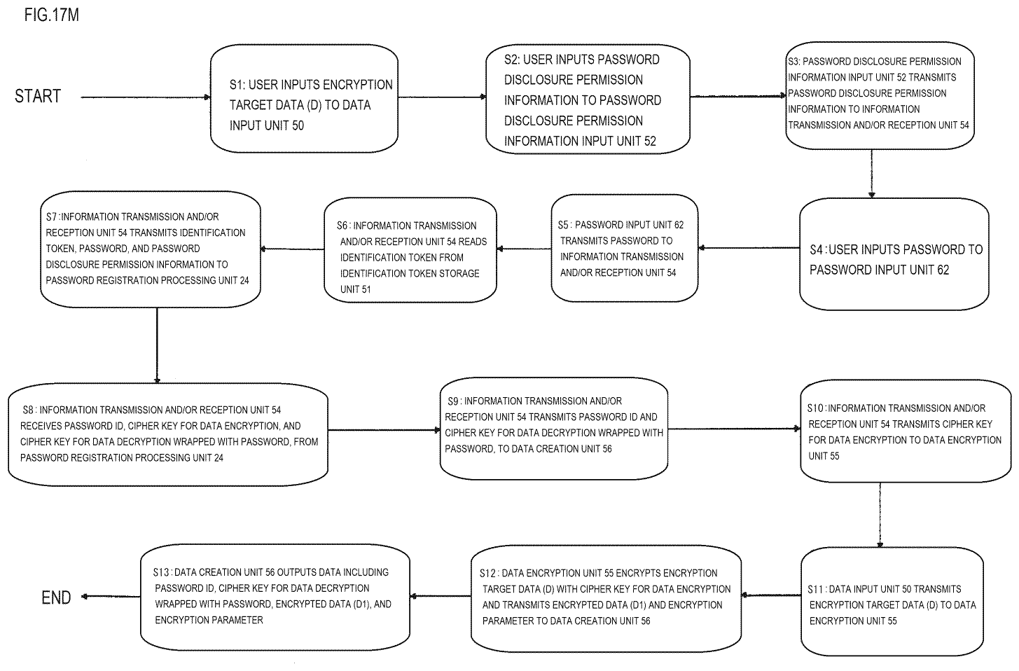

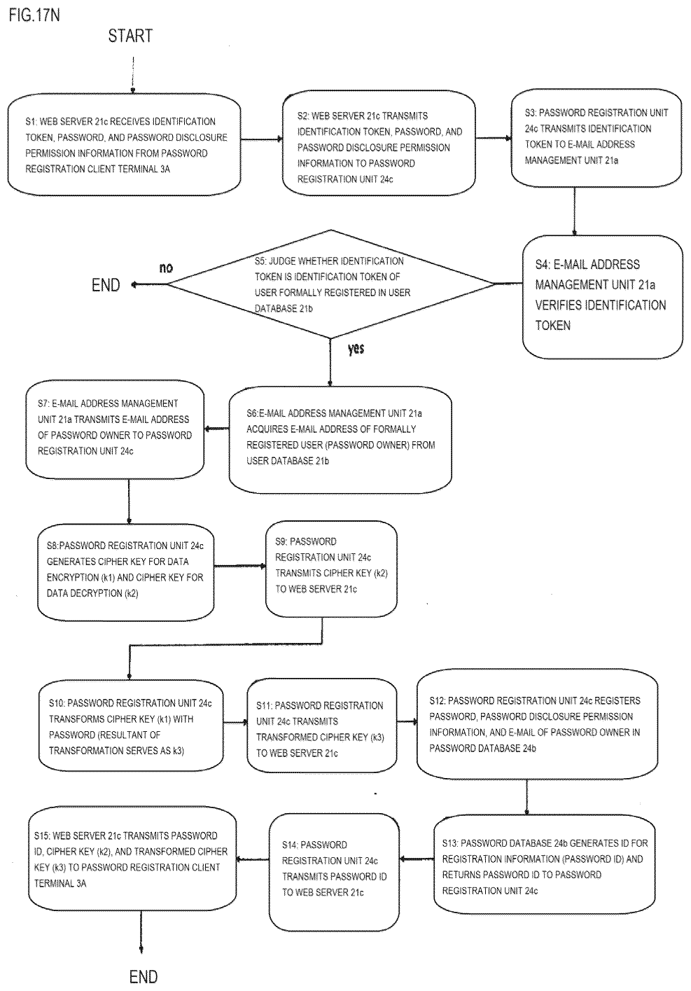

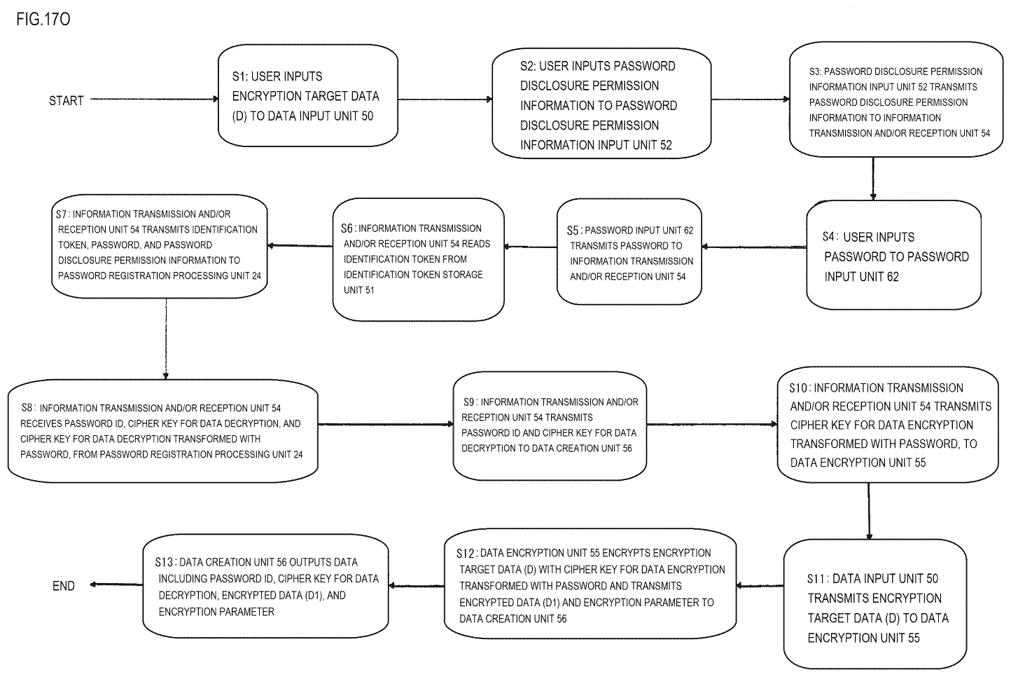

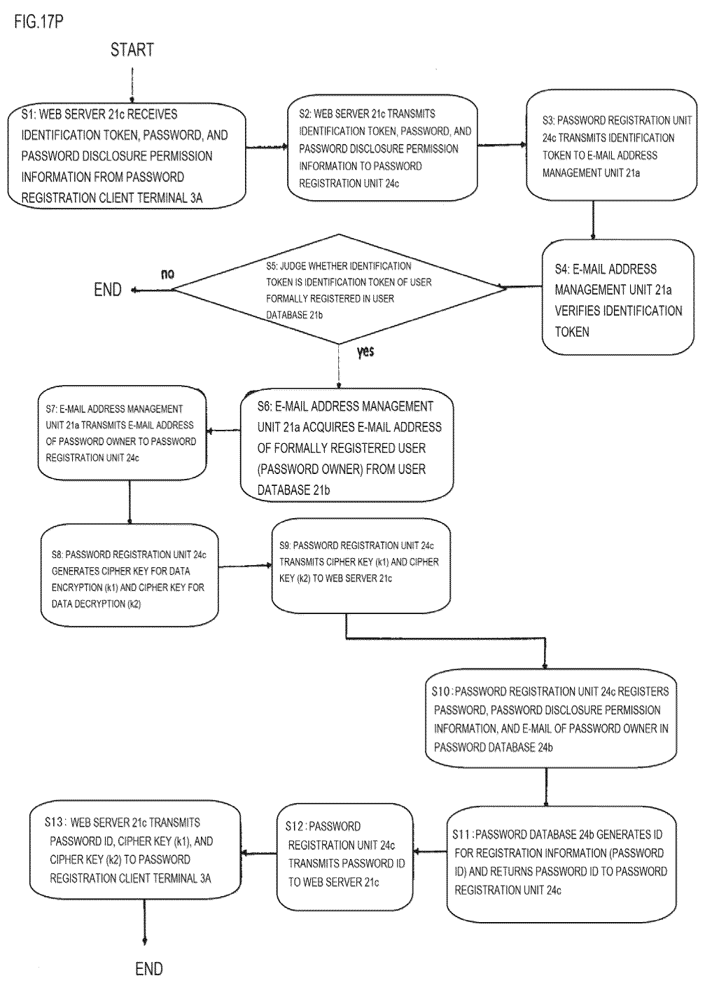

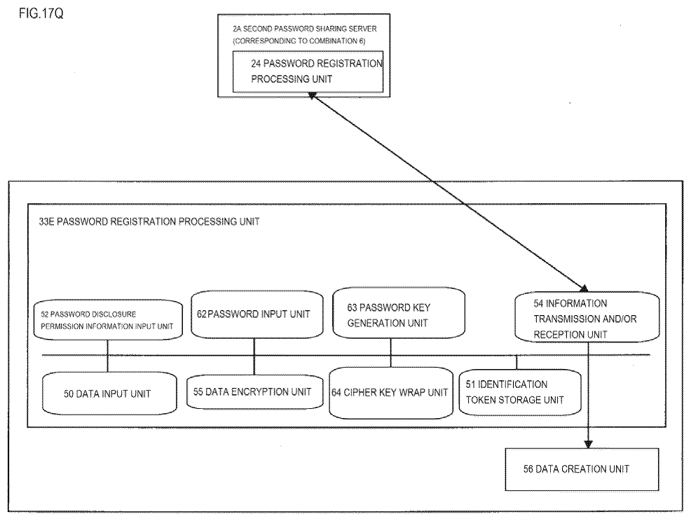

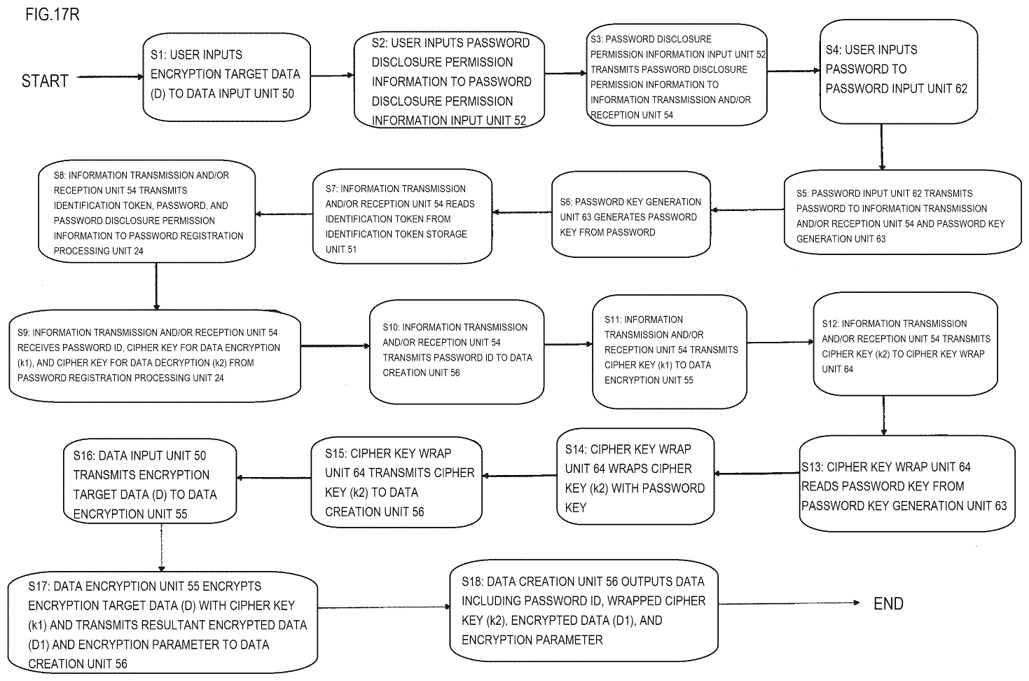

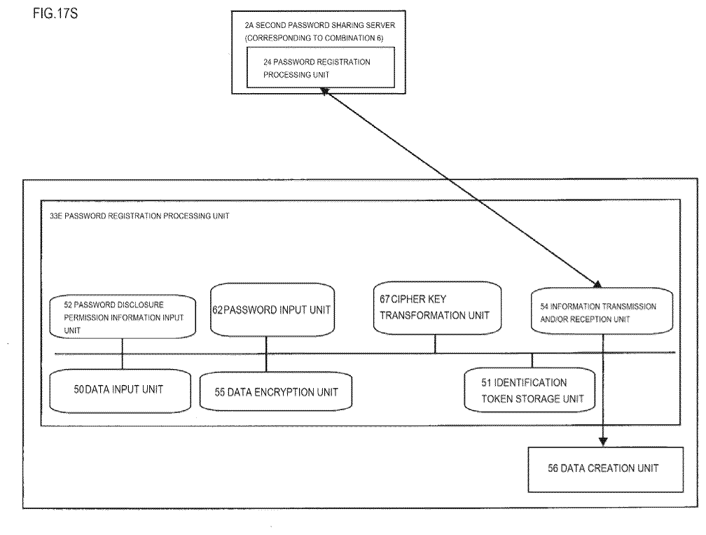

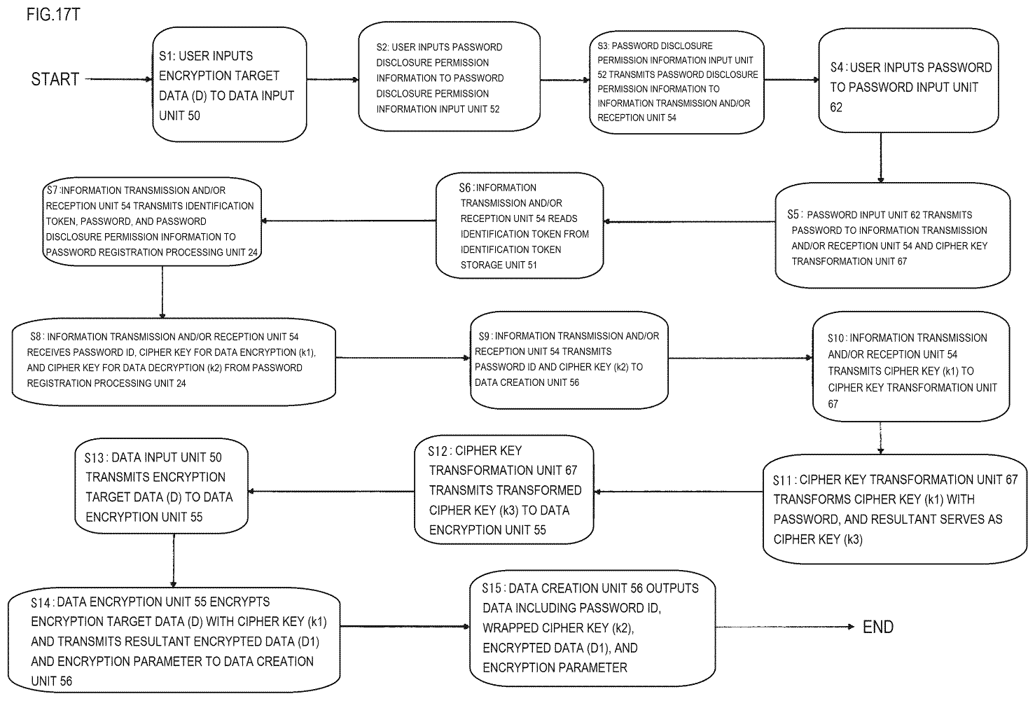

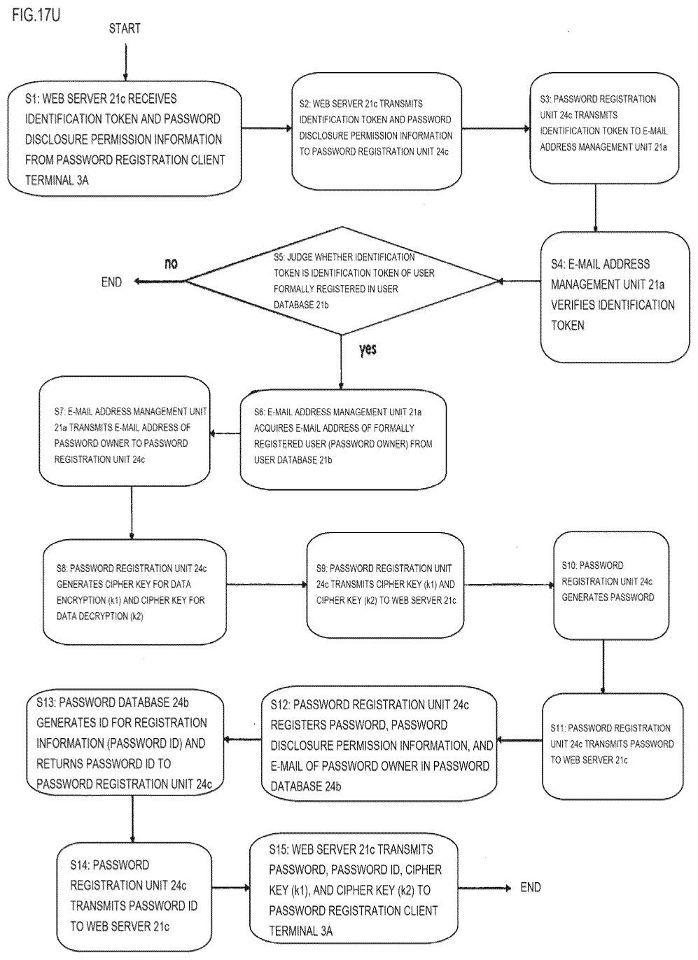

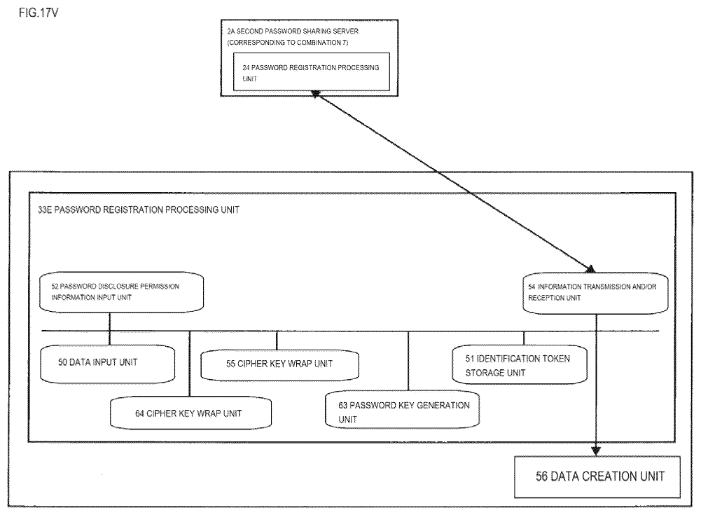

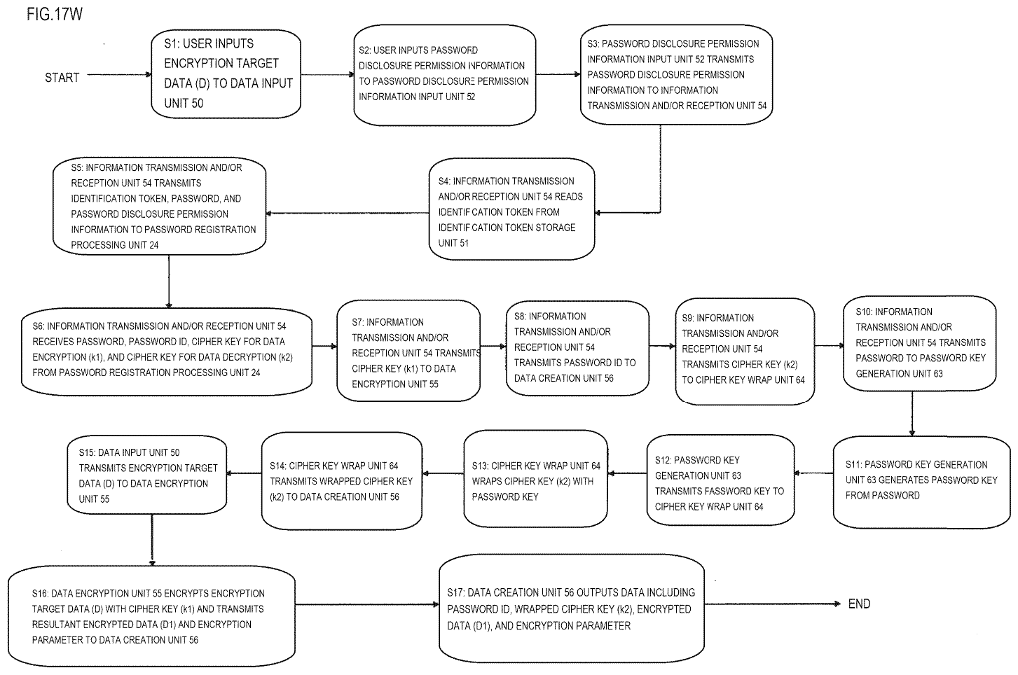

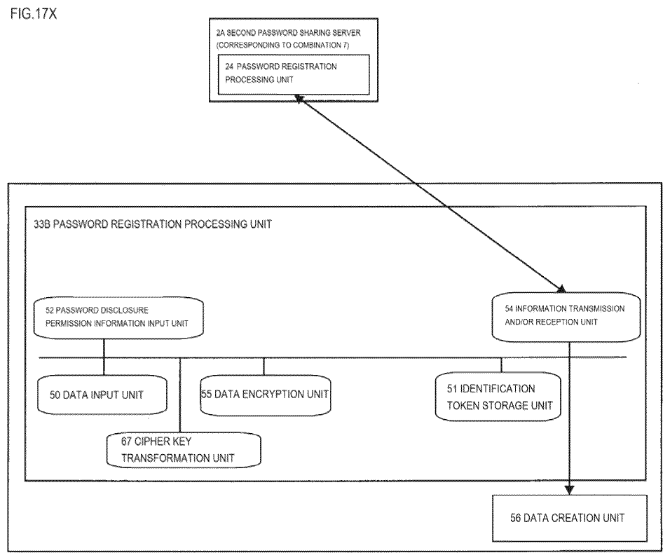

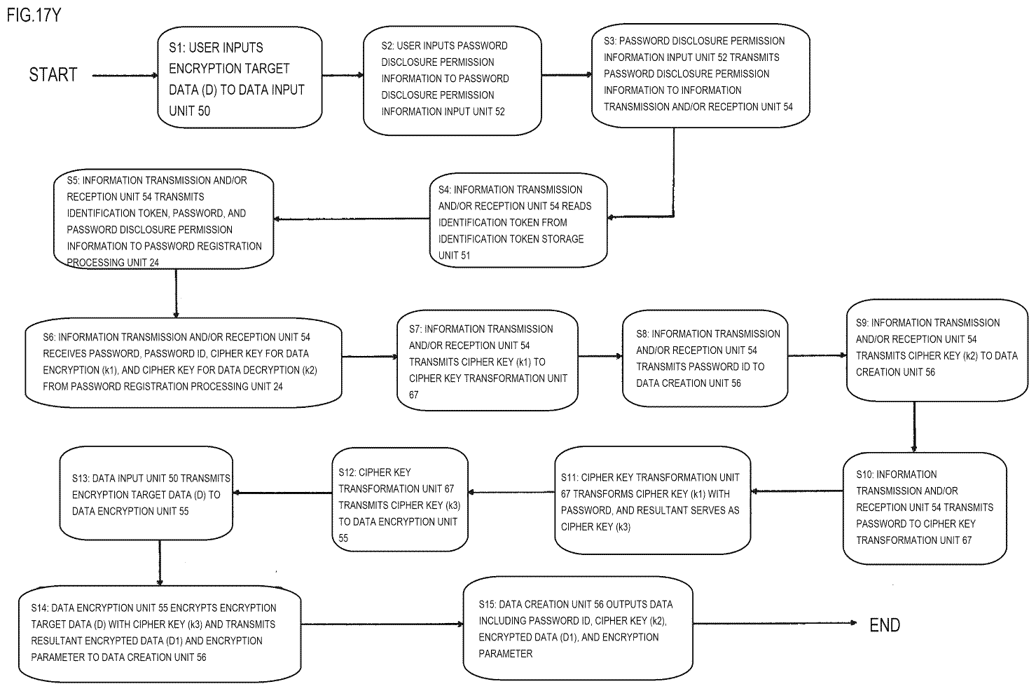

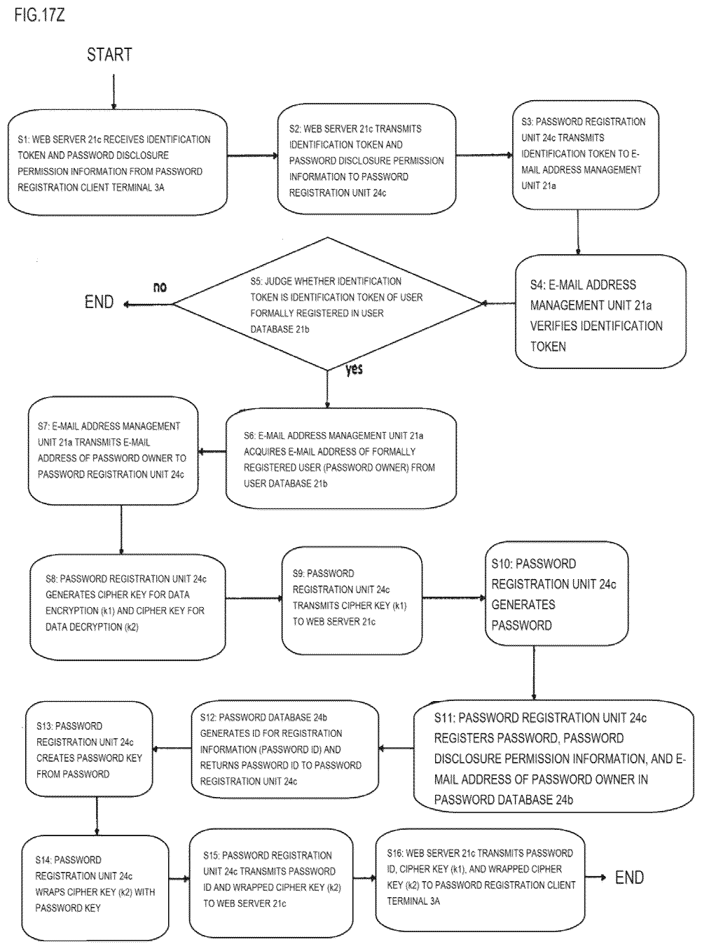

A password sharing server for a case of key wrapping in combination 3 has the same configuration as that of the second password sharing server in FIG. 15. Configurations and operations of the user registration processing unit 21, the login processing unit 22, the user relationship holding processing unit 23, and the password disclosure processing unit 25 are the same as those of the second password sharing server. A configuration of the password registration processing unit 24B is also the same as that of the second password sharing server (FIG. 16A), but the operations of the password registration processing unit 24B are different from those of the second password sharing server. FIG. 17A illustrates the operations of the password registration processing unit 24B. FIG. 17B illustrates a configuration of a password registration client terminal communicating with the password sharing server. FIG. 17C illustrates the operations of the password registration client terminal. A password acquisition client terminal communicating with the password sharing server is a first password acquisition client (corresponding to key wrapping).

A password sharing server for a case of key transformation in combination 3 also has the same configuration as that of the second password sharing server in FIG. 15. Configurations and operations of the user registration processing unit 21, the login processing unit 22, the user relationship holding processing unit 23, and the password disclosure processing unit 25 are the same as those of the second password sharing server. A configuration of the password registration processing unit 24B is also the same as that of the second password sharing server (FIG. 16A), but the operations of the password registration processing unit 24B are different from those of the second password sharing server. FIG. 17D illustrates the operations of the password registration processing unit 24B. A configuration of a password registration client terminal communicating with the password sharing server is the same as that in FIG. 17B, but operations of the password registration client terminal are different from those in FIG. 17B. FIG. 17E illustrates the operations of the password registration client terminal. A password acquisition client terminal communicating with the password sharing server is a second password acquisition client terminal (corresponding to key transformation).

A password sharing server for a case of key wrapping in combination 4 has the same configuration as that of the second password sharing server in FIG. 15. Configurations and operations of the user registration processing unit 21, the login processing unit 22, the user relationship holding processing unit 23, and the password disclosure processing unit 25 are the same as those of the second password sharing server. A configuration of the password registration processing unit 24B is also the same as that of the second password sharing server (FIG. 16A), but the operations of the password registration processing unit 24B are different from those of the second password sharing server. FIG. 17F illustrates the operations of the password registration processing unit 24B. FIG. 17G illustrates a configuration of a password registration client terminal communicating with the password sharing server. FIG. 17H illustrates the operations of the password registration client terminal. A password acquisition client terminal communicating with the password sharing server is a first password acquisition client terminal (corresponding to key wrapping).

A password sharing server for a case of key transformation in combination 4 also has the same configuration as that of the second password sharing server in FIG. 15. Configurations and operations of the user registration processing unit 21, the login processing unit 22, the user relationship holding processing unit 23, and the password disclosure processing unit 25 are the same as those of the second password sharing server. A configuration of the password registration processing unit 24B is also the same as that of the second password sharing server (FIG. 16A), but the operations of the password registration processing unit 24B are different from those of the second password sharing server. FIG. 17I illustrates the operations of the password registration processing unit 24B. A configuration of a password registration client terminal communicating with the password sharing server is the same as that in FIG. 17G, but operations of the password registration client terminal are different from those in FIG. 17G. FIG. 17J illustrates the operations of the password registration client terminal. A password acquisition client terminal communicating with the password sharing server is a second password acquisition client terminal (corresponding to key transformation).

A password sharing server for a case of key wrapping in combination 5 has the same configuration as that of the second password sharing server in FIG. 15. Configurations and operations of the user registration processing unit 21, the login processing unit 22, the user relationship holding processing unit 23, and the password disclosure processing unit 25 are the same as those of the second password sharing server. A configuration of the password registration processing unit 24B is also the same as that of the second password sharing server (FIG. 16A), but the operations of the password registration processing unit 24B are different from those of the second password sharing server. FIG. 17K illustrates the operations of the password registration processing unit 24B. FIG. 17L illustrates a configuration of a password registration client terminal communicating with the password sharing server. FIG. 17M illustrates the operations of the password registration client terminal. A password acquisition client terminal communicating with the password sharing server is a first password acquisition client terminal (corresponding to key wrapping).

A password sharing server for a case of key transformation in combination 5 also has the same configuration as that of the second password sharing server in FIG. 15. Configurations and operations of the user registration processing unit 21, the login processing unit 22, the user relationship holding processing unit 23, and the password disclosure processing unit 25 are the same as those of the second password sharing server. A configuration of the password registration processing unit 24B is also the same as that of the second password sharing server (FIG. 16A), but the operations of the password registration processing unit 24B are different from those of the second password sharing server. FIG. 17N illustrates the operations of the password registration processing unit 24B. A configuration of a password registration client terminal communicating with the password sharing server is the same as that in FIG. 17L, but operations of the password registration client terminal are different from those in FIG. 17L. FIG. 17O illustrates the operations of the password registration client terminal. A password acquisition client terminal communicating with the password sharing server is a second password acquisition client terminal (corresponding to key transformation).

A password sharing server for a case of key wrapping in combination 6 has the same configuration as that of the second password sharing server in FIG. 15. Configurations and operations of the user registration processing unit 21, the login processing unit 22, the user relationship holding processing unit 23, and the password disclosure processing unit 25 are the same as those of the second password sharing server. A configuration of the password registration processing unit 24B is also the same as that of the second password sharing server (FIG. 16A), but the operations of the password registration processing unit 24B are different from those of the second password sharing server. FIG. 17P illustrates the operations of the password registration processing unit 24B. FIG. 17Q illustrates a configuration of a password registration client terminal communicating with the password sharing server. FIG. 17R illustrates the operations of the password registration client terminal. A password acquisition client terminal communicating with the password sharing server is a first password acquisition client terminal (corresponding to key wrapping).

A password sharing server for a case of key transformation in combination 6 also has the same configuration as that of the second password sharing server in FIG. 15. Configurations and operations of the user registration processing unit 21, the login processing unit 22, the user relationship holding processing unit 23, and the password disclosure processing unit 25 are the same as those of the second password sharing server. A configuration of the password registration processing unit 24B is also the same as that of the second password sharing server (FIG. 16A), but the operations of the password registration processing unit 24B are the same as those in FIG. 17P. FIG. 17S illustrates a configuration of a password registration client terminal communicating with the password sharing server. FIG. 17T illustrates the operations of the password registration client terminal. A password acquisition client terminal communicating with the password sharing server is a second password acquisition client terminal (corresponding to key transformation).

A password sharing server for a case of key wrapping in combination 7 has the same configuration as that of the second password sharing server in FIG. 15. Configurations and operations of the user registration processing unit 21, the login processing unit 22, the user relationship holding processing unit 23, and the password disclosure processing unit 25 are the same as those of the second password sharing server. A configuration of the password registration processing unit 24B is also the same as that of the second password sharing server (FIG. 16A), but the operations of the password registration processing unit 24B are different from those of the second password sharing server. FIG. 17U illustrates the operations of the password registration processing unit 24B. FIG. 17V illustrates a configuration of a password registration client terminal communicating with the password sharing server. FIG. 17W illustrates the operations of the password registration client terminal. A password acquisition client terminal communicating with the password sharing server is a first password acquisition client terminal (corresponding to key wrapping).

A password sharing server for a case of key transformation in combination 7 also has the same configuration as that of the second password sharing server in FIG. 15. Configurations and operations of the user registration processing unit 21, the login processing unit 22, the user relationship holding processing unit 23, and the password disclosure processing unit 25 are the same as those of the second password sharing server. A configuration of the password registration processing unit 24B is also the same as that of the second password sharing server (FIG. 16A), but the operations of the password registration processing unit 24B are the same as those in FIG. 17U. FIG. 17X illustrates a configuration of a password registration client terminal communicating with the password sharing server. FIG. 17Y illustrates the operations of the password registration client terminal. A password acquisition client terminal communicating with the password sharing server is a second password acquisition client terminal (corresponding to key transformation).

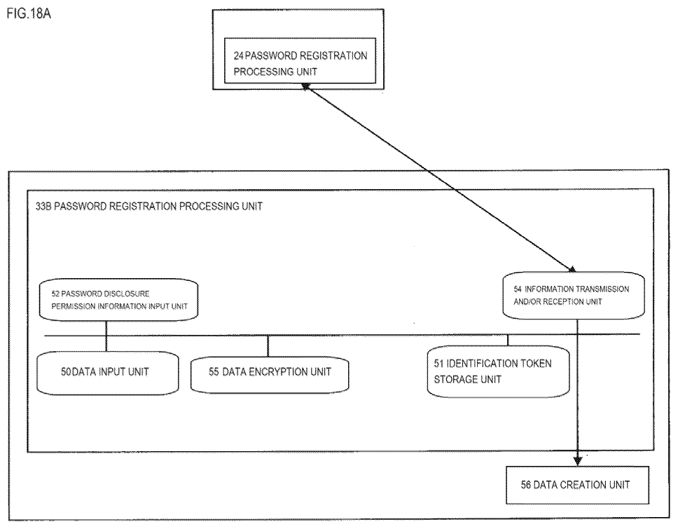

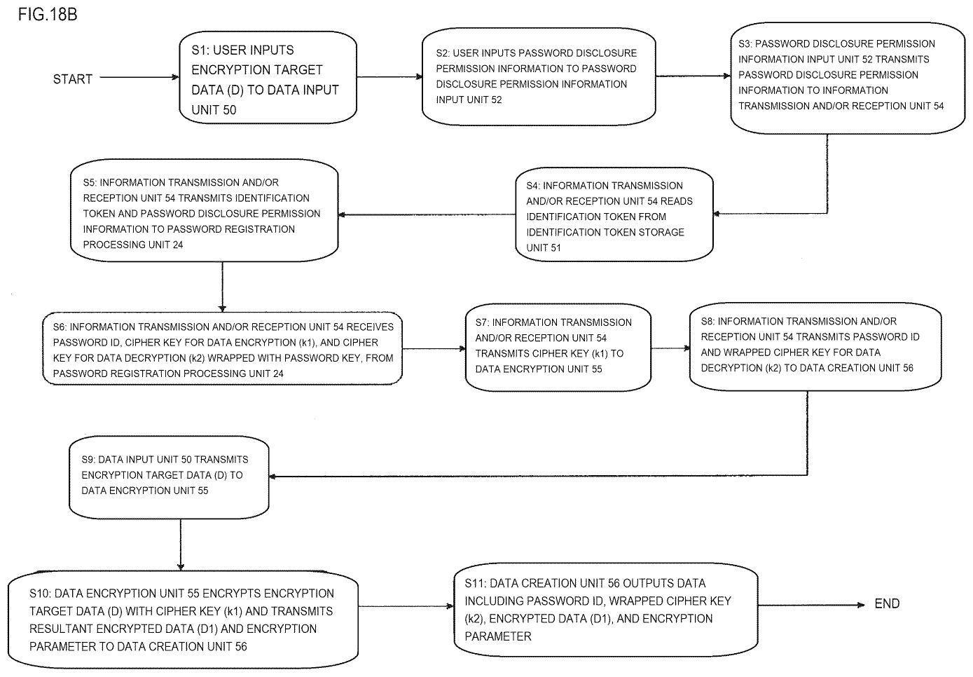

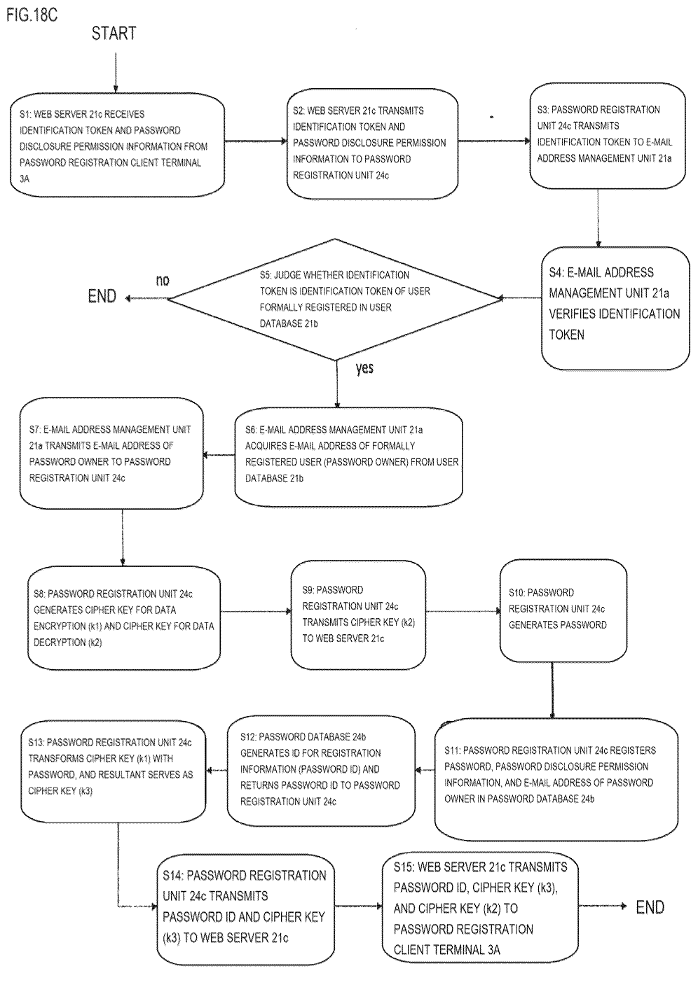

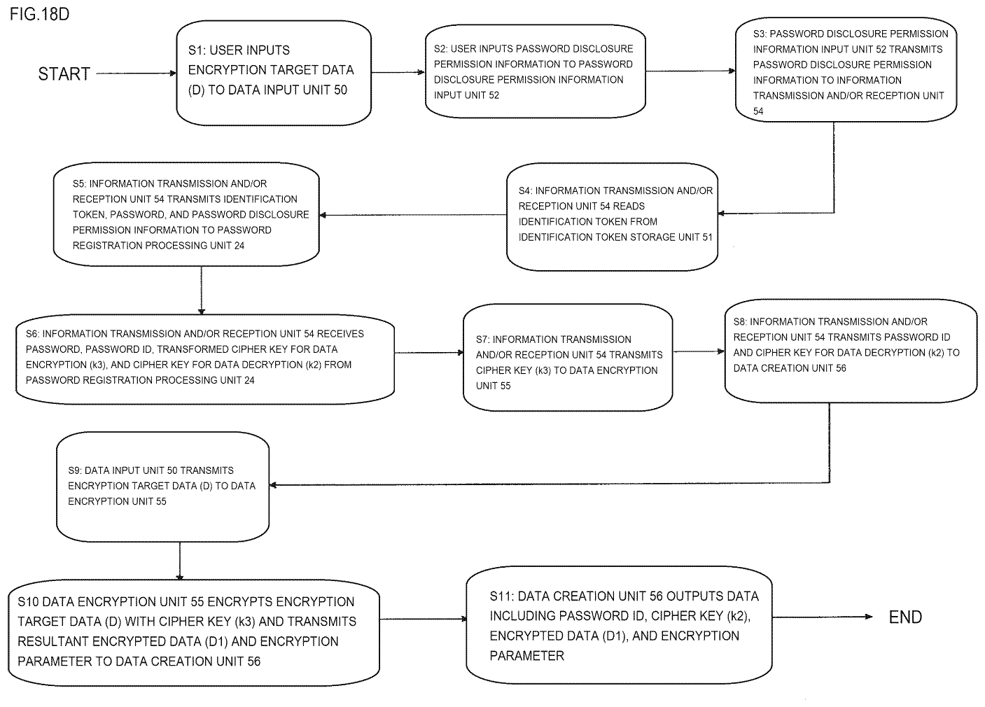

A password sharing server for a case of key wrapping in combination 8 has the same configuration as that of the second password sharing server in FIG. 15. Configurations and operations of the user registration processing unit 21, the login processing unit 22, the user relationship holding processing unit 23, and the password disclosure processing unit 25 are the same as those of the second password sharing server. A configuration of the password registration processing unit 24B is also the same as that of the second password sharing server (FIG. 16A), but the operations of the password registration processing unit 24B are different from those of the second password sharing server. FIG. 17Z illustrates the operations of the password registration processing unit 24B. FIG. 18A illustrates a configuration of a password registration client terminal communicating with the password sharing server. FIG. 18B illustrates the operations of the password registration client terminal. A password acquisition client terminal communicating with the password sharing server is a first password acquisition client terminal (corresponding to key wrapping).

A password sharing server for a case of key transformation in combination 8 also has the same configuration as that of the second password sharing server in FIG. 15. Configurations and operations of the user registration processing unit 21, the login processing unit 22, the user relationship holding processing unit 23, and the password disclosure processing unit 25 are the same as those of the second password sharing server. A configuration of the password registration processing unit 24B is also the same as that of the second password sharing server (FIG. 16A), but FIG. 18C illustrates the operations of the password registration processing unit 24B. A configuration of a password registration client terminal communicating with the password sharing server is the same as that in FIG. 18A. FIG. 18D illustrates the operations of the password registration client terminal. A password acquisition client terminal communicating with the password sharing server is a second password acquisition client terminal (corresponding to key transformation).

### {Details of First Password Registration Client Terminal}

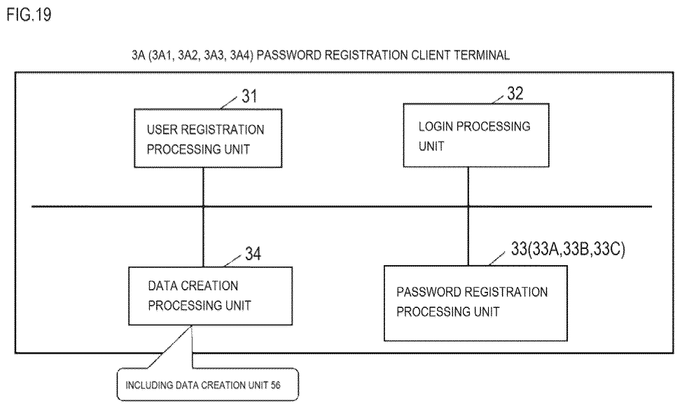

Details of a first password registration client terminal 3A1 in the password sharing system 1 will be described with reference to FIGS. 1A to 1D, FIG. 19, and related drawings together.

With reference to FIG. 19, the password registration client terminal 3A, as the first password registration client terminal 3A1, includes the user registration processing unit 31, the login processing unit 32, a password registration processing unit 33B, and the data creation processing unit 34 as functional components. Here, the data creation processing unit 34 includes the data creation unit 56 (this similarly applies to other embodiments (examples)).

The first password registration client terminal 3A1 further includes the password deletion processing unit 37, the password disclosure period change processing unit 38, the password disclosure permission information change processing unit 39, or the like according to each embodiment (example).

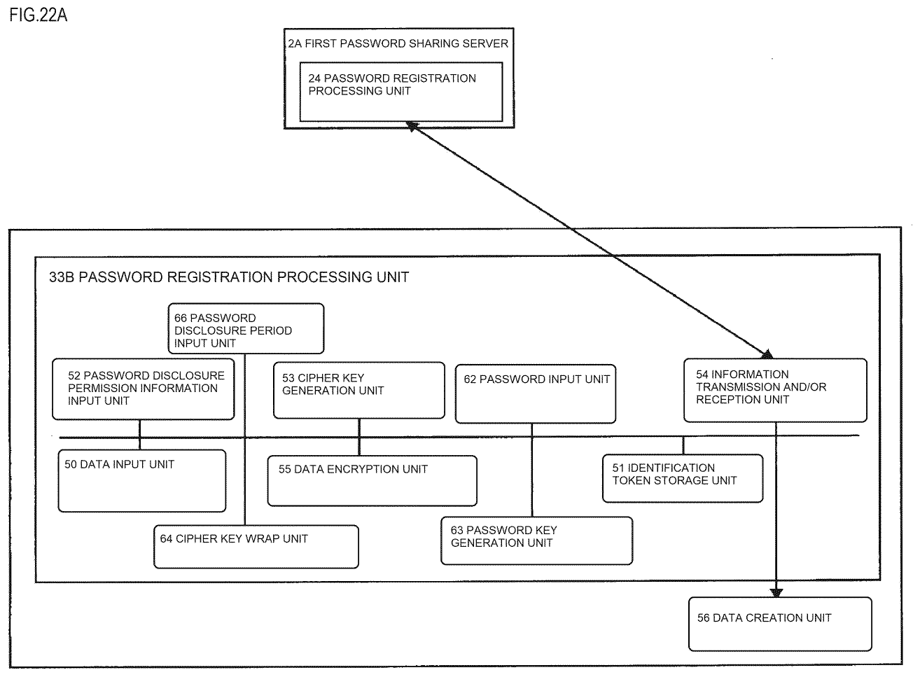

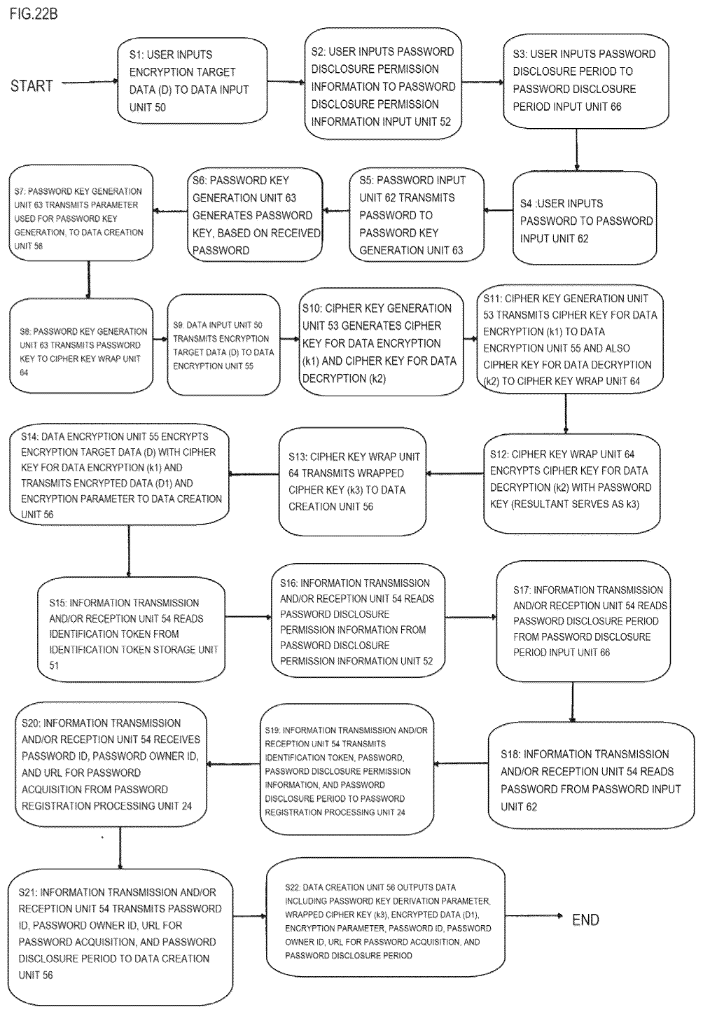

The basic feature elements of the first password registration client terminal 3A1 include the identification token storage unit 51, the password disclosure permission information input unit 52, the cipher key generation unit 53, the password input unit 62, a password key generation unit 63, the cipher key wrap unit 64, the information transmission and/or reception unit (network access unit) 54, the data encryption unit 55, and the data creation unit 56 (refer to FIG. 22A).

In other words, the first password registration client terminal 3A1 is a client terminal having a password registration function applicable to the password sharing system 1 including a server and includes the identification token storage unit 51 configured to store an identification token (proof) indicating that a corresponding user is an authenticated user, the password input unit 62 configured to receive an input of a password, and the password disclosure permission information input unit 52 configured to receive an input of password disclosure permission information designating the disclosure permissible range of the password. The first password registration client terminal 3A1 includes the password key generation unit 63 configured to generate a key (password key) for encrypting (wrapping) a key, based on the password input by the password input unit 62.

The first password registration client terminal 3A1 includes the cipher key generation unit 53 configured to generate a cipher key for data encryption and a cipher key for data decryption, the cipher key wrap unit 64 configured to wrap the key for data decryption with a password key, and the information transmission and/or reception unit (network access unit) 54 configured to transmit the identification token stored in the identification token storage unit 51, the wrapped cipher key for data decryption output by the cipher key wrap unit 64, and the password disclosure permission information input to the password disclosure permission information input unit 52, to the password sharing server 2 (2A) as transmission information, and receive password identification information (password ID) corresponding to the transmission information from the password sharing server 2 (2A).

The first password registration client terminal 3A1 further includes the data encryption unit 55 configured to use, in response to an input of encryption target data, the cipher key 136 for data encryption after first processing generated by the cipher key first processing unit 109, to encrypt the encryption target data, and output encrypted data thus encrypted, and the data creation unit 56 configured to output, in response to an input of the password ID received by the information transmission and/or reception unit 54 from the password sharing server 2 (2A) and the encrypted data output by the data encryption unit 55, data including the password ID and the encrypted data.

The first password registration client terminal 3A1 can adopt any of the following aspects. Note that [Aspect 12] to [Aspect 14] are also applicable to a second password registration client terminal 3A2, a third password registration client terminal 3A3, and a fourth password registration client terminal 3A4 to be described below.

[Aspect 12] In the first password registration client terminal 3A1, the password disclosure permission information includes at least one of a relationship between users registered to the password sharing server 2 (2A) in advance, designation of a user group registered to the password sharing server 2 (2A) in advance, and a list of e-mail addresses. Regarding the list of e-mail addresses, the client terminal 3A1 may transmit the list of e-mail addresses as the password disclosure permission information.

[Aspect 13] The first password registration client terminal 3A1 further includes a password disclosure period input unit 66 configured to receive an input of a password disclosure start time or a password disclosure end time as a password disclosure period, from a user. The information transmission and/or reception unit 54 transmits the password disclosure period input to the password disclosure period input unit 66, to the password sharing server 2 (2A).

[Aspect 14] In the first password registration client terminal 3A1, the data creation unit 56 outputs data including at least one of an encryption parameter, a password owner ID, a URL for password acquisition, a password disclosure period, and a data creation time and date.

With reference to FIG. 20, the user registration processing unit 31 in the first password registration client terminal 3A1 is configurable to include a user input unit 31a, an e-mail reception unit 31b, the identification token storage unit 51, and the information transmission and/or reception unit (network access unit) 54 as detailed components. These components include those shared with other processing units.

The processing in this user registration processing unit 31 is considered to be similar to what is performed in general at the time of account registration in various Internet services such as Facebook and can be easily understood by those skilled in the art. Hence, only main points will be described here.

In the user registration processing unit 31, the user input unit 31a, the e-mail reception unit 31b, the identification token storage unit 51, and the information transmission and/or reception unit 54 cooperate to communicate with the user registration processing unit 21 in the first password sharing server 2A and temporarily register an e-mail address used by a user and a password. In the user registration processing unit 31, a registration token received with the e-mail address is used to formally register the e-mail address to the first password sharing server 2A. Consequently, in the user registration processing unit 31, the identification token generated by the user registration processing unit 21 in the first password sharing server 2A is received and stored in the identification token storage unit 51.

With reference to FIG. 21, the login processing unit 32 in the first password registration client terminal 3A1 is configurable to include the user input unit 31a, the identification token storage unit 51, and the information transmission and/or reception unit (network access unit) 54 as detailed components. These components are shared with the user registration processing unit 31.

The processing in this login processing unit 32 is considered to be similar to what is performed in general at login in various Internet services such as Facebook and can be easily understood by those skilled in the art. Hence, only main points will be described here.

In the login processing unit 32, the user input unit 31a, the identification token storage unit 51, and the information transmission and/or reception unit 54 cooperate to communicate with the login processing unit 22 in the first password sharing server 2A, receive the identification token of a formally registered user, and store the identification token in the identification token storage unit 51.

With reference to FIG. 22A, the password registration processing unit 33B in the first password registration client terminal 3A1 is configurable to include the data input unit 50, the identification token storage unit 51, the password disclosure permission information input unit 52, the cipher key generation unit 53, the information transmission and/or reception unit (network access unit) 54, the data encryption unit 55, the password key generation unit 63, the cipher key wrap unit 64, and the password disclosure period input unit 66 as detailed components. This password registration processing unit 33B operates with the data creation unit 56 configuring the data creation processing unit 34 (refer to FIG. 19). The password registration processing unit 33B in the first password registration client terminal 3A1 communicates with the password registration processing unit 24 in the first password sharing server 2A.

In this password registration processing unit 33B, the data input unit 50, the identification token storage unit 51, the password disclosure permission information input unit 52, the cipher key generation unit 53, the information transmission and/or reception unit 54, the data encryption unit 55, the password key generation unit 63, the cipher key wrap unit 64, and the password disclosure period input unit 66 cooperate to execute main points of the following processing. Specifically, the password disclosure permission information input by a user is, for example, designation of a relationship between users such as “family”. Alternatively, the password disclosure permission information is designation of a group held by the user relationship holding processing unit 23 of the password sharing server 2A. As the password disclosure permission information, password disclosure target users can be designated by a list of e-mail addresses.

Encrypted data (D1) is a result obtained by encrypting encryption target data (D) with a cipher key (k1) for data encryption. Note that, at the time of reading an identification token, user registration to the password sharing server 2A using the user registration processing unit 31 or login to the password sharing server 2A using the login processing unit 32 are assumed to be completed. As a result, a valid identification token transmitted from the password sharing server 2A is stored in the identification token storage unit 51.

In this example, a cipher key of asymmetric key encryption is assumed. The cipher key generation unit 53 generates a pair of a cipher key k1 for data encryption and a cipher key k2 for data decryption. k1 may correspond to a public key while k2 may correspond to a private key, or vice versa. The cipher key generation unit 53 transmits the cipher key k1 for data encryption to the data encryption unit 55 and the cipher key k2 for data decryption to the information transmission and/or reception unit 54. The cipher key k2 for data decryption is then transmitted to the password registration processing unit 24 of the first password sharing server 2A. In a case of adopting symmetric key encryption, the cipher key k1 for data encryption and the cipher key k2 for data decryption are identical.

Examples of the encryption parameter are various parameters for encryption to be shared with the decryption side at the time of encryption. For example, nonce (random number) and an initial vector (IV) in Counter mode correspond to these. When the encryption parameter is shared with the decryption side in some method in advance, there is no need to explicitly notify the decryption side of the encryption parameter. Hence, the data encryption unit 55 does not transmit the encryption parameter with no need of notification, to the data creation unit 56. In this example, the password registration processing unit 33B transmits the following seven kinds of data, i.e., a password ID, a password owner ID (e-mail address), a URL for password acquisition, a password disclosure period, encrypted data D1, a password key derivation parameter, and an encryption parameter to the data creation unit 56.

With reference to FIG. 22A and FIG. 22B together, in the password registration processing unit 33B, the following detailed processing steps are executed as an example.

[S1 (refer to FIG. 22B)] A user inputs encryption target data (D) to the data input unit 50.
[S2] The user inputs password disclosure permission information to the password disclosure permission information input unit 52.
[S3] The user inputs a password disclosure period to the password disclosure period input unit 66.
[S4] The user inputs a password to the password input unit 62.
[S5] The password input unit 62 transmits the password to the password key generation unit 63.
[S6] The password key generation unit 63 generates a password key on the basis of the received password.
[S7] The password key generation unit 63 transmits a parameter used for the password key generation to the data creation unit 56. This is the password key derivation parameter described in paragraph.
[S8] The password key generation unit 63 transmits the password key to the cipher key wrap unit 64. [S9] The data input unit 50 transmits encryption target data (D) to the data encryption unit 55.
[S10] The cipher key generation unit 53 generates a cipher key (k1) for data encryption and a cipher key (k2) for data decryption.
[S11] The cipher key generation unit 53 transmits the cipher key (k1) for data encryption to the data encryption unit 55 and the cipher key (k2) for data decryption to the cipher key wrap unit 64.
[S12] The cipher key wrap unit 64 wraps (encrypts) the cipher key (k2) for data decryption with the password key. Data obtained as a result of the wrapping is referred to as k3.
[S13] The cipher key wrap unit 64 transmits the wrapped cipher key (k3) to the data creation unit 56.
[S14] The data encryption unit 55 encrypts the encryption target data (D) with the cipher key (k1) for data encryption and transmits encrypted data (D1) and an encryption parameter to the data creation unit 56. The encryption parameter here is nonce described in paragraph [0224], for example.
[S15] The information transmission and/or reception unit 54 reads a corresponding identification token from the identification token storage unit 51.
[S16] The information transmission and/or reception unit 54 reads password disclosure permission information from the password disclosure permission information input unit 52.
[S17] The information transmission and/or reception unit 54 reads a password disclosure period from the password disclosure period input unit 66.
[S18] The information transmission and/or reception unit 54 reads a password from the password input unit 62.
[S19] The information transmission and/or reception unit 54 transmits the identification token, the password, the password disclosure permission information, and the password disclosure period to the password registration processing unit 24.
[S20] The information transmission and/or reception unit 54 receives a password ID, a password owner ID, and a URL for password acquisition from the password registration processing unit 24.
[S21] The information transmission and/or reception unit 54 transmits the password ID, the password owner ID, the URL for password acquisition, and the password disclosure period to the data creation unit 56.
[S22] The data creation unit 56 outputs data including the password key derivation parameter, the cipher key (k3) for data decryption wrapped with the password key, the encrypted data (D1), the encryption parameter, the password ID, the password owner ID, the URL for password acquisition, and the password disclosure period.

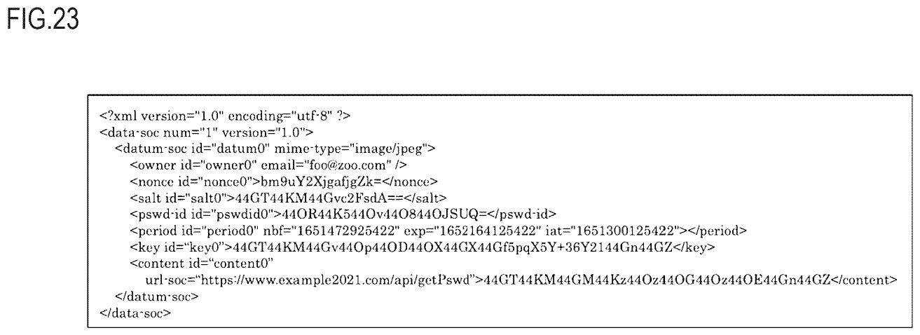

The data creation unit 56 configuring the data creation processing unit 34 operating with the password registration processing unit 33B receives the above eight kinds of data (password ID, password owner ID (e-mail address), wrapped cipher key for data decryption, URL for password acquisition, password disclosure period, encrypted data D1, encryption parameter, and password key derivation parameter) from the password registration processing unit 33B and format the data as illustrated in FIG. 23 to write the data into a file.

In the example illustrated in FIG. 23, the file is output in an xml format. The <data-soc> element is a parent element of the entire file. The attribute num of the element indicates that one piece of encrypted data is included in the element. The <datum-soc> element is an element including the encrypted data. The <datum-soc> element includes six child elements: <owner>, <nonce>, <salt>, <pswd-id>, <period>, and <content>. In <owner>, the password owner ID is described. In this example, it is described in the e-mail attribute of the <owner> element that an e-mail address “foo@zoo.com” is the password owner ID.

<nonce> is the encryption parameter received by the data creation unit 56 in paragraph [0225] [S14]. Here, the value of the encryption parameter is encoded in base64 and described. <salt> is the password key derivation parameter received by the data creation unit 56 in paragraph [0225] [S7]. This value is similarly encoded in base64 and described. In <pswd-id>, the password ID received by the information transmission and/or reception unit 54 of the password registration processing unit 33B from the password registration processing unit 24 of the first password sharing server 2A is described. In the example in FIG. 23, the value of the password ID encoded in base64 is described as an internal text in the <pswd-id> element. In the url-soc attribute of the <pswd-id> element, a URL for password acquisition “https://www.example 2021.com/api/getPswd” is described.

In the <period> element, a password disclosure period is described. The nbf attribute and the exp attribute of the <period> element are in Universal Coordinated Time (UTC) in milliseconds and indicate a password disclosure start time and a password disclosure end time, respectively. Note that nbf stands for “not before”, and exp stands for “expiration”. The iat attribute of the <period> element indicates a data creation time and is expressed in UTC in milliseconds similarly to nbf and exp. The value of the iat attribute indicates the current time acquired by the data creation unit 56. Note that iat stands for “issued at”.

The internal text of the <key> element is the wrapped cipher key for data decryption encoded in base64. This wrapped cipher key for data decryption is what is received by the data creation unit 56 from the cipher key wrap unit 64 in paragraph [0225] [S13].

The internal text of the <content> element is the encrypted data D1 encoded in base64. Data in a format including a password ID, a password owner ID, a URL for password acquisition, a password disclosure period, encrypted data D1, a password key derivation parameter, and an encryption parameter as that illustrated in FIG. 23 is sometimes described as encrypted data below. Note that this encrypted data does not necessarily include a password owner ID, a URL for password acquisition, a password key derivation parameter, and an encryption parameter.

Data output by the data creation unit 56 is not limited to a file. For example, xml data as in FIG. 23 or html data may be posted to a message board or a personal blog on the Internet. Alternatively, data may be made public using a cloud storage. The above-described encrypted data is available to anyone, but who can decrypt the encrypted data is only a registered user who can obtain a corresponding password from the first password sharing server 2A. The registered user is, for example, a user with an e-mail address designated in password disclosure permission information by the user who has registered the password. Alternatively, the registered user is a user registered by the user who has registered the password, as “good friend” to the user relationship holding processing unit 23. (This corresponds to a case where the password disclosure permission information registered to the server indicates “good friend”,)

### {Details of Second Password Registration Client Terminal}

Details of a second password registration client terminal 3A2 in the password sharing system 1 will be described with reference to FIGS. 1A to 1D, FIG. 19, and related drawings together.

With reference to FIG. 19, the password registration client terminal 3A, as the second password registration client terminal 3A2, includes the user registration processing unit 31, the login processing unit 32, a password registration processing unit 33C, and the data creation processing unit 34 as functional components.

The second password registration client terminal 3A2 further includes the password deletion processing unit 37, the password disclosure period change processing unit 38, the password disclosure permission information change processing unit 39, or the like according to each embodiment (example).

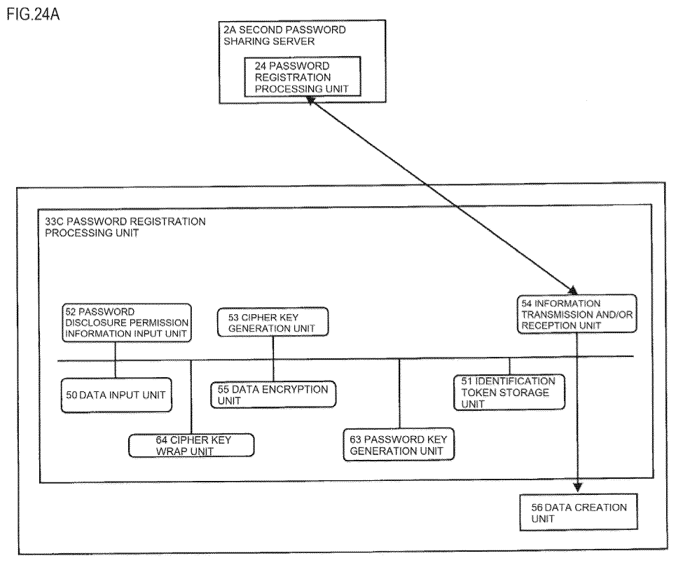

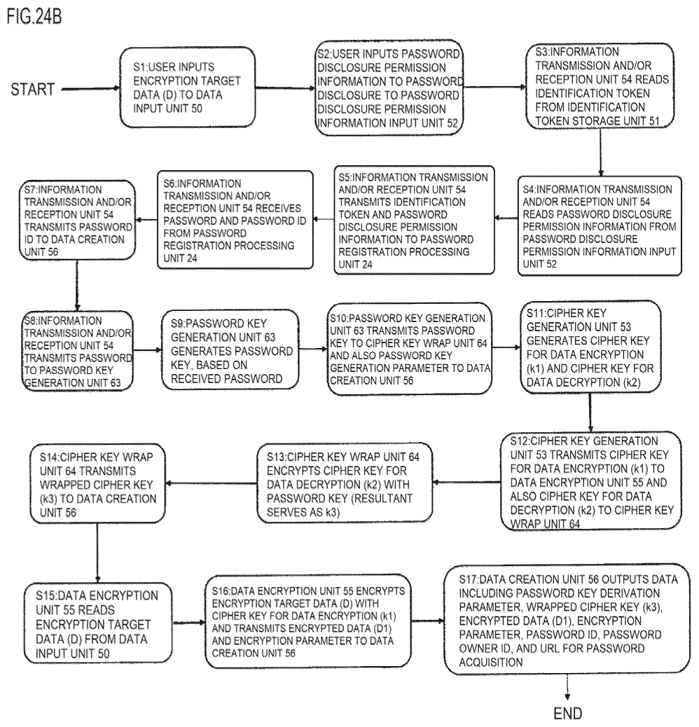

The basic feature elements of the second password registration client terminal 3A2 include the identification token storage unit 51, the password disclosure permission information input unit 52, the cipher key generation unit 53, the password key generation unit 63, the cipher key wrap unit 64, the information transmission and/or reception unit (network access unit) 54, the data encryption unit 55, and a data creation unit 56 (refer to FIG. 24A).

The second password registration client terminal 3A2 does not include the password input unit 62 in the first password registration client terminal 3A1.

In other words, the second password registration client terminal 3A2 is a client terminal having a password registration function applicable to the password sharing system 1 including a server and includes the identification token storage unit 51 configured to store an identification token (proof) indicating that a corresponding user is an authenticated user, and the password disclosure permission information input unit 52 configured to receive an input of password disclosure permission information designating the disclosure permissible range of the password.

The second password registration client terminal 3A2 includes the information transmission and/or reception unit (network access unit) 54 configured to transmit the identification token stored in the identification token storage unit 51 and the password disclosure permission information input to the password disclosure permission information input unit 52, to the password sharing server 2 (2B) as transmission information and receive a password corresponding to the transmission information and the password identification information (password ID) of the password from the password sharing server 2. This password is generated by the password sharing server 2.

The second password registration client terminal 3A2 further includes the data encryption unit 55 configured to encrypt, in response to an input of encryption target data and the cipher key generation unit 53 generating a cipher key for data encryption and a cipher key for data decryption, the encryption target data with the cipher key for data encryption, and output encrypted data thus encrypted, the password key generation unit 63 configured to generate a password key for wrapping (encrypting) the cipher key for data decryption, on the basis of the password received by the information transmission and/or reception unit 54 from the password sharing server 2 (2B), the cipher key wrap unit 64 configured to wrap the cipher key for data decryption generated by the cipher key generation unit 53 with the password key generated by the password key generation unit 63, and the data creation unit 56 configured to output, in response to an input of the wrapped cipher key for data decryption output by the cipher key wrap unit 64, the password ID received by the information transmission and/or reception unit 54 from the password sharing server 2 (2B), and the encrypted data output by the data encryption unit 55, data including the password ID and the encrypted data.

With reference to FIG. 24A, the password registration processing unit 33C in the second password registration client terminal 3A2 is configurable to include the data input unit 50, the identification token storage unit 51, the password disclosure permission information input unit 52, the information transmission and/or reception unit (network access unit) 54, the cipher key generation unit 53, the password key generation unit 63, the cipher key wrap unit 64, and the data encryption unit 55 as detailed components. These components include those shared with other processing units. This password registration processing unit 33C operates with the data creation unit 56 configuring the data creation processing unit 34 (refer to FIG. 19).

The password registration processing unit 33C in the second password registration client terminal 3A2 communicates with the password registration processing unit 24B in the second password sharing server 2B.

With reference to FIG. 24A and FIG. 24B together, in the password registration processing unit 33C, the data input unit 50, the identification token storage unit 51, the password disclosure permission information input unit 52, the information transmission and/or reception unit 54, the cipher key generation unit 53, the password key generation unit 63, the cipher key wrap unit 64, and the data encryption unit 55 cooperate to execute main points of the following detailed processing steps.

[S1 (refer to FIG. 24B)] A user inputs encryption target data (D) to the data input unit 50.
[S2] The user inputs password disclosure permission information to the password disclosure permission information input unit 52.
[S3] The information transmission and/or reception unit 54 reads a corresponding identification token from the identification token storage unit 51.
[S4] The information transmission and/or reception unit 54 reads password disclosure permission information from the password disclosure permission information input unit 52.
[S5] The information transmission and/or reception unit 54 transmits the identification token and the password disclosure permission information to the password registration processing unit 24.
[S6] The information transmission and/or reception unit 54 receives a password and a password ID from the password registration processing unit 24.
[S7] The information transmission and/or reception unit 54 transmits the password ID to the data creation unit 56.
[S8] The information transmission and/or reception unit 54 transmits the password to the password key generation unit 63.
[S9] The password key generation unit 63 generates a password key on the basis of the received password.
[S10] The password key generation unit 63 transmits the password key generated in [S9] to the cipher key wrap unit 64 and also transmits a password key derivation parameter used to generate the password key in [S9] to the data creation unit 56.
[S11] The cipher key generation unit 53 generates a cipher key (k1) for data encryption and a cipher key (k2) for data decryption.
[S12] The cipher key generation unit 53 transmits the cipher key (k1) for data encryption to the data encryption unit 55 and the cipher key (k2) for data decryption to the cipher key wrap unit 64.
[S13] The cipher key wrap unit 64 wraps (encrypts) the cipher key (k2) for data decryption with the password key received in [S10]. (The result of the encryption is referred to as k3.)
[S14] The cipher key wrap unit 64 transmits the wrapped cipher key (k3) to the data creation unit 56.
[S15] The data encryption unit 55 reads encryption target data (D) from the data input unit 50.
[S16] The data encryption unit 55 encrypts the encryption target data (D) with the cipher key (k1) for data encryption and transmits encrypted data (D1), which is the result of the encryption, and an encryption parameter to the data creation unit 56.
[S17] The data creation unit 56 outputs data including the password key derivation parameter, the wrapped cipher key (k3), the encrypted data (D1), the encryption parameter, the password ID, the password owner ID, and the URL for password acquisition.

The password owner ID output by the data creation unit 56 is the e-mail address of the user using the second password registration client terminal 3A2. This e-mail address is assumed to be registered to the data creation unit 56 in advance by the user. The URL for password acquisition output by the data creation unit 56 is also held by the data creation unit 56 in advance.

### {Details of Third Password Registration Client Terminal}

Details of a third password registration client terminal 3A3 in the password sharing system 1 will be described with reference to FIGS. 1A to 1D, FIG. 19, and related drawings together.

With reference to FIG. 19, the password registration client terminal 3A, as the third password registration client terminal 3A3, includes the user registration processing unit 31, the login processing unit 32, a password registration processing unit 33D, and the data creation processing unit 34 as functional components.

The third password registration client terminal 3A3 further includes the password deletion processing unit 37, the password disclosure period change processing unit 38, the password disclosure permission information change processing unit 39, or the like according to each embodiment (example).

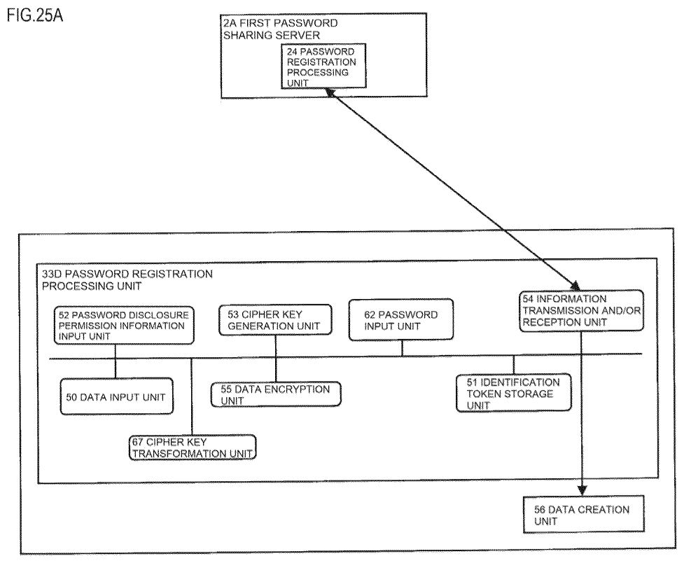

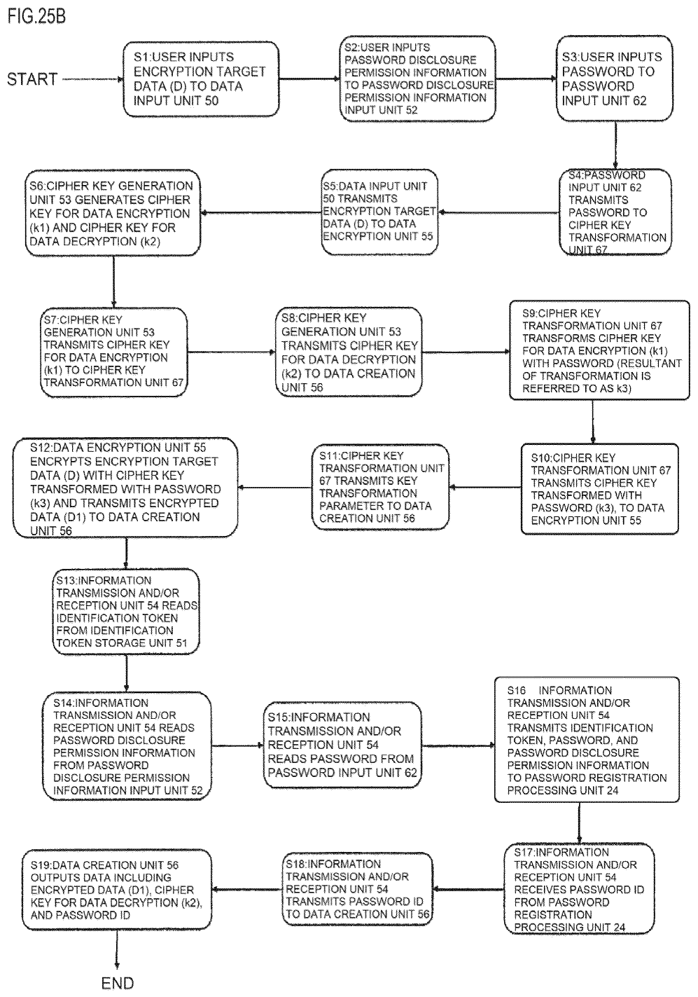

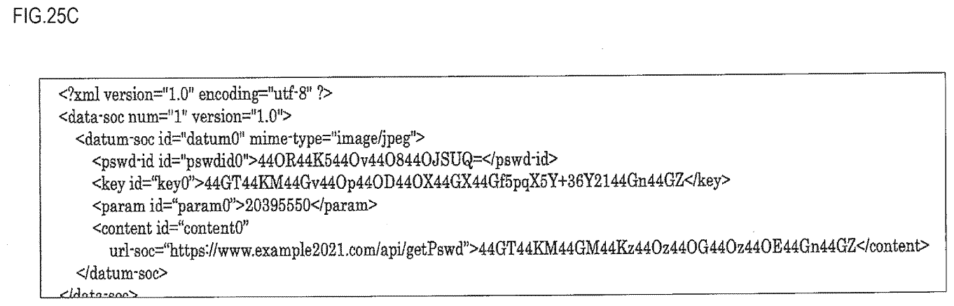

With reference to FIG. 25A, the basic feature elements of the third password registration client terminal 3A3 include the data input unit 50, the identification token storage unit 51, the password disclosure permission information input unit 52, the cipher key generation unit 53, the password input unit 62, the cipher key transformation unit 67, the information transmission and/or reception unit (network access unit) 54, the data encryption unit 55, and the data creation unit 56.

The third password registration client terminal 3A3 includes the cipher key transformation unit 67 instead of the cipher key wrap unit 64, in comparison with the first password registration client terminal 3A1. The cipher key transformation unit 67 transforms a cipher key to create a cipher key for data decryption in the methods described in paragraph [0085] and paragraph [0242], for example. The third password registration client terminal 3A3 does not include the password key generation unit 63 in comparison with the first password registration client terminal 3A1.

The information transmission and/or reception unit 54 of the third password registration client terminal 3A3 transmits an identification token stored in the identification token storage unit 51, a password input to the password input unit 62, and password disclosure permission information input to the password disclosure permission information input unit 52 to the password sharing server 2 (2A) as transmission information and receives the password ID corresponding to the transmission information from the password sharing server 2 (2A).

Here, the password input by a user using the third password registration client terminal 3A3 to the password input unit 62 may be optionally generated by the user or may be generated by a program on the basis of a random number, but these are not restrictive.

With reference to FIG. 25A, the password registration processing unit 33D in the third password registration client terminal 3A3 is configurable to include the data input unit 50, the identification token storage unit 51, the password disclosure permission information input unit 52, the cipher key generation unit 53, the information transmission and/or reception unit (network access unit) 54, the data encryption unit 55, the password input unit 62, and the cipher key transformation unit 67 as detailed components. These components include those shared with other processing units. This password registration processing unit 33D operates with the data creation unit 56 configuring the data creation processing unit 34 (refer to FIG. 19).

The password registration processing unit 33D in the third password registration client terminal 3A3 communicates with the password registration processing unit 24 in the first password sharing server 2A.

With reference to FIG. 25A and FIG. 25B together, in the password registration processing unit 33D, the data input unit 50, the identification token storage unit 51, the password disclosure permission information input unit 52, the cipher key generation unit 53, the information transmission and/or reception unit 54, the data encryption unit 55, the password input unit 62, and the cipher key transformation unit 67 cooperate to execute main points of the following detailed processing steps.

[S1 (refer to FIG. 25B)] A user inputs encryption target data (D) to the data input unit 50.
[S2] The user inputs password disclosure permission information to the password disclosure permission information input unit 52.
[S3] The user inputs a password to the password input unit 62.
[S4] The password input unit 62 transmits the password to the cipher key transformation unit 67.
[S5] The data input unit 50 transmits encryption target data (D) to the data encryption unit 55.
[S6] The cipher key generation unit 53 generates a cipher key (k1) for data encryption and a cipher key (k2) for data decryption.
[S7] The cipher key generation unit 53 transmits the cipher key (k1) for data encryption to the cipher key transformation unit 67.
[S8] The cipher key generation unit 53 transmits the cipher key (k2) for data decryption to the data creation unit 56.
[S9] The cipher key transformation unit 67 transforms the cipher key (k1) for data encryption with the password to generate a cipher key (k3) for data encryption.
[S10] The cipher key transformation unit 67 transmits the cipher key (k3) for data encryption transformed with the password to the data encryption unit 55.
[S11] The cipher key transformation unit 67 transmits the key transformation parameter used for the key transformation in [S9] to the data creation unit 56.
[S12] The data encryption unit 55 encrypts the encryption target data (D) with the cipher key (k3) for data encryption transformed with the password and transmits encrypted data (D1) and an encryption parameter to the data creation unit 56.
[S13] The information transmission and/or reception unit 54 reads a corresponding identification token from the identification token storage unit 51.
[S14] The information transmission and/or reception unit 54 reads password disclosure permission information from the password disclosure permission information input unit 52.
[S15] The information transmission and/or reception unit 54 reads a password from the password input unit 62.
[S16] The information transmission and/or reception unit 54 transmits the identification token, the password, and the password disclosure permission information to the password registration processing unit 24.
[S17] The information transmission and/or reception unit 54 receives a password ID from the password registration processing unit 24.
[S18] The information transmission and/or reception unit 54 transmits the password ID to the data creation unit 56.
[S19] The data creation unit 56 outputs data including the encrypted data (D1), the cipher key (k2) for data decryption, and the password ID.

The transformation of the cipher key used in the example above will be described. Here, elliptic-curve cryptography is employed. As common parameters, elliptic curve E and generation source P are open to the public. In this case, Q=sP is a public key for secret key s. This public key Q is transformed with password ρ. ρ denotes a password converted into numbers in an appropriate method. For example, assume that the password constituted of 16 characters including numbers and uppercase or lowercase alphabets. In this case, the password can be converted into a 16-byte numeric value constituted of 16 ASCII codes (each corresponding to 1 byte) of the respective characters arranged sequentially. Here, Q′=(s+mρ) P is assumed as a public key obtained through transformation with password ρ. s in this case is included in output data in [S19] as a cipher key for data decryption. (Hence, s is open to public.) Note that m is an appropriate integer, and mρ denotes multiplication of m and ρ. m is an example of a key transformation parameter.

Assume that an encryption target text is M. In this case, a cipher text is (C1, C2)=(rP, rQ′+M). Note that r is an appropriate random number. By calculating C2−(s+mρ) C1 for the cipher text, original text M is obtained. However, (s+mρ) C1 can be calculated only by a receiver who knows password ρ. In other words, in this case, s′=s+ρ is a secret key obtained by transformation with the password.

The data output in [S19] above is illustrated in FIG. 25C, for example. This example is output in an xml format, and cipher key (k2) for data decryption is described in the <key> element, and the password ID is encoded in base64 and described in the <pswd-id> element. In the <param> element, key transformation parameter m is described. Encrypted data (D1) is described in the <content> element.

### {Details of Fourth Password Registration Client Terminal}

Details of a fourth password registration client terminal 3A4 in the password sharing system 1 will be described with reference to FIGS. 1A to 1D, FIG. 19, and related drawings together.

With reference to FIG. 19, the password registration client terminal 3A, as the fourth password registration client terminal 3A4, includes the user registration processing unit 31, the login processing unit 32, a password registration processing unit 33C, and the data creation processing unit 34 as functional components.

The fourth password registration client terminal 3A4 further includes the password deletion processing unit 37, the password disclosure period change processing unit 38, the password disclosure permission information change processing unit 39, or the like according to each embodiment (example).

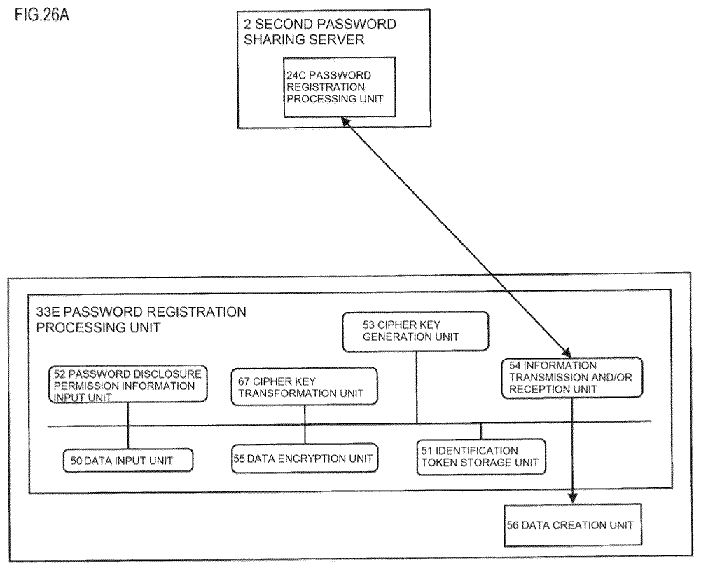

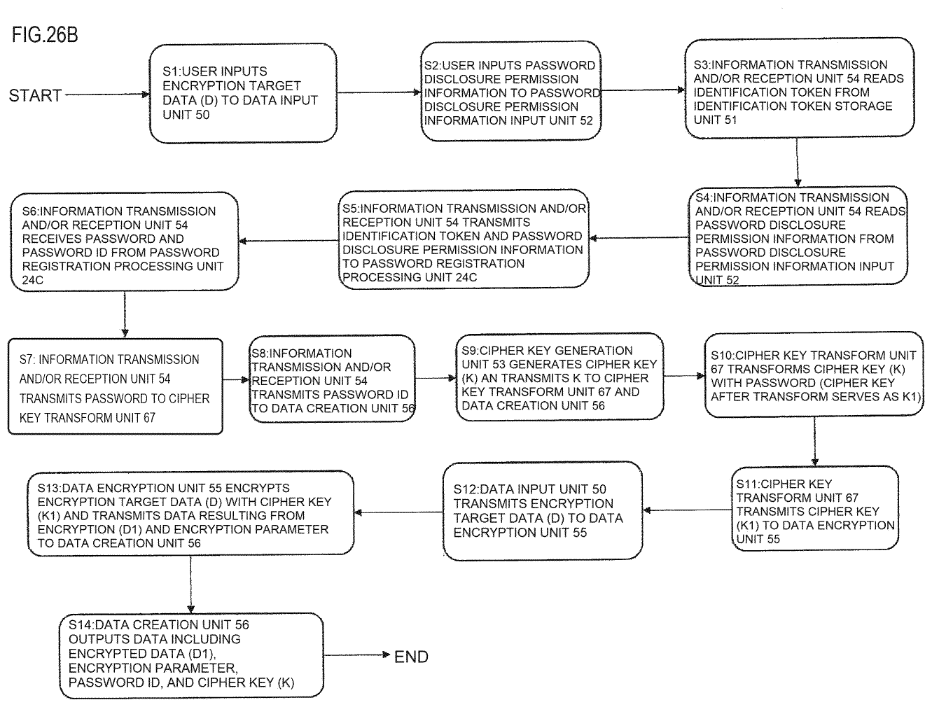

The basic feature elements of the fourth password registration client terminal 3A4 include the identification token storage unit 51, the password disclosure permission information input unit 52, the information transmission and/or reception unit (network access unit) 54, the cipher key transformation unit 67, the data encryption unit 55, and the data creation unit 56 (refer to FIG. 26A).

The information transmission and/or reception unit 54 transmits an identification token stored in the identification token storage unit 51 and password disclosure permission information input to the password disclosure permission information input unit 52, to the password sharing server 2 (2C) as transmission information and receives a password and the password ID corresponding to the password from the password sharing server 2 (2C).

With reference to FIG. 26A, the password registration processing unit 33C in the fourth password registration client terminal 3A4 is configurable to include the data input unit 50, the identification token storage unit 51, the password disclosure permission information input unit 52, the information transmission and/or reception unit 54, the data encryption unit 55, the cipher key generation unit 53, and the cipher key transformation unit 67 as detailed components. These components include those shared with other processing units. This password registration processing unit 33C operates with the data creation unit 56 configuring the data creation processing unit 34 (refer to FIG. 19).

The password registration processing unit 33C in the fourth password registration client terminal 3A4 communicates with the password registration processing unit 24C in the third password sharing server 2C.

With reference to FIG. 26A and FIG. 26B together, in the password registration processing unit 33C, the data input unit 50, the identification token storage unit 51, the password disclosure permission information input unit 52, the information transmission and/or reception unit 54, the cipher key generation unit 53, the data encryption unit 55, and the cipher key transformation unit 67 cooperate to execute the following detailed processing steps.

[S1 (refer to FIG. 26B)] A user inputs encryption target data (D) to the data input unit 50.
[S2] The user inputs password disclosure permission information to the password disclosure permission information input unit 52.
[S3] The information transmission and/or reception unit 54 reads a corresponding identification token from the identification token storage unit 51.
[S4] The information transmission and/or reception unit 54 reads password disclosure permission information from the password disclosure permission information input unit 52.
[S5] The information transmission and/or reception unit 54 transmits the identification token and the password disclosure permission information to the password registration processing unit 24C.
[S6] The information transmission and/or reception unit 54 receives a password and a password ID from the password registration processing unit 24C.
[S7] The information transmission and/or reception unit 54 transmits the password to the cipher key transformation unit 67.
[S8] The information transmission and/or reception unit 54 transmits the password ID to the data creation unit 56.
[S9] The cipher key generation unit 53 generates a cipher key (K) and transmits K to the cipher key transformation unit 67 and the data creation unit 56.
[S10] The cipher key transformation unit 67 transforms the cipher key (K) with the password. Assume the cipher key after the transformation as K1.
[S11] The cipher key transformation unit 67 transmits the cipher key (K1) to the data encryption unit 55.
[S12] The data input unit 50 transmits encryption target data (D) to the data encryption unit 55.
[S13] The data encryption unit 55 encrypts the encryption target data (D) with the cipher key (K1) and transmits data (D1), which is the result of the encryption, and an encryption parameter to the data creation unit 56.
[S14] The data creation unit 56 outputs data including the encrypted data (D1), the encryption parameter, the password ID, and the cipher key (K).

A symmetric key is assumed as the cipher key generated by the cipher key generation unit 53 in [S9] above. Hence, cipher key K can be used for both data encryption and data decryption.

The data output in [S14] includes the cipher key (K), but the cipher key used for the data encryption is K1. Hence, the data cannot be decrypted without obtaining K1. K1 can be created by acquiring cipher key K and the password. In other words, confidentiality of the data depends on confidentiality of the password.

### {Details of First Password Acquisition Client Terminal}

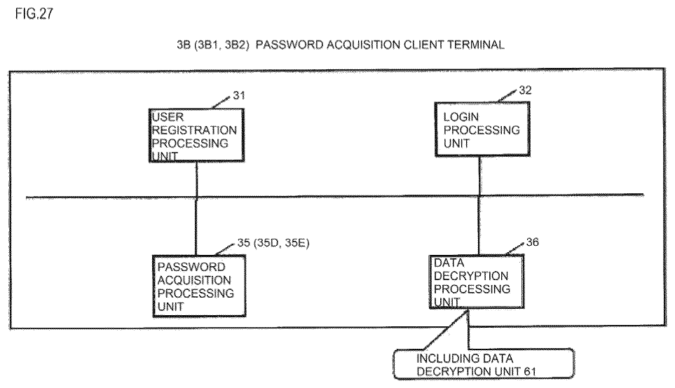

Details of a first password acquisition client terminal 3B1 in the password sharing system 1 will be described with reference to FIGS. 1A to 1D, FIG. 27, and related drawings together.

With reference to FIG. 27, the password acquisition client terminal 3B, as the first password acquisition client terminal 3B1, includes the user registration processing unit 31, the login processing unit 32, a password acquisition processing unit 35D, and the data decryption processing unit 36 as functional components. Here, the data decryption processing unit 36 includes a data decryption unit 61 (this similarly applies to other embodiments (examples)).

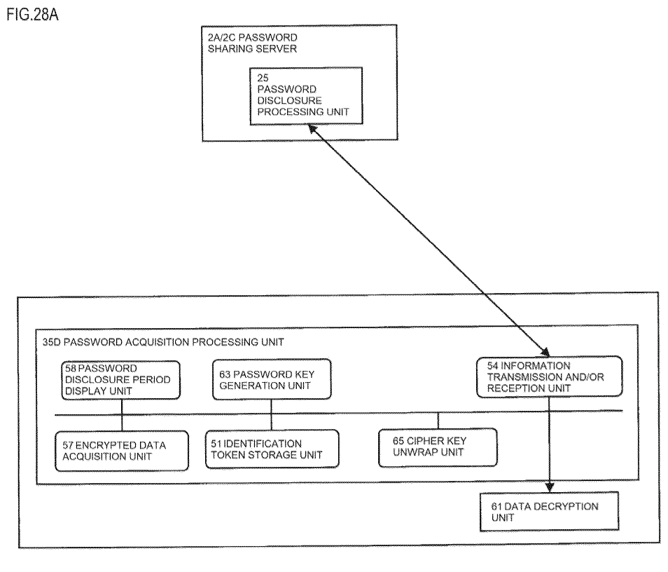

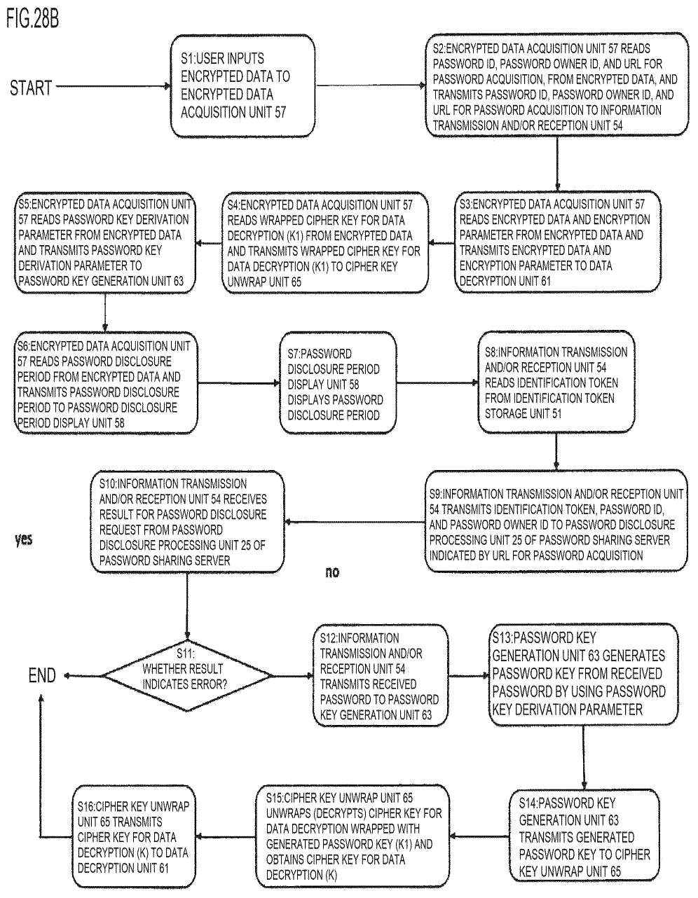

The basic feature elements of the first password acquisition client terminal 3B1 include the identification token storage unit 51, the information transmission and/or reception unit (network access unit) 54, the encrypted data acquisition unit 57, and the data decryption unit 61 (refer to FIG. 28A).

In other words, the first password acquisition client terminal 3B1 is a client terminal having a password acquisition function of reading data output by the client terminal 3A having a password registration function and includes the identification token storage unit 51 configured to store an identification token (proof) indicating that a corresponding user is an authenticated user and the encrypted data acquisition unit 57 configured to acquire password identification information (password ID) and encrypted data from the read data.

The first password acquisition client terminal 3B1 includes the information transmission and/or reception unit 54 configured to transmit the identification token stored in the identification token storage unit 51 and the password ID acquired by the encrypted data acquisition unit 57 to the password sharing server 2 (2A/2B) as transmission information and receive a password corresponding to the transmission information from the password sharing server 2 (2A/2B).

The first password acquisition client terminal 3B1 further includes the data decryption unit 61 configured to receive the encrypted data acquired by the encrypted data acquisition unit 57, the cipher key wrapped (encrypted), and the password received by the information transmission and/or reception unit 54, unwrap (decrypt) the wrapped cipher key with a password key generated from the password, to extract a cipher key for data decryption, and decrypt the encrypted data with the cipher key for data decryption.

The first password acquisition client terminal 3B1 can adopt any of the following aspects. Note that [Aspect 32] to [Aspect 35] are also applicable to a second password acquisition client terminal 3B2 to be described below.

[Aspect 32] In the first password acquisition client terminal 3B1, the encrypted data acquisition unit 57 acquires, when read data includes an encryption parameter, the encryption parameter from the read data, and
the data decryption unit 61 uses the encryption parameter acquired by the encrypted data acquisition unit 57 to decrypt encrypted data.

[Aspect 33] In the first password acquisition client terminal 3B1, the encrypted data acquisition unit 57 acquires, when input data includes a password owner ID, the password owner ID from the input data, and
the information transmission and/or reception unit 54 transmits the password owner ID acquired by the encrypted data acquisition unit 57 to the password sharing server 2 (2A/2B).

[Aspect 34] In the first password acquisition client terminal 3B1, the encrypted data acquisition unit 57 reads, when input data includes a URL for password acquisition, the URL for password acquisition from the input data, and
the information transmission and/or reception unit 54 accesses the URL for password acquisition read by the encrypted data acquisition unit 57, to communicate with the password sharing server 2 (2A/2B).

[Aspect 35] In the first password acquisition client terminal 3B1, the encrypted data acquisition unit 57 reads, when input data includes a password disclosure period or a data creation time and date, the password disclosure period or the data creation time and date from the input data, and performs processing to display the password disclosure period or the data creation time and date to a corresponding user.

The user registration processing unit 31 and the login processing unit 32 in the first password acquisition client terminal 3B1 include similar components to those of the first password registration client terminal 3A1 and the like described above and function similarly, and can hence be easily understood by those skilled in the art. Hence, descriptions of the user registration processing unit 31 and the login processing unit 32 are omitted here.

With reference to FIG. 28A, the password acquisition processing unit 35D in the first password acquisition client terminal 3B1 is configurable to include the identification token storage unit 51, the information transmission and/or reception unit 54, the encrypted data acquisition unit 57, a cipher key unwrap unit 65, and the password disclosure period display unit 58 as detailed components. These components include those shared with other processing units. This password acquisition processing unit 35D operates with the data decryption unit 61 configuring the data decryption processing unit 36 (refer to FIG. 27).

The password acquisition processing unit 35D in the first password acquisition client terminal 3B1 communicates with the password disclosure processing unit 25 in the first password sharing server 2A or the second password sharing server 2B.

With reference to FIG. 28A and FIG. 28B together, in the password acquisition processing unit 35D, the identification token storage unit 51, the information transmission and/or reception unit 54, the encrypted data acquisition unit 57, the cipher key unwrap unit 65, and the password disclosure period display unit 58 cooperate to execute processing steps S1 to S16 illustrated in FIG. 28B as an example.

In processing step S1, a user inputs encrypted data (six kinds of data illustrated in FIG. 23) acquired in advance, to the encrypted data acquisition unit 57.

In processing step S2, the encrypted data acquisition unit 57 reads a password ID (<pswd-id> element), a password owner ID (e-mail attribute in the <owner> element), and a URL for password acquisition (url-soc attribute in the <content> element), and transmits the password ID, the password owner ID, and the URL for password acquisition to the information transmission and/or reception unit 54. Here, the password owner ID is an e-mail address in a case of the encrypted data illustrated in FIG. 23.

In processing step S3, the encrypted data acquisition unit 57 reads encrypted data D1 and an encryption parameter from the encrypted data and transmits the encrypted data D1 and the encryption parameter to the data decryption unit 61.

In processing step S4, the encrypted data acquisition unit 57 reads a wrapped (encrypted) cipher key for data decryption (<key> element) from the encrypted data (assume this as K1) and transmits the wrapped cipher key for data decryption to the cipher key unwrap unit 65.

In processing step S5, the encrypted data acquisition Unit 57 reads password Key derivation parameter from encrypted data and transmits password key derivation parameter to the password key generation unit 63.

In processing step S6, the encrypted data acquisition unit 57 reads a password disclosure period (<period> element) from the encrypted data and transmits the password disclosure period to the password disclosure period display unit 58.

In processing step S7, the password disclosure period display unit 58 displays the password disclosure period. This is, for example, a display as follows.

Password disclosure start time and date (time point): 2022 May 2 15:28:45
Password disclosure end time and date (time point): 2022 May 10 15:28:45
Data creation time and date (time point): 2022 Apr. 30 15:28:45

When an error (result) is returned from a password sharing server and no password is obtained in a subsequent step (processing step S10), the user using the first password acquisition client terminal 3B1 views this display of the password disclosure period to thereby be able to understand that the password disclosure end time and date has passed, for example. Note that, for example, when there is a rule “the password disclosure end time is one week after the data creation time”, the password acquisition processing unit 35D can display the password disclosure end time even when the password disclosure end time is not described in the encrypted data, as long as the data creation time and date is described.

In processing step S8, the information transmission and/or reception unit 54 reads a corresponding identification token from the identification token storage unit 51. It is assumed that, before processing step S8, user registration to the password sharing server by the user registration processing unit 31 or login to the password sharing server by the login processing unit 32 is completed. As a result of the user registration or the login, the identification token transmitted from the password sharing server is stored in the identification token storage unit 51.

In processing step S9, the information transmission and/or reception unit 54 transmits the identification token, the password ID, and the password owner ID to the password disclosure processing unit 25 of the password sharing server indicated by the URL for password acquisition.

In processing step S10, the information transmission and/or reception unit 54 receives a result for a password disclosure request from the password disclosure processing unit 25 of the password sharing server.

When the judgment result in processing step S11 does not indicate an error, a password is transmitted from the password disclosure processing unit 25. In processing step S12, the information transmission and/or reception unit 54 transmits the password to the password key generation unit 63.

In processing step S13, the password key generation unit 63 generates password key from received password by using password key derivation parameter.

In processing step S14, the password key generation unit 63 generates a password key from the received password and transmits this password key to the cipher key unwrap unit 65.

In processing step S15, the cipher key unwrap unit 65 uses the password key received in processing step S12, to unwrap (decrypt) the cipher key (K1) received in processing step S4 to obtain a cipher key (K) for data decryption.

In processing step S16, the cipher key unwrap unit 65 transmits the cipher key (K) for data decryption unwrapped by the cipher key unwrap unit 65, to the data decryption unit 61.

Note that the encrypted data input to the encrypted data acquisition unit 57 by the user does not include the URL for password acquisition in some cases. In these cases, the password acquisition processing unit 35D accesses a password acquisition destination held in advance. Alternatively, the password acquisition processing unit 35D may access a URL held in advance to acquire a password acquisition destination URL.

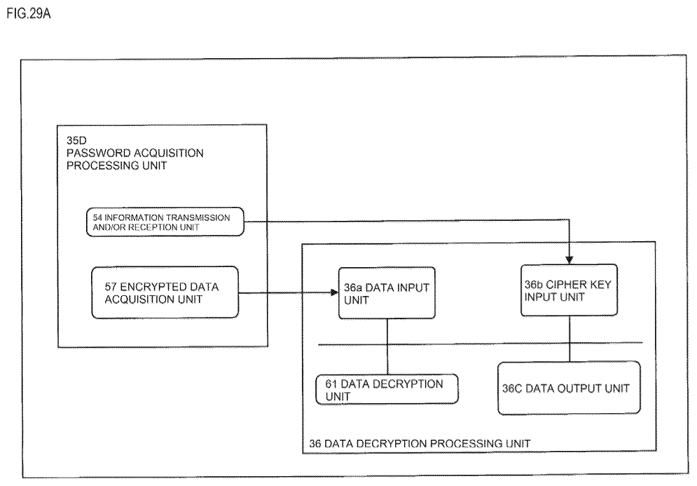

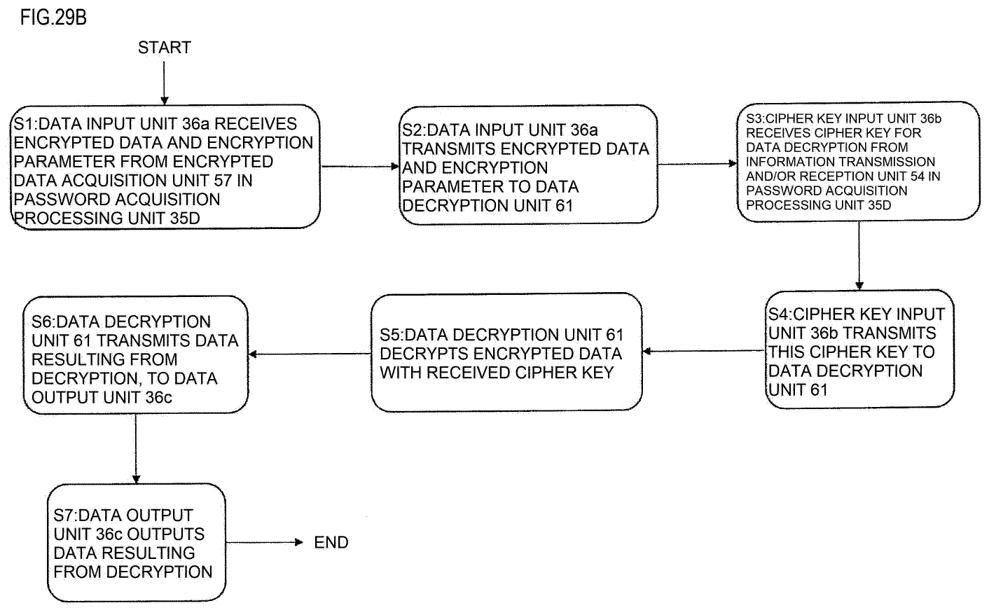

With reference to FIG. 29A, the data decryption processing unit 36 in the first password acquisition client terminal 3B1 is configurable to include a data input unit 36a, a cipher key input unit 36b, a data output unit 36c, and the data decryption unit 61 as detailed components. This data decryption processing unit 36 operates with the password acquisition processing unit 35D.

With reference to FIG. 29A and FIG. 29B together, in the data decryption processing unit 36, the data input unit 36a, the cipher key input unit 36b, the data output unit 36c, and the data decryption unit 61 cooperate to execute processing steps S1 to S7 illustrated in FIG. 29B as an example.

In processing step S1 illustrated in FIG. 29B, the data input unit 36a receives encrypted data D1 and an encryption parameter from the encrypted data from the encrypted data acquisition unit 57 in the password acquisition processing unit 35D.

In processing step S2, the data input unit 36a transmits the encrypted data D1 and the encryption parameter to the data decryption unit 61.

The cipher key input unit 36b receives a cipher key (cipher key for data decryption) from the information transmission and/or reception unit 54 in the password acquisition processing unit 35D in processing step S3 and transmits this cipher key to the data decryption unit 61 in processing step S4.

In processing step S5, the data decryption unit 61 decrypts the encrypted data D1 with the received cipher key. In this decryption, the encryption parameter is used

To supplement a function of the encryption parameter in the data decryption unit 61, nonce in Counter mode is XORed with a counter value, for example, to generate a counter block for encryption/decryption. The nonce in Counter mode is a parameter that changes every encryption to change a result of encryption of the same plain text every encryption. Similarly, an initial vector (IV) is a value XORed before encryption of the first plain block in CBC mode, for example. By changing the IV every encryption, an encrypted text corresponding to the same plain text changes every encryption. In decryption in CBC mode, a decryption result of the first block is XORed with the IV to obtain the first plain text block.

In processing step S6, the data decryption unit 61 transmits data of the decryption result to the data output unit 36c.

In processing step S7, the data output unit 36c outputs the data of the decryption result. The data output by the data output unit 36c is a text, an image (still image and/or video), or the like, according to the format of original data. In the first password acquisition client terminal 3B1, the data output by the data output unit 36c is displayed in an appropriate form.

### {Details of Second Password Acquisition Client Terminal}

Details of a second password acquisition client terminal 3B2 in the password sharing system 1 will be described with reference to FIGS. 1A to 1D, FIG. 27, and related drawings together.

With reference to FIG. 27, the password acquisition client terminal 3B, as the second password acquisition client terminal 3B2, includes the user registration processing unit 31, the login processing unit 32, a password acquisition processing unit 35E, and the data decryption processing unit 36 as functional components.

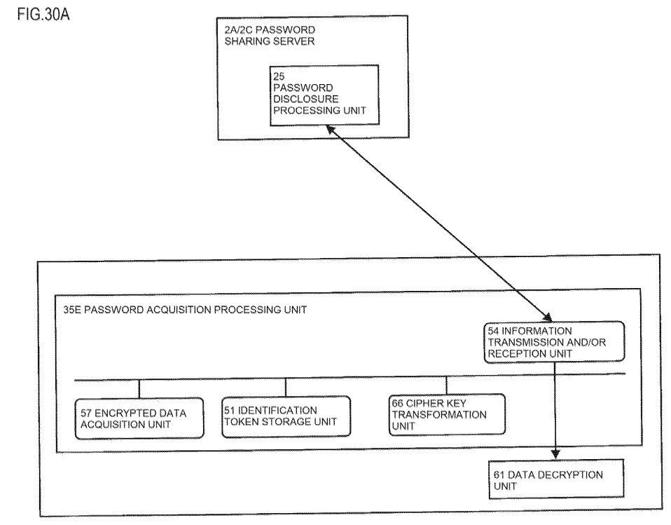

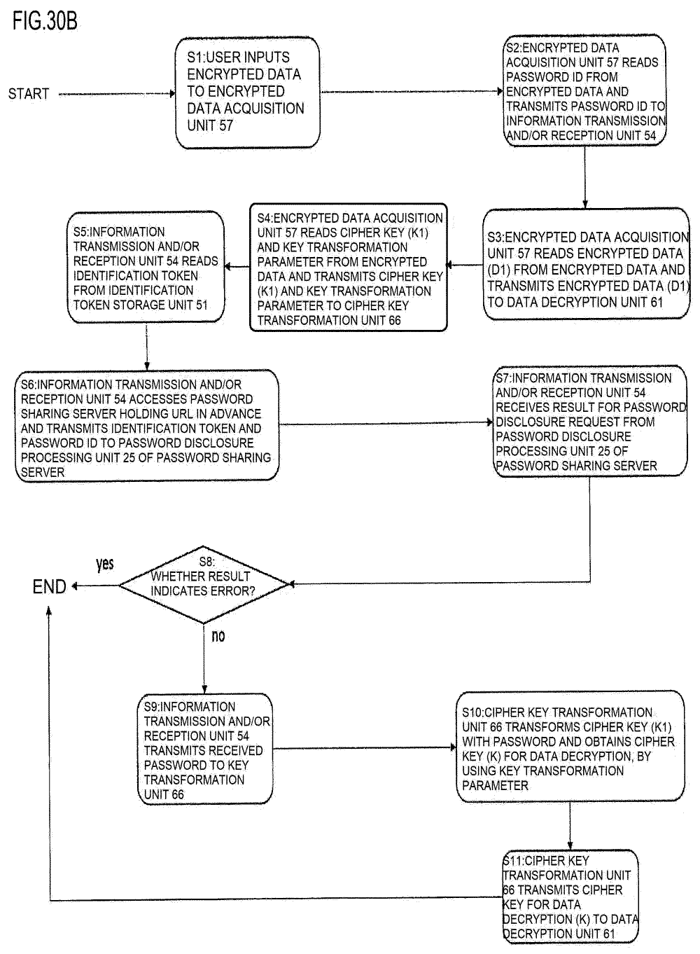

The basic feature elements of the second password acquisition client terminal 3B2 include the identification token storage unit 51, the information transmission and/or reception unit (network access unit) 54, the encrypted data acquisition unit 57, the cipher key transformation unit 67, and the data decryption unit 61 (refer to FIG. 30A).

The second password acquisition client terminal 3B2 includes the cipher key transformation unit 67 without including the password key generation unit 63 and the cipher key unwrap unit 65, in comparison with the first password acquisition client terminal 3B1.

With reference to FIG. 30A, the password acquisition processing unit 35E in the second password acquisition client terminal 3B2 is configurable to include the identification token storage unit 51, the information transmission and/or reception unit 54, the encrypted data acquisition unit 57, and the cipher key transformation unit 67 as detailed components. This password acquisition processing unit 35E operates with the data decryption unit 61 configuring the data decryption processing unit 36 (refer to FIG. 27).

The password acquisition processing unit 35E in the second password acquisition client terminal 3B2 communicates with the password disclosure processing unit 25 in the first password sharing server 2A or the third password sharing server 2C.

With reference to FIG. 30A and FIG. 30B together, in the password acquisition processing unit 35E, the identification token storage unit 51, the information transmission and/or reception unit 54, the encrypted data acquisition unit 57, and the cipher key transformation unit 67 cooperate to execute processing steps S1 to S11 illustrated in FIG. 30B as an example.

In processing step S1, when password disclosure request is needed, a user inputs encrypted data (data illustrated in FIG. 25C) acquired in advance, to the encrypted data acquisition unit 57.

In processing step S2, the encrypted data acquisition unit 57 reads a password ID (<pswd-id> element in FIG. 25C) from the input encrypted data and transmits the password ID to the information transmission and/or reception unit 54.

In processing step S3, the encrypted data acquisition unit 57 reads encrypted data (D1) (<content> element) from the input encrypted data and transmits the encrypted data (D1) to the data decryption unit 61.

In processing step S4, the encrypted data acquisition unit 57 reads a cipher key (assumed as K1) (<key> element) and a key transformation parameter (<param> element) from the input encrypted data and transmits this cipher key (K1) to the cipher key transformation unit 67.

In processing step S5, the information transmission and/or reception unit 54 reads a corresponding identification token from the identification token storage unit 51.

In processing step S6, the information transmission and/or reception unit 54 transmits the identification token and the password ID to the password sharing server.

In processing step S7, the information transmission and/or reception unit 54 receives a result of the request transmitted to the password sharing server in processing step S6, from the password disclosure processing unit 25 of the password sharing server 2. This result indicates a password in a case of a success, but the information transmission and/or reception unit 54 receives an error in a case of a failure.

In processing step S8, the information transmission and/or reception unit 54 checks whether or not a response from the password sharing server indicates an error. In a case where the response indicates an error, the processing is terminated. In a case where the response does not indicate an error, the processing advances to processing step S9.

In processing step S9, the information transmission and/or reception unit 54 receives a password from the password sharing server. The information transmission and/or reception unit 54 transmits the password to the cipher key transformation unit 67.

In processing step S10, the cipher key transformation unit 67 transforms the cipher key (K1) received in processing step S4, with the password received in processing step S9 to obtain a cipher key (K) for data decryption. In this transformation, the key transformation parameter received in processing step S4 is used. The transformation of a cipher key with a password is performed as already described.

In processing step S11, the cipher key transformation unit 67 transmits the cipher key (K) for data decryption to the data decryption unit 61.

The data decryption unit 61 decrypts encrypted data (D1) in the input encrypted data, with the acquired cipher key (K) for data decryption and reproduces the text, the image (still image and/or video), or the like from the decrypted data.

### {Modified Examples in One Embodiment}

To the password sharing system 1 of the one embodiment described above, modified examples to be described below can be adopted.

(1) In the password sharing system 1 of the one embodiment described above, it is possible, for example, to adopt a configuration that the password sharing server 2 (2A/2B/2C) further includes the password deletion processing unit 26, the password disclosure period change processing unit 27, and the password disclosure permission information change processing unit 28, and the password registration client terminal 3A further includes the password deletion processing unit 37, the password disclosure period change processing unit 38, and the password disclosure permission information change processing unit 39.

This configuration enables deletion of a password registered to the password sharing server 2 by a user, change of the disclosure period of the password registered to the password sharing server 2 by the user, and change of the password disclosure permission information of the password registered to the password sharing server 2 by the user.

(2) In the password sharing system 1 of the one embodiment described above, password disclosure by the password sharing server 2 (2A/2B/2C) can be associated with viewing of advertisement and charging. For example, the password sharing server 2 provides a password to a user requesting password disclosure after confirming that the user has viewed an advertisement video. Alternatively, the password sharing server 2 provides a password to a user requesting password disclosure after confirming that the user has paid a service charge.

(3) In the password sharing system 1 of the one embodiment described above, an identification token indicates an authenticated user. For a user with an e-mail address being authenticated, the password sharing server 2 may request registration of another e-mail address, a phone number, or the like held by the user to perform two-element authentication or multi-element authentication. In this case, a smartphone may be registered as the second element for identity verification.

(4) In the password sharing system 1 of the one embodiment described above, to increase security of password disclosure, it is possible to adopt a configuration to perform reconfirmation of an e-mail address by using one-time password between the password sharing server 2 (2A/2B/2C) and the password acquisition client terminal 3B at the time of password disclosure.

(5) A cipher key for data encryption and a cipher key for data decryption in the password sharing system 1 of the one embodiment described above is replaceable with cipher key generation source information corresponding to source data for generating a cipher key.

(6) A modified example of the second password registration client terminal 3A2 in the password sharing system 1 of the one embodiment described above will be described. This modified example further includes the password input unit 62, the password key generation unit 63, and the cipher key wrap unit 64. A password input to the password input unit 62 is transmitted to the password key generation unit 63, and a password key generated by the password key generation unit 63 is transmitted to the cipher key wrap unit 64. The information transmission and/or reception unit 54 also receives a cipher key for data decryption in addition to a cipher key for data encryption, from the password sharing server 2. In a case of symmetric key encryption, these cipher keys match.

The information transmission and/or reception unit 54 transmits the cipher key for data decryption received from the password sharing server 2, to the cipher key wrap unit 64. The cipher key wrap unit 64 encrypts (wraps) the cipher key for data decryption with the password key and transmits the encrypted (wrapped) cipher key to the information transmission and/or reception unit 54. The information transmission and/or reception unit 54 transmits the wrapped cipher key for data decryption to the password sharing server 2 together with a corresponding identification token stored in the identification token storage unit 51. Password identification information of the cipher key for data decryption is received from the password sharing server 2 at the time of reception of the cipher key for data encryption and the cipher key for data decryption by the information transmission and/or reception unit 54 from the password sharing server 2 or in response to transmission of the wrapped cipher key for data decryption from the information transmission and/or reception unit 54 to the password sharing server 2.

(7) A modified example of the second password sharing server 2B that communicates with the second password registration client terminal 3A2 of modified example (6) described above will be described. A second processing unit of the modified example transmits a cipher key for data decryption in addition to a cipher key for data encryption to the above client terminal. In this transmission, the password identification information of the cipher key does not necessarily need to be transmitted. The second processing unit further receives the cipher key for data decryption wrapped with a password key from the above password registration client terminal together with an identification token. The wrapped cipher key for data decryption received is stored in a database in association with password disclosure permission information received by the second processing unit from the password registration client terminal. The second processing unit transmits password identification information corresponding to the cipher key for data decryption to the password registration client terminal at the time of transmitting the cipher key for data decryption to the password registration client terminal or in response to reception of the wrapped cipher key for data decryption from the password registration client terminal.

A third processing unit of the second password registration client terminal of this modified example transmits, for password identification information received from the second password acquisition client terminal, the wrapped cipher key for data decryption associated with the password identification information.

(8) A modified example of the first password registration client terminal 3A1 in the password sharing system 1 of the one embodiment described above will be described. This modified example further includes the password input unit 62. The information transmission and/or reception unit 54 transmits a password input to the password input unit 62, to the password sharing server 2 in addition to an identification token, a cipher key for data decryption, and password disclosure permission information, and acquires password identification information.

(9) A modified example of the first password sharing server 2A that communicates with the first password registration client terminal 3A1 of modified example (8) described above will be described. A second processing unit receives a password in addition to an identification token, a cipher key for data decryption, and password disclosure permission information. The second processing unit generates a password key from the password and uses the password key to encrypt (wrap) the received cipher key for data decryption. The second processing unit stores the wrapped cipher key for data decryption and the password disclosure permission information in a database, and transmits password identification information for identifying the wrapped cipher key for data decryption and the password disclosure permission information in the database, to this first password registration client terminal 3A1.

### {Effects of One Embodiment and Modified Examples}

In the password sharing system 1 of any of the one embodiment and modified examples described above, by using an identification token, password disclosure permission information, password identification information, and a plurality of kinds of keys in combination, a password sharing processing technique for more securely sharing encrypted data obtained by encrypting encryption target data is provided. With this, problems of existing techniques can be solved.

### {Other Modified Examples}

Each of the processes in any of the one embodiment and modified examples described above may be provided as a program executable in a computer and may be provided via a non-transitory computer readable recording medium such as a CD-ROM or a flexible disc and further a communication line.

The processes in any of the one embodiment and modified examples described above may be implemented in combination by selecting a plurality of any ones of or all of the processes.

### REFERENCE SIGNS LIST

100 Password sharing system
101 Password sharing server
102 First client terminal
103 Second client terminal
104 Identification token issue unit
105 Password provision unit
106 Verification unit
107 Password registration unit
108 Cipher key generation unit
109 Cipher key first processing unit
110 Password disclosure unit
111 First identification token storage unit
112 Password disclosure permission information input unit
113 First information transmission and/or reception unit
114 Data encryption unit
115 Data creation unit
116 Second identification token storage unit
117 Encrypted data acquisition unit
118 Second information transmission and/or reception unit
119 Cipher key second processing unit
120 Data decryption unit
121 Database
122 Record
131, 132 Identification token
133 Password information
134 Password disclosure permission information
135 Password identification information
136 Cipher key for data encryption
137 Cipher key for data decryption
138 Encrypted data
139 Data
140 Cipher key for data decryption subjected to second processing
1 Password sharing system
2 Password sharing server
2A First password sharing server
2B Second password sharing server
2C Third password sharing server
3 Client terminal
3A Password registration client terminal
3B Password acquisition client terminal
3A1 First password registration client terminal
3A2 Second password registration client terminal
3A3 Third password registration client terminal
3A4 Fourth password registration client terminal
3B1 First password acquisition client terminal
3B2 Second password acquisition client terminal
4 Communication network

What is claimed is:

1. A password sharing system including one or more password sharing servers, one or more first client terminals having functions of password registration and data output, and one or more second client terminals having a function of reading data output by the first client terminal, the password sharing system comprising:
an identification token issue unit configured to issue an identification token indicating “authenticated” to the first client terminal and the second client terminal;
a password provision unit configured to provide password information, which is a password or a password key generated based on the password;
a verification unit configured to verify an identification token transmitted from the first client terminal;
a password registration unit configured to, only when the verification unit confirms that the identification token is correct, store the password information provided by the password provision unit and password disclosure permission information designating a disclosure permissible range of the password transmitted from the first client terminal in a record in a database included in one of the password sharing servers and also transmit password identification information for identifying the record to the first client terminal;
a cipher key generation unit configured to generate a pair of a cipher key for data encryption and a cipher key for data decryption;
a cipher key first processing unit configured to perform first processing on at least one of the cipher key for data decryption and the cipher key for data encryption generated by the cipher key generation unit, based on the password information provided by the password provision unit, to thereby generate a cipher key for data decryption and a cipher key for data encryption subjected to or not subjected to the first processing, respectively as a cipher key for data decryption after first processing and a cipher key for data encryption after first processing, and input the cipher key for data decryption after first processing and the cipher key for data encryption after first processing to the first client terminal; and
a password disclosure unit configured to acquire the password identification information and the identification token included in a password inquiry information from the second client terminal, acquire the password information and the password disclosure permissible information from a record in the database included in the password sharing server, the record corresponding to the password identification information acquired, acquire information of a user corresponding to the identification token acquired, and transmit the password information acquired to the second client terminal only when it is confirmed that the user is included in the disclosure permissible range indicated by the password disclosure permission information acquired.

2. The password sharing system according to claim 1, wherein the first client terminal includes
a first identification token storage unit configured to store the identification token issued by the identification token issue unit,
a password disclosure permission information input unit configured to input the password disclosure permission information,
a first information transmission and/or reception unit configured to transmit the password disclosure permission information input by the password disclosure permission information input unit and the identification token stored by the first identification token storage unit, to the verification unit and the password registration unit and receive the password identification information transmitted from the password registration unit in response to the transmission,
a data encryption unit configured to use, in response to an input of encryption target data, the cipher key for data encryption after first processing output by the cipher key first processing unit to encrypt the encryption target data, and output encrypted data obtained as a result of the encryption, and
a data creation unit configured to output the data including the password identification information received by the first information transmission and/or reception unit, the cipher key for data decryption after first processing output by the cipher key processing unit, and the encrypted data output by the data encryption unit.

3. The password sharing system according to claim 1, wherein the second client terminal includes
a second identification token storage unit configured to store the identification token issued by the identification token issue unit,
an encrypted data acquisition unit configured to acquire the password identification information, the cipher key for data decryption subjected to the processing, and the encrypted data from the data read,
a second information transmission and/or reception unit configured to transmit, as the password inquiry information, the password identification information acquired by the encrypted data acquisition unit and the identification token stored by the second identification token storage unit, to the password disclosure unit, and receive the password information transmitted from the password disclosure unit in response to the transmission,
a cipher key second processing unit configured to perform second processing on the cipher key for data decryption after first processing acquired by the encrypted data acquisition unit, based on the password information received by the second information transmission and/or reception unit, to thereby generate a cipher key for data decryption subjected to the second processing, and
a data decryption unit configured to use the cipher key for data decryption subjected to the second processing generated by the cipher key second processing unit, to execute decryption processing on the encrypted data acquired by the encrypted data acquisition unit.

4. The password sharing system according to claim 1, wherein
the cipher key generation unit, the password provision unit, and the cipher key first processing unit are included in the first client terminal, and
the first client terminal is configured to transmit the password information provided by the password provision unit, to the password registration unit.

5. The password sharing system according to claim 1, wherein
the cipher key generation unit and the cipher key first processing unit are included in the first client terminal,
the password provision unit is included in a server, and
the server including the password provision unit is configured to transmit the password information provided by the password provision unit, to the first client terminal including the cipher key first processing unit and a server including the password registration unit.

6. The password sharing system according to claim 1, wherein
the password provision unit and the cipher key generation unit are included in the first client terminal,
the cipher key first processing unit is included in a server,
the first client terminal is configured to transmit the password information provided by the password provision unit, to a server including the password registration unit and a server including the cipher key first processing unit, and transmit the cipher key for data decryption or the cipher key for data encryption generated by the cipher key generation unit, to the server including the cipher key first processing unit, and
the server including the cipher key first processing unit is configured to transmit the cipher key for data decryption after first processing or the cipher key for data encryption after first processing generated by the cipher key first processing unit, to the first client terminal.

7. The password sharing system according to claim 1, wherein
the cipher key generation unit is included in the first client terminal,
the password provision unit and the cipher key first processing unit are included together in one server or in a server different from the server in a distributed manner,
the first client terminal is configured to transmit the cipher key for data decryption or the cipher key for data encryption generated by the cipher key generation unit, to the server including the cipher key first processing unit,
the server including the password provision unit is configured to transmit the password information provided by the password provision unit, to a server including the password registration unit and a server including the cipher key first processing unit, and
the server including the cipher key first processing unit is configured to transmit the cipher key for data decryption after first processing or the cipher key for data encryption after first processing generated by the cipher key first processing unit, to the first client terminal.

8. The password sharing system according to claim 1, wherein
the password provision unit is included in the first client terminal, and the cipher key generation unit and the cipher key first processing unit are included together in one server or in one or more servers in a distributed manner,
the first client terminal is configured to transmit the password information provided by the password provision unit, to a server including the password registration unit and a server including the cipher key first processing unit,
the server including the cipher key generation unit is configured to transmit the cipher key for data decryption or the cipher key for data encryption generated by the cipher key generation unit, to the server including the cipher key first processing unit, and
the server including the cipher key first processing unit is configured to transmit the cipher key for data decryption after first processing or the cipher key for data encryption after first processing generated by the cipher key first processing unit, to the first client terminal.

9. The password sharing system according to claim 1, wherein
the password provision unit and the cipher key first processing unit are included in the first client terminal,
the cipher key generation unit is included in a server,
the first client terminal is configured to transmit the password information provided by the password provision unit, to a server including the password registration unit, and
the server including the cipher key generation unit is configured to transmit the cipher key for data encryption or the cipher key for data decryption generated by the cipher key generation unit, to the first client terminal including the cipher key first processing unit.

10. The password sharing system according to claim 1, wherein
the password provision unit and the cipher key generation unit are included together in one server or one or more servers in a distributed manner,
the cipher key first processing unit is included in the first client terminal,
the server including the password provision unit is configured to transmit the password information provided by the password provision unit, to a server including the password registration unit and the first client terminal including the cipher key first processing unit, and
the server including the cipher key generation unit is configured to transmit the cipher key for data encryption or the cipher key for data decryption generated by the cipher key generation unit, to the first client terminal including the cipher key first processing unit.

11. The password sharing system according to claim 1, wherein the verification unit, the password registration unit, and the password disclosure unit are included in the password sharing server.

12. The password sharing system according to claim 1, wherein the password disclosure permission information includes at least one of a relationship between users, designation of a user group, and a list of e-mail addresses.

13. The password sharing system according to claim 1, wherein
the password registration unit is configured to
receive a password disclosure period together with the identification token from the first client terminal, and
store the password disclosure period in the record in the database, and
the password disclosure unit is configured to
acquire the password disclosure period together with the password, from a record in the database, the record corresponding to the password identification information received from the second client terminal, and
transmit, only when a current time is within the password disclosure period, the password information acquired, to the second client terminal.

14. The password sharing system according to claim 13, wherein
the first client terminal further includes a password disclosure period input unit configured to receive an input of a password disclosure start time or a password disclosure end time as the password disclosure period, from a user of the first client terminal and
the first information transmission and/or reception unit is configured to transmit the password disclosure period input by the password disclosure period input unit, to the password registration unit.

15. The password sharing system according to claim 1, wherein the password registration unit is configured to transmit a password owner identifier or a uniform resource locator (URL) for password acquisition to the first client terminal.

16. The password sharing system according to claim 1, wherein the password disclosure unit is configured to
receive a first password owner identifier together with the identification token and the password identification information from the second client terminal,
acquire a second password owner identifier together with the password information from a record in the database, the record corresponding to the password identification information acquired, and
transmit, only when the first password owner identifier and the second password owner identifier match, the password information acquired to the second client terminal.

17. The password sharing system according to claim 1, wherein at least one of the cipher key for data encryption after first processing and the cipher key for data decryption after first processing is substitutable with cipher key generation source information corresponding to data serving as a source for generating a cipher key.

18. The password sharing system according to claim 2, wherein the data creation unit is configured to output the data including at least one of an encryption parameter, a password key derivation parameter, a key transformation parameter, a password owner ID, a URL for password acquisition, a password disclosure period, and a data creation time and date.

19. The password sharing system according to claim 16, wherein
the encrypted data acquisition unit is configured to acquire, when the data read includes a password owner identifier, the password owner identifier from the data read, and
the second information transmission and/or reception unit is configured to transmit the password owner identifier acquired by the encrypted data acquisition unit, as the first password owner identifier to the password disclosure unit.

20. A password sharing method applied to a password sharing system including one or more password sharing servers, one or more first client terminals having functions of password registration and data output, and one or more second client terminals having a function of reading data output by the first client terminal, the password sharing method executing:
identification token issue processing for issuing an identification token indicating “authenticated” to the first client terminal and the second client terminal;
password generation processing for generating password information, which is a password or a password key generated based on the password;
verification processing for verifying an identification token transmitted from the first client terminal;
password registration processing for, only when the verification processing confirms that the identification token is correct, storing the password information generated by the password generation processing and password disclosure permission information designating a disclosure permissible range of the password transmitted from the first client terminal in a record in a database included in one of the password sharing servers and also transmitting password identification information for identifying the record to the first client terminal;
cipher key generation processing for generating a pair of a cipher key for data encryption and a cipher key for data decryption;
cipher key first processing for performing first processing on at least one of the cipher key for data decryption and the cipher key for data encryption generated by the cipher key generation processing, based on the password information generated by the password generation processing, to thereby generate a cipher key for data decryption and a cipher key for data encryption subjected to or not subjected to the first processing, respectively as a cipher key for data decryption after first processing and a cipher key for data encryption after first processing, and input the cipher key for data decryption after first processing and the cipher key for data encryption after first processing to the first client terminal; and
password response processing for acquiring the password identification information and the identification token included in a password inquiry information from the second client terminal, acquiring the password information and the password disclosure permissible information from a record in the database included in the password sharing server, the record corresponding to the password identification information acquired, acquiring information of a user corresponding to the identification token acquired, and transmitting the password information acquired to the second client terminal only when it is confirmed that the user is included in the disclosure permissible range indicated by the password disclosure permission information acquired.

21. A program for causing one or more computers in a password sharing system including one or more password sharing servers, one or more first client terminals having functions of password registration and data output, and one or more second client terminals having a function of reading data output by the first client terminal, to execute all of or in a divided manner:
identification token issue processing for issuing an identification token indicating “authenticated” to the first client terminal and the second client terminal;
password generation processing for generating password information, which is a password or a password key generated based on the password;
verification processing for verifying an identification token transmitted from the first client terminal;
password registration processing for, only when the verification processing confirms that the identification token is correct, storing the password information generated by the password generation processing and password disclosure permission information designating a disclosure permissible range of the password transmitted from the first client terminal in a record in a database included in one of the password sharing servers and also transmitting password identification information for identifying the record to the first client terminal;
cipher key generation processing for generating a pair of a cipher key for data encryption and a cipher key for data decryption;
cipher key first processing for performing first processing on at least one of the cipher key for data decryption and the cipher key for data encryption generated by the cipher key generation processing, based on the password information generated by the password generation processing, to thereby generate a cipher key for data decryption and a cipher key for data encryption subjected to or not subjected to the first processing, respectively as a cipher key for data decryption after first processing and a cipher key for data encryption after first processing, and input the cipher key for data decryption after first processing and the cipher key for data encryption after first processing to the first client terminal; and
password response processing for acquiring the password identification information and the identification token included in a password inquiry information from the second client terminal, acquiring the password information and the password disclosure permissible information from a record in the database included in the password sharing server, the record corresponding to the password identification information acquired, acquiring information of a user corresponding to the identification token acquired, and transmitting the password information acquired to the second client terminal only when it is confirmed that the user is included in the disclosure permissible range indicated by the password disclosure permission information acquired.

22. A server device comprising the database according to claim 1, the server device further comprising:
any one of the identification token issue unit, the password provision unit, the verification unit, the password registration unit, the cipher key generation unit, the cipher key processing unit, and the password disclosure unit according to claim 1.

23. A terminal device having
functions of the first client terminal according to claim 1.

24. A terminal device having
functions of the second client terminal according to claim 1.
